(19) United States
(12) Patent Application Publication
(10) Pub. No.: US 2026/0300388 A1
(43) Pub. Date: Oct. 1, 2026

(54) GRAPH-BASED MODELS WITH AUDIO NODES

(71) Applicant: Infosys Limited, Bangalore (IN)

(72) Inventor: Steven SCHILDERS, Columbus, IN (US)

(73) Assignees: Infosys Limited, Bangalore (IN); InvertIT Inc., Columbus, IN (US)

(21) Appl. No.: 19/093,172

(22) Filed: Mar. 27, 2025

(51) Int. Cl. G06F 16/683; G06F 16/901

(52) U.S. Cl. CPC G06F 16/683; G06F 16/9024

(57) ABSTRACT

An overlay system is provided that includes a storage element and processing circuitry coupled thereto. The storage element stores an executable graph-based model having a plurality of audio nodes and a plurality of audio action overlay nodes. Each audio node represents an audio file. The processing circuitry receives a stimulus associated with a first audio action to be executed based on a first audio file and identifies, based on the stimulus, a first audio node representing the first audio file. The processing circuitry determines a first audio action overlay node associated with the first audio node and executes the first audio action using the first audio node and the first audio action overlay node to generate a second audio file. The processing circuitry generates, in response to the stimulus, a second audio node representing the second audio file.

### FIELD OF THE DISCLOSURE

Various embodiments of the present disclosure relate generally to graph-based models. More specifically, various embodiments of the present disclosure relate to implementation of audio nodes in executable graph-based models.

### BACKGROUND

Graph-based models are increasingly being adopted across various industries, crediting their ability to represent complex relationships between entities. These models are composed of nodes including vertices and edges, where the vertices symbolize real-world entities, and the edges represent associations or relationships between these entities. This structure allows graph-based models to be highly versatile and applicable to diverse domains such as marketing, research, hospitality, and more.

One of the notable features of graph-based models is their generic nature, which allows the nodes to represent a wide range of real-world scenarios without domain-specific constraints. Additionally, many graph-based models include overlay nodes embedded with processing logic. These overlay nodes enable operations to be performed on other nodes in the graph, such as data analysis, decision-making, or automated processing tasks.

However, this inherent generic nature of graph-based models presents certain limitations. While their flexibility allows them to adapt to multiple domains, it often leads to sub-optimal utilization of their potential. The lack of domain-specific customization or optimization in the node structure and processing logic may prevent the models from achieving an optimal operational capacity.

Notably, the domain of audio data processing—such as speech-to-text, text-to-speech, speaker identification, and other forms of audio-driven operations—faces challenges when applied to existing graph-based models. Presently, operations associated with the audio data processing often rely on a dissociation between raw audio data and neural processing pipeline. For example, in speech-to-text and text-to-speech systems, audio signals are typically preprocessed and converted into intermediate representations (e.g., spectrograms, embeddings, or token sequences) before they can be used by neural models. This separation introduces complexity, reduces flexibility, and limits the ability to perform end-to-end contextual analysis that simultaneously considers audio signal properties and higher-level linguistic or semantic features.

In light of the foregoing, there exists a need for a technical and reliable solution that overcomes the abovementioned problems.

Limitations and disadvantages of conventional and traditional approaches will become apparent to one of skill in the art, through the comparison of described systems with some aspects of the present disclosure, as set forth in the remainder of the present application and with reference to the drawings.

### SUMMARY

Methods and systems for facilitating implementation of audio nodes in executable graph-based models are provided substantially as shown in, and described in connection with, at least one of the figures.

The methods and systems described herein provide an overlay system. The overlay system includes processing circuitry and a storage element coupled to the processing circuitry. The storage element is configured to store an executable graph-based model that includes a plurality of audio nodes and a plurality of audio action overlay nodes. The plurality of audio nodes represent a plurality of audio configurations associated with a plurality of audio files. Each audio node of the plurality of audio nodes is associated with one or more audio action overlay nodes of the plurality of audio action overlay nodes. The processing circuitry is configured to receive a stimulus associated with a first audio action to be executed based on a first audio file of the plurality of audio files. The processing circuitry is further configured to identify, based on the stimulus, from the plurality of audio nodes, a first audio node that represents a first audio configuration of the first audio file. The processing circuitry is further configured to determine a first audio action overlay node, of the plurality of audio action overlay nodes, associated with the first audio node. The processing circuitry is further configured to execute the first audio action based on the first audio node and the first audio action overlay node to generate a second audio file. The processing circuitry is further configured to generate, in the executable graph-based model, in response to the stimulus, a second audio node, representing a second audio configuration of the second audio file.

In some embodiments, the processing circuitry determines the first audio action overlay node based on the first audio action being in conformity with a functionality of the first audio action overlay node.

In some embodiments, the first audio file corresponds to at least one of: (i) an encoded audio signal, (ii) metadata describing an audio signal, (iii) one or more feature representations of an audio content, (iv) one or more annotations indicative of temporal characteristics of the audio signal, or (v) one or more annotations indicative of spectral characteristics of the audio signal.

In some embodiments, the first audio configuration corresponds to at least one of: (i) one or more audio parameters, (ii) an encoding format, (iii) one or more feature representations, (iv) one or more processing settings, (v) metadata, or (vi) one or more annotations, associated with the first audio file.

In some embodiments, the first audio action overlay node is at least one of: an audio generation overlay node, an audio modification overlay node, or an audio analyzer overlay node.

In some embodiments, the executable graph-based model further includes a plurality of standard operations overlay nodes. The processing circuitry is further configured to determine a first standard operations overlay node, of the plurality of standard operations overlay nodes, associated with the first audio node. The first audio action is executed further based on the first standard operations overlay node.

In some embodiments, the first audio node includes a first audio reference of the first audio file. The first audio action overlay node includes a first module reference of a first audio action module. For the execution of the first audio action, the processing circuitry is further configured to retrieve, based on the first audio action overlay node, the first audio reference from the first audio node. The processing circuitry is further configured to communicate, based on the first module reference of the first audio action overlay node, the first audio reference to the first audio action module. An audio operation, of the first audio action, is executed on the first audio file by the first audio action module using the first audio reference, to generate the second audio file. The processing circuitry is further configured to receive, using the first audio action overlay node, the second audio configuration from the first audio action module.

In some embodiments, the execution of the first audio action generates at least one intermediate audio file associated with the first audio file. Prior to the reception of the second audio configuration, the processing circuitry is further configured to receive, based on the first audio action overlay node, a third audio configuration of the at least one intermediate audio file from the first audio action module.

In some embodiments, the processing circuitry is further configured to determine a second audio action overlay node, of the plurality of audio action overlay nodes, associated with the first audio node. The second audio action overlay node includes a second module reference of a second audio action module. The first audio action is executed further based on the second audio action overlay node.

In some embodiments, the first audio node further includes a first overlay manager configured to manage the association of the first audio node with the first audio action overlay node.

In some embodiments, the processing circuitry is further configured to determine a third audio action overlay node, of the plurality of audio action overlay nodes, associated with the first audio action overlay node. The first audio action is executed further based on the third audio action overlay node.

In some embodiments, the first audio action overlay node further includes a second overlay manager configured to manage the association of the first audio action overlay node with the third audio action overlay node.

In some embodiments, the first audio node is one of a stateful node or a stateless node.

In some embodiments, based on the first audio node being the stateful node, the first audio configuration remains stored with the storage element upon unloading of the first audio node.

In some embodiments, based on the first audio node being the stateless node, the first audio configuration ceases to exist in the storage element upon unloading of the first audio node.

In some embodiments, based on the execution of the first audio action, the processing circuitry is further configured to store the first audio configuration in association with the first audio action overlay node.

In some embodiments, the first audio action overlay node is one of a stateful node or a stateless node.

In some embodiments, based on the first audio action overlay node being the stateful node, the first audio configuration is stored in the storage element upon unloading of the first audio action overlay node.

In some embodiments, based on the first audio action overlay node being the stateless node, the first audio configuration ceases to exist in the storage element upon unloading of the first audio action overlay node.

In some embodiments, upon the execution of the first audio action, the processing circuitry is further configured to associate the first audio configuration with the first audio action overlay node. The processing circuitry is further configured to discard the first audio node from the executable graph-based model.

In some embodiments, the execution of the first audio action generates at least one intermediate audio file associated with the first audio file. The at least one intermediate audio file is generated prior to the generation of the second audio file. The processing circuitry is further configured to receive, using the first audio action overlay node, a third audio configuration of the at least one intermediate audio file.

In some embodiments, the first audio action overlay node represents the third audio configuration of the at least one intermediate audio file.

In some embodiments, the processing circuitry is further configured to instantiate, based on the first audio action overlay node, at least one intermediate audio node representing the third audio configuration of the at least one intermediate audio file.

In some embodiments, the processing circuitry is further configured to correlate, based on the first audio action overlay node, the first audio node with at least one of the at least one intermediate audio node or the second audio node.

In some embodiments, the processing circuitry is further configured to generate a first group node that includes at least one of: the first audio node, the at least one intermediate audio node, or the second audio node.

In some embodiments, the processing circuitry is further configured to generate, based on the first group node, an audio trail associated with the first audio file. The audio trail includes a time-synchronized order of audio mutations of the first audio file.

In some embodiments, the first group node is associated with a second group node. The second group node includes a third audio node correlated with at least one of: the first audio node, the at least one intermediate audio node, or the second audio node.

In some embodiments, the processing circuitry is further configured to associate a fourth audio action overlay node, of the plurality of audio action overlay nodes, with the first group node. The first audio action is executed further based on the fourth audio action overlay node.

In some embodiments, the executable graph-based model further includes a plurality of standard operations overlay nodes. The first group node is further associated with a second standard operations overlay node of the plurality of standard operations overlay nodes. The first audio action is executed further based on the second standard operations overlay node.

In some embodiments, the first group node is one of a persistable node or a non-persistable node.

In some embodiments, based on the first group node being the persistable node, an audio trail of the first audio node is stored in the storage element. The audio trail of the first audio node includes a time-synchronized order of at least one of: the first audio node, the at least one intermediate audio node, or the second audio node.

In some embodiments, based on the first group node being the non-persistable node, an audio trail of the first audio node ceases to exist from the storage element upon expiration of a threshold time-interval. The audio trail of the first audio node includes a time-synchronized order of at least one of: the first audio node, the at least one intermediate audio node, or the second audio node.

In some embodiments, the first group node is further associated with a contract overlay node of the executable graph-based model. The processing circuitry is further configured to execute, using the contract overlay node, a set of constraints that implements access control associated with the first group node.

In some embodiments, the access control associated with the first group node includes one of a private access, a public access, or a protected access.

In some embodiments, based on the stimulus, the processing circuitry is further configured to determine whether at least one of the first audio node or the first audio action overlay node is unloaded, from the executable graph-based model. The processing circuitry is further configured to load, in the executable graph-based model, based on at least one of the first audio node or the first audio action overlay node being unloaded from the executable graph-based model, at least one of the first audio node or the first audio action overlay node.

In some embodiments, based on the generation of the second audio node, the processing circuitry is further configured to unload at least one of: the first audio node, the second audio node, or the first audio action overlay node, from the executable graph-based model.

In some embodiments, the first audio node is a generic node and the first audio action overlay node is a generic overlay node.

In some embodiments, the first audio node is a run-time node that includes (i) a node template that defines a node structure and (ii) a node instance that is an implementation of the node template. Based on the first audio node being the run-time node, the first audio action overlay node is a run-time overlay node that includes (i) an overlay node template that defines an overlay node structure and (ii) an overlay node instance that is an implementation of the overlay node template.

In some embodiments, the processing circuitry is further configured to load the run-time node based on loading of the node template and the node instance. The processing circuitry is further configured to load the run-time overlay node based on loading of the overlay node template and the overlay node instance.

In some embodiments, each audio action overlay node of the plurality of audio action overlay nodes is a run-time overlay node. The processing circuitry is further configured to determine one or more audio action overlay nodes, of the plurality of audio action overlay nodes, associated with the first audio action overlay node. The first audio action is executed further based on the one or more audio action overlay nodes. The overlay node template of the first audio action overlay node defines a sequence of operations associated with the one or more audio action overlay nodes.

In some embodiments, the first audio node is an edge node.

In some embodiments, a method is provided. The method comprising receiving, by processing circuitry of an overlay system, a stimulus associated with a first audio action. The first audio action is to be executed based on a first audio file of a plurality of audio files. An executable graph-based model is stored in a storage element of the overlay system and includes a plurality of audio nodes and a plurality of audio action overlay nodes. The plurality of audio nodes represent a plurality of audio configurations of the plurality of audio files. Each audio node of the plurality of audio nodes is associated with one or more audio action overlay nodes of the plurality of audio action overlay nodes. The method further comprising identifying, by the processing circuitry, based on the stimulus, a first audio node of the plurality of audio nodes that represents a first audio configuration of the first audio file. The method further comprising determining, by the processing circuitry, a first audio action overlay node, of the plurality of audio action overlay nodes, associated with the first audio node. The method further comprising executing, by the processing circuitry, the first audio action based on the first audio node and the first audio action overlay node to generate a second audio file. The method further comprising generating, by the processing circuitry, in response to the stimulus, a second audio node, representing a second audio configuration of the second audio file.

These and other features and advantages of the present disclosure may be appreciated from a review of the following detailed description of the present disclosure, along with the accompanying figures in which like reference numerals refer to like parts throughout.

### BRIEF DESCRIPTION OF THE DRAWINGS

Embodiments of the present disclosure are illustrated by way of example and are not limited by the accompanying figures. Similar references in the figures may indicate similar elements. Elements in the figures are illustrated for simplicity and clarity and have not necessarily been drawn to scale.

FIG. 1 is a graph that illustrates a composition of an executable graph-based model, consistent with disclosed embodiments of the present disclosure;

FIG. 2 is a block diagram that illustrates a system environment of an overlay system for execution, management, and configuration of the executable graph-based model, consistent with disclosed embodiments of the present disclosure;

FIG. 3A is a block diagram that illustrates a standard structure of a generic node within the executable graph-based model, consistent with disclosed embodiments of the present disclosure;

FIG. 3B is a block diagram that illustrates a standard structure of a run-time node within the executable graph-based model, consistent with disclosed embodiments of the present disclosure;

FIG. 4A is a block diagram that illustrates a standard structure of a generic audio node within the executable graph-based model, consistent with disclosed embodiments of the present disclosure;

FIG. 4B is a block diagram that illustrates a standard structure of a run-time audio node within the executable graph-based model, consistent with disclosed embodiments of the present disclosure;

FIG. 5A is a block diagram that illustrates an executable generic audio node within the executable graph-based model, consistent with disclosed embodiments of the present disclosure;

FIG. 5B is a block diagram that illustrates an executable run-time audio node within the executable graph-based model, consistent with disclosed embodiments of the present disclosure;

FIG. 6 is a block diagram that illustrates a composition of the executable generic audio node that enables persistent storage of data and processing logic associated therewith, consistent with disclosed embodiments of the present disclosure;

FIGS. 7A and 7B, collectively, illustrate a graph that depicts an implementation of a plurality of audio nodes in the executable graph-based model, consistent with disclosed embodiments of the present disclosure;

FIG. 8 illustrates a graph that depicts an exemplary implementation of the executable graph-based model, consistent with disclosed embodiments of the present disclosure;

FIG. 9 illustrates a graph that depicts another exemplary implementation of the executable graph-based model, consistent with disclosed embodiments of the present disclosure;

FIG. 10 shows an example computing system for carrying out methods of the present disclosure, consistent with disclosed embodiments of the present disclosure;

FIG. 11 illustrates a flowchart of a method for implementation of audio nodes in the executable graph-based model, consistent with disclosed embodiments of the present disclosure; and

FIG. 12 illustrates a flowchart of a method for execution of a first audio action, consistent with disclosed embodiments of the present disclosure.

### DETAILED DESCRIPTION

The detailed description of the appended drawings is intended as a description of the embodiments of the present disclosure and is not intended to represent the only form in which the present disclosure may be practiced. It is to be understood that the same or equivalent functions may be accomplished by different embodiments that are intended to be encompassed within the spirit and scope of the present disclosure.

### Overview

Graph-based models are becoming increasingly prevalent across a wide array of industries, primarily credited for their ability to represent and analyze complex relationships between interconnected entities. These models are composed of nodes including vertices and edges, where vertices signify real-world entities, and edges depict the relationships or associations between them. This structural flexibility enables graph-based models to be applied effectively in diverse domains such as marketing, research, healthcare, hospitality, and others.

The generic nature of graph-based models allows them to adapt to various contexts without requiring significant structural changes. Additionally, these models often include overlay nodes, which are equipped with processing logic. This logic, when executed, enables the overlay nodes to perform operations such as data processing, analysis, or automated workflows on other nodes within the graph.

Despite their inherent adaptability, the versatility of graph-based models is often accompanied by certain inefficiencies. The generic design of nodes, while flexible, may result in sub-optimal performance for domain-specific applications. For example, the lack of tailored structures or processing logic limits the potential of graph-based models to leverage unique requirements or nuances within a specific domain.

The present disclosure is directed to facilitation of audio nodes in an executable graph-based model of an overlay system. The executable graph-based model is a customized hypergraph with hyper-edges that are realized by way of executable nodes. Each executable node is associated with a particular node-type. For example, an edge node corresponds to a base node with an edge node-type. Nodes (for example, base nodes and executable nodes) are connected with other nodes by way of roles included in an edge node therebetween. In some embodiments, roles are represented by way of nodes of role node-type. A role node between two nodes may be indicative of a context regarding an association therebetween. The executable graph-based model also includes a plurality of overlay nodes that incorporate in-situ features in the overlay system. Each overlay node is associated with one or more nodes (for example, a vertex node, an edge node, or the like) of the executable graph-based model and includes a corresponding processing logic that when executed implements a functionality thereof on the associated nodes. Hence, the processing logic is implemented within the executable graph-based model and is not required to be retrieved from any external system.

The overlay system disclosed herein facilitates implementation of the audio nodes in the executable graph-based model. The executable graph-based model may include a plurality of audio nodes (for example, a plurality of generic audio nodes and a plurality of run-time audio nodes). An audio node of the executable graph-based model may represent an audio file of an external system by representing various configurations (for example, audio configurations) associated therewith, in the executable graph-based model. The audio node further includes an audio reference (for example, a storage location, a pointer, or the like) to the audio file in the external system. The executable graph-based model may further include a plurality of audio action overlay nodes. Each audio action overlay node may include processing logic that when executed based on an associated audio node may cause a corresponding audio operation to be performed on an audio file being represented by the associated audio node. Each audio action overlay node may include a module reference (for example, a storage location, a pointer, or the like) to a corresponding audio action module in the external system. The module reference may be used to access the corresponding audio action module. An audio action module may include processing logic that when executed may implement one or more algorithms, operations, techniques, or the like to perform one or more audio operations (for example, audio creation operations, audio modification operations, audio analysis operations, audio deletion operations, or the like) on one or more audio files of the external system.

In operation, a first audio action overlay node associated with a first audio node may have a first module reference associated with a first audio action module in the external system. The first audio node may represent a first audio file of the external system and may include a first audio reference associated with the first audio file. The first audio action overlay node may retrieve the first audio reference from the first audio node associated therewith. Subsequently, the first audio action overlay node may communicate, using the first module reference, the first audio reference to the first audio action module. Based on the received first audio reference, the audio action module may execute a corresponding audio operation on the first audio file. Subsequently, the audio action module may communicate an output of the audio operation to the first audio action overlay node which may update the executable graph-based model to reflect the output of the audio operation.

Thus, the disclosed overlay system facilitates implementation of the plurality of audio nodes in the executable graph-based model. An audio node may be a node of the executable graph-based model that may be dedicated, specialized, and customized to represent an audio file of the external system associated with the overlay system. The disclosed overlay system further includes the plurality of audio action overlay nodes having processing logic that when executed on one or more associated audio nodes may cause execution of various audio operations (for example, audio creation, audio modification, audio analysis, audio deletion, or the like) on audio files of the external system being represented by the one or more associated audio nodes. Such implementation of audio nodes and audio action overlay nodes significantly eliminates the disadvantage of a limited use of capabilities of graph-based models by optimizing the use of the executable graph-based model for dedicated purposes. Hence, the disclosed overlay system offers numerous advantages, including enhanced efficiency and performance through optimized and customized node structures and tailored processing logic. Therefore, the disclosed overlay system enables faster data processing and reduced computational overhead. It ensures increased scalability by improving resource management, allowing the overlay system to handle large and complex datasets effectively across diverse domains. Furthermore, it enables domain-specific customization by adapting node and node structures to meet the unique requirements of specific industries, such as marketing, healthcare, or hospitality. This results in more accurate insights, streamlined operations, and maximized utilization of the executable graph-based model, unlocking its full potential for specialized applications while retaining their inherent versatility.

### Figure description:

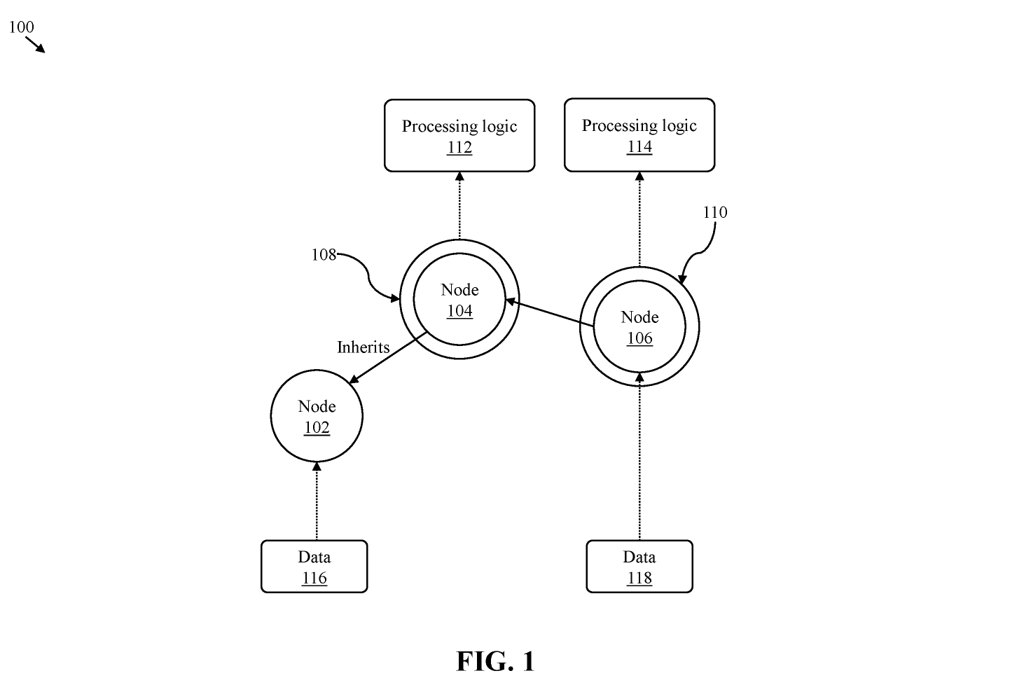

FIG. 1 is a graph that illustrates a composition of an executable graph-based model 100, consistent with disclosed embodiments of the present disclosure. Referring to FIG. 1, the executable graph-based model 100 is generally formed of a data structure (e.g., a graph-based model or a graphical model) comprising a plurality of nodes 102-106, which can be functionally extended with processing logic via the use of overlays. For example, as shown in FIG. 1, the nodes 104 and 106 are functionally extended with processing logic via the use of overlay nodes 108 and 110, respectively. Although not shown, the node 102 can be similarly extended with processing logic via the use of one or more overlays. Each overlay includes processing logic, such as processing logic 112 and 114, which are associated with the overlay nodes 108 and 110, respectively. At run-time, data such as data 116 and 118, is associated with the nodes 102 and 106, respectively. Further, the overlay nodes 108 and 110 of the nodes 104 and 106, respectively, provide the functionality to respond to stimuli and interact with, manipulate, or otherwise process the data based on the stimuli. Further, the node 104 inherits the node 102, and hence, also inherits the data 116 which is associated with the node 102. In some embodiments, the node 102 may be extended to have one or more overlays. In such embodiments, the node 104 may further inherit the overlays of the node 102.

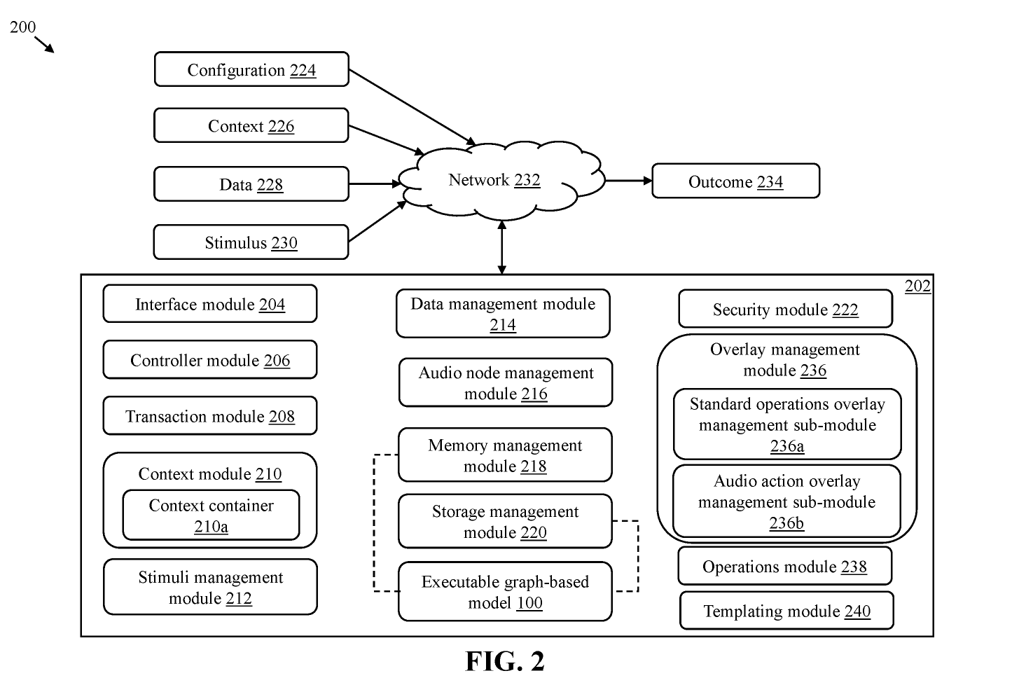

Each element within the executable graph-based model 100 (both the data and the processing functionality) is implemented by way of a node. A node forms the fundamental building block of all executable graph-based models. A node may be an executable node. A node that is extended by way of an overlay node forms an executable node. One or more nodes are extended to include overlays in order to form the executable graph-based model 100. As such, the executable graph-based model 100 includes one or more nodes that can be dynamically generated, extended, or processed by one or more other modules within an overlay system (shown in FIG. 2). Throughout the description, the terms “overlay node” and “overlay” are used interchangeably.

Notably, the structure and functionality of the data processing are separate from the data itself when offline (or at rest) and are combined dynamically at run-time. The executable graph-based model 100 thus maintains the separability of the data and the processing logic when offline. Moreover, by integrating the data and the processing logic within a single model, processing delays or latencies are reduced because the data and the processing logic exist within the same logical system. Therefore, the executable graph-based model 100 applies to a range of time-critical systems where efficient processing of the stimuli is required.

FIG. 2 is a block diagram that illustrates a system environment 200 of an overlay system 202 for execution, management, and configuration of the executable graph-based model 100, consistent with disclosed embodiments of the present disclosure. Referring to FIG. 2, the overlay system 202 includes the executable graph-based model 100. The overlay system 202 further includes an interface module 204, a controller module 206, a transaction module 208, a context module 210, a stimuli management module 212, a data management module 214, an audio node management module 216, a memory management module 218, a storage management module 220, and a security module 222. FIG. 2 further shows a configuration 224, a context 226, data 228, a stimulus 230, a network 232, and an outcome 234. Additionally, the overlay system 202 of the present disclosure includes an overlay management module 236, an operations module 238, and a templating module 240. In some embodiments, all the modules of the overlay system 202 except for the executable graph-based model 100 may collectively form processing circuitry that facilitates operations associated with a plurality of audio nodes of the executable graph-based model 100. The plurality of audio nodes may be created (namely, derived) based on generic nodes and run-time nodes of the executable graph-based model 100.

A generic node may refer to a node, in the executable graph-based model 100, with an edge node-type, a role node-type, an overlay node-type, or a vertex node-type. A first generic node with the vertex node-type is coupled to a second generic node with the vertex node-type by way of a third generic node with the edge node-type indicative of roles of the first and second generic nodes. A run-time node may include a node template and a node instance. The node template may be a predefined node structure and the node instance may be an implementation of the predefined node structure. The run-time node may have an edge node-type, a role node-type, an overlay node-type, or a vertex node-type. A first run-time node with the vertex node-type is coupled to a second run-time node with the vertex node-type by way of a third run-time node with the edge node-type indicative of roles of the first and second run-time nodes.

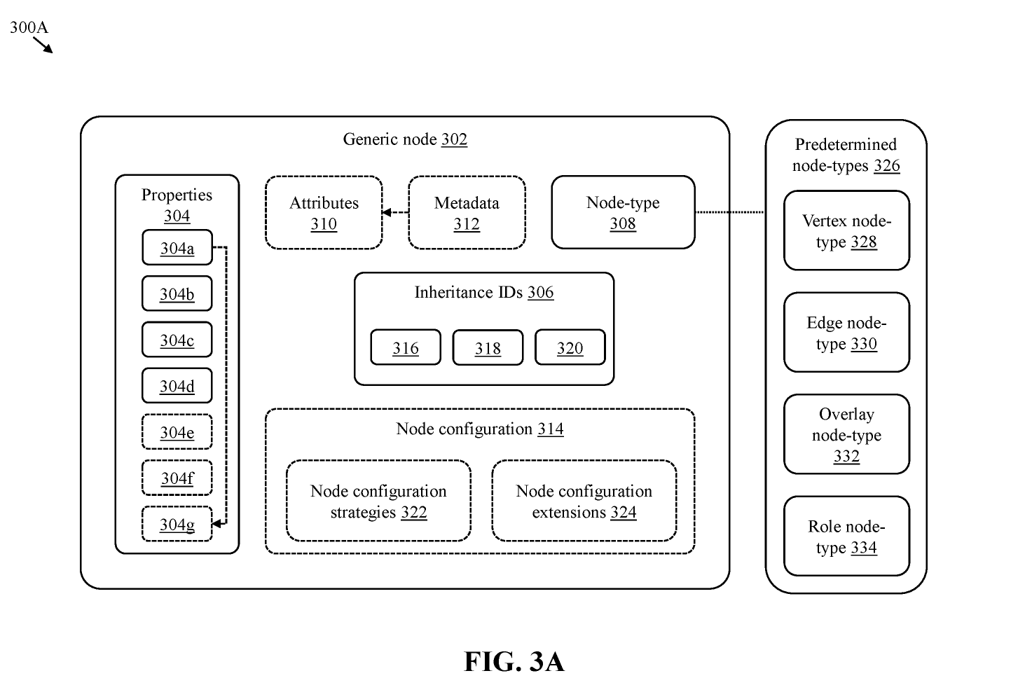

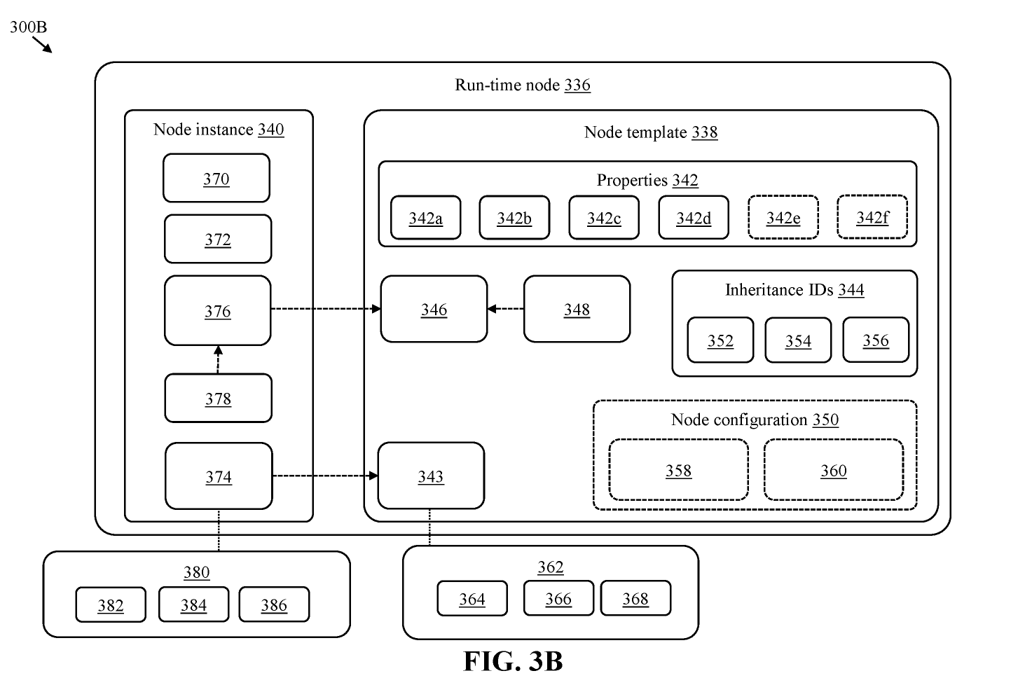

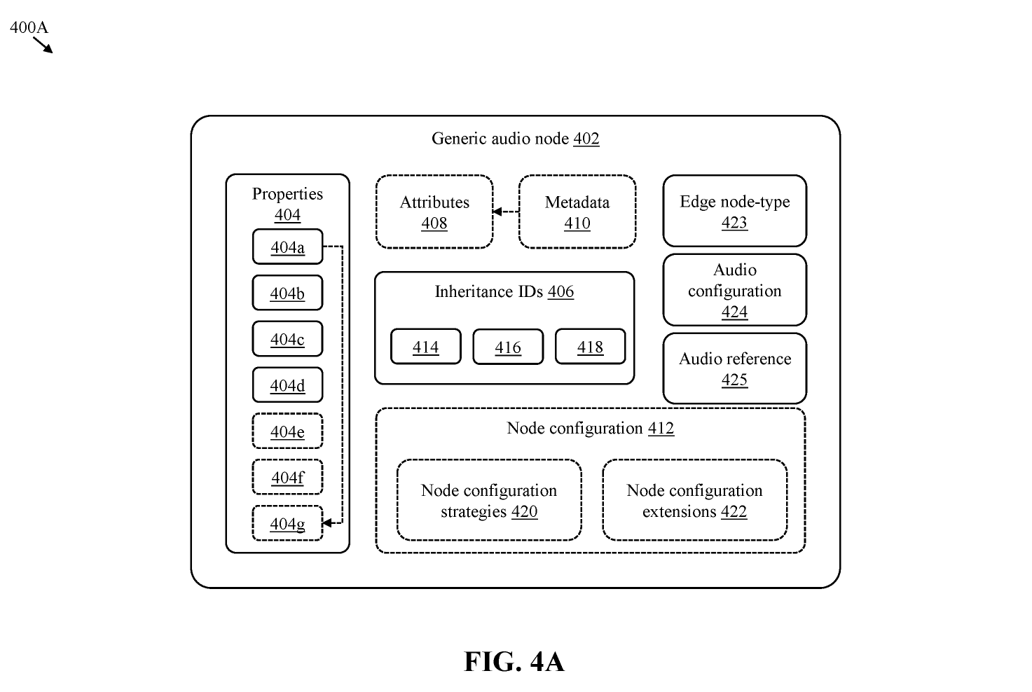

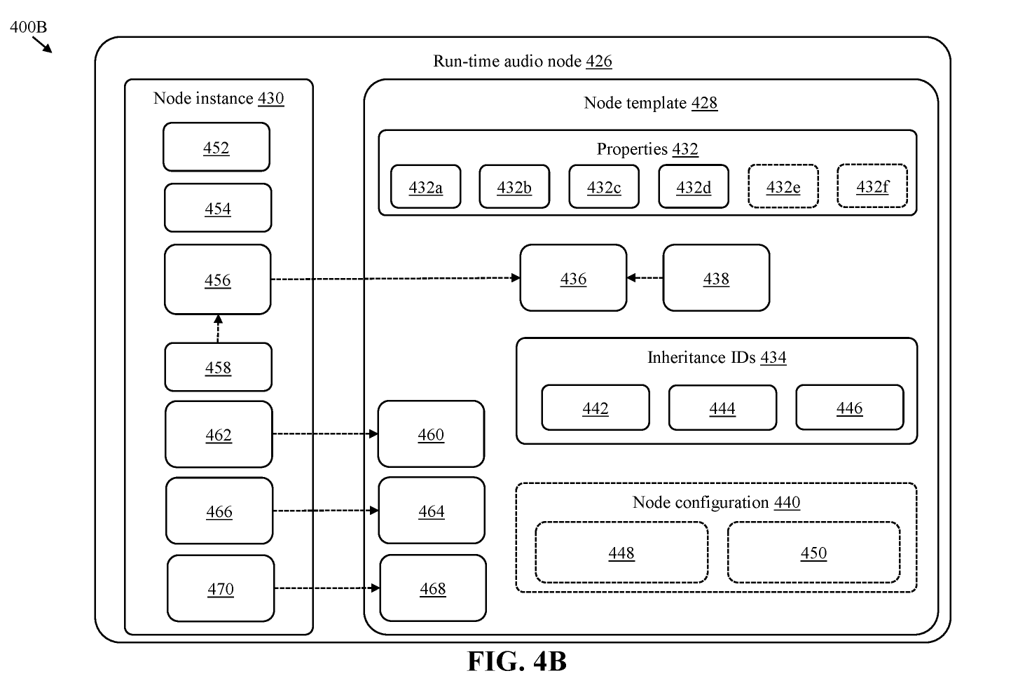

A standard node structure of the generic node and the run-time node (as described later in conjunction with FIGS. 3A and 3B, respectively) may be modified to form a generic audio node (depicted in FIG. 4A) and a run-time audio node (depicted in FIG. 4B), respectively, in the executable graph-based model 100. The generic audio node and the run-time audio node are collectively referred to as an audio node. An audio node may represent an audio file of an external system associated with the overlay system 202. Such a representation may be based on audio configurations of the audio file of the external system being stored in association with the audio node. The external system may include a plurality of audio files that may be represented by the plurality of audio nodes of the executable graph-based model 100.

The overlay system 202 may include suitable logic, circuitry, interfaces, and/or code, executable by the circuitry, that may be configured to facilitate one or more operations associated with the audio nodes in the executable graph-based model 100. One or more modules (for example, the controller module 206, the transaction module 208, or the like) of the overlay system 202 may be modified and customized to execute one or more operations associated with creation and management of the plurality of audio nodes and execution of transactions associated with the audio nodes.

The interface module 204 may include suitable logic, circuitry, interfaces, and/or code, executable by the circuitry, configured to provide a common interface between internal modules of the overlay system 202 and/or external sources. The interface module 204 provides an application programming interface (API), scripting interface, or any other suitable mechanism for interfacing externally or internally with any module of the overlay system 202. The configuration 224, the context 226, the data 228, and the stimulus 230 may be received by the interface module 204 via the network 232. Similarly, outputs (e.g., the outcome 234) produced by the overlay system 202 are passed by the interface module 204 to the network 232 for consumption or processing by external systems. In one embodiment, the interface module 204 supports one or more messaging patterns or protocols such as the simple object access protocol (SOAP), the representational state transfer (REST) protocol, or the like. The interface module 204 thus allows the overlay system 202 to be deployed in any number of application areas, operational environments, or architecture deployments. Although not illustrated in FIG. 2, the interface module 204 is communicatively coupled (e.g., connected either directly or indirectly) to one or more other modules or elements within the overlay system 202 (such as the controller module 206, the context module 210, the executable graph-based model 100, or the like). In one embodiment, the interface module 204 is communicatively coupled (e.g., connected either directly or indirectly) to one or more overlays within the executable graph-based model 100. The interface module 204 is further configured to receive one or more inputs via the API for creation of the plurality of audio nodes for representing the plurality of audio files of the external system. The interface module 204 is further configured to receive one or more inputs via the API for executing one or more audio operations (for example, audio creation operations, audio modification operations, audio analysis operations, or audio deletion operations) based on the plurality of audio nodes. The audio operations may be executed further based on a plurality of audio action overlay nodes described later in the description.

The controller module 206 may include suitable logic, circuitry, interfaces, and/or code, executable by the circuitry, configured to handle and process interactions and executions within the overlay system 202. As will be described in more detail below, stimuli (such as the stimulus 230) and their associated contexts (such as the context 226) provide the basis for all interactions within the executable graph-based model 100. Processing of such stimuli may lead to execution of processing logic associated with one or more overlays (for example, the plurality of audio action overlay nodes) within the executable graph-based model 100. The processing of the stimuli within the overlay system 202 may be referred to as a system transaction (namely, transaction). The processing and execution of stimuli (and associated overlay execution) within the overlay system 202 is handled by the controller module 206. The controller module 206 manages all received input stimuli (e.g., the stimulus 230) and processes them based on a corresponding context (e.g., the context 226). The context 226 determines the priority that is to be assigned to the processing of the corresponding stimulus by the controller module 206 or the context module 210. This allows each stimulus to be configured with a level of importance and prioritization within the overlay system 202. The controller module 206 may be further configured to facilitate and manage interactions among various modules of the overlay system 202 for execution of the audio operations within the overlay system 202.

The controller module 206 may maintain the integrity of the modules within the overlay system 202 before, during, and after a system transaction. The transaction module 208, which is associated with the controller module 206, is responsible for maintaining the integrity of the overlay system 202 through the lifecycle of a transaction. The transaction module 208 may be further configured to track and monitor various transactions associated with the audio operations associated with the overlay system 202. Based on such tracking and monitoring, the transaction module 208 may be configured to maintain system integrity of the overlay system 202. Maintaining system integrity via the controller module 206 and the transaction module 208 allows a transaction to be rolled back in an event of an expected or unexpected software or hardware fault or failure. The controller module 206 is configured to handle the processing of the stimulus 230 and transactions (for example, audio operations) through architectures such as parallel processing, grid computing, priority queue techniques, or the like. In one embodiment, the controller module 206 and the transaction module 208 are communicatively coupled (e.g., connected either directly or indirectly) to one or more overlays within the executable graph-based model 100.

As stated briefly above, the overlay system 202 utilizes a context-driven architecture, whereby the stimulus 230 within the overlay system 202 is associated with the context 226 which is used to adapt the handling or processing of the stimulus 230 by the overlay system 202. That is to say that the handling or processing of the stimulus 230 is done based on the context 226 associated therewith. Hence, the stimulus 230 is a contextualized stimulus. The context 226 may include details such as username, password, access token, device information, time stamp, one or more relevant identifiers (IDs), or the like, that are required for processing of the stimulus 230 within the executable graph-based model 100. Each context within the overlay system 202 may be extended to include additional information that is required for the processing of the stimulus (e.g., a query, a command, or an event).

The context module 210 may include suitable logic, circuitry, interfaces, and/or code, executable by the circuitry, configured to manage the handling of contexts within the overlay system 202. The context module 210 is responsible for processing any received contexts (e.g., the context 226) and translating the received context to an operation execution context.

In some examples, the operation execution context is larger than the received context because the context module 210 supplements the received context with further information necessary for the processing of the received context. The context module 210 passes the operation execution context to one or more other modules within the overlay system 202 to drive communication of data associated with the operation execution context. Contexts within the overlay system 202 can be external or internal. While some contexts apply to all application areas and problem spaces, some applications may require specific contexts to be generated and used to process the received stimulus 230. As will be described in more detail below, the executable graph-based model 100 is configurable (e.g., via the configuration 224) so as only to execute within a given execution context for a given stimulus.

As shown, the context module 210 includes a context container 210a that includes a set of defined contexts. The set of defined contexts may be generated by a module of the overlay system 202 or may be user defined and received by way of the interface module 204. Each defined context of the set of defined contexts pertains to a context that is associated with one or more operations for facilitating implementation and management of the plurality of audio nodes in the overlay system 202. That is to say that, one or more contexts of the set of defined contexts are indicative of the one or more operations to be executed by way of one or more audio nodes in the overlay system 202. The one or more operations are executed when a context of a corresponding stimuli matches one of the set of defined contexts. Each defined context of the set of defined contexts pertains to a context that is associated with one or more operations for facilitating the creation and maintenance of the audio nodes in the overlay system 202. That is to say that, one or more contexts of the set of defined contexts are indicative of the one or more operations to be executed for performing the creation and maintenance of the audio nodes in the overlay system 202. The set of defined contexts may include an audio node creation context, an audio node modification context, an audio node analysis context, an audio node deletion context, and a rollback context. The audio node creation context is indicative of a first set of audio operations for the creation of one or more audio nodes. The audio node modification context is indicative of a second set of audio operations for modification of one or more audio nodes. The audio node analysis context is indicative of a third set of audio operations for analysis of one or more audio nodes. The analysis of the audio node may be performed for genre detection, context identification, or other operations associated with audio files. The audio node deletion context is indicative of a fourth set of audio operations for deletion of one or more audio nodes. The rollback context is indicative of a rollback operation for the first or second set of audio operations executed for creation or modification of the one or more audio nodes such that a previous state of the audio node or the overlay system 202 may be achieved. Notably, a set of operations associated with the creation and maintenance of the one or more audio nodes is executed when a context of a corresponding stimuli matches one of the set of defined contexts.

The stimuli management module 212 may include suitable logic, circuitry, interfaces, and/or code, executable by the circuitry, configured to process externally received stimuli (e.g., the stimulus 230) and any stimuli generated internally from any module within the overlay system 202. The stimuli management module 212 is communicatively coupled (e.g., connected either directly or indirectly) to one or more overlays within the executable graph-based model 100 to facilitate the processing of stimuli within the executable graph-based model 100. The overlay system 202 utilizes different types of stimuli, such as a command (e.g., a transactional request), a query, or an event received from an external system such as an Internet-of-things (IoT) device. As previously stated, a stimulus (such as the stimulus 230) can be either externally or internally generated. In an example, the stimulus 230 may be a message that is internally triggered (e.g., generated) from any of the modules within the overlay system 202. Such internal generation of the stimulus 230 indicates that something has happened within the overlay system 202 and subsequent handling by one or more other modules within the overlay system 202 may be required. Internal stimulus 230 can also be triggered (e.g., generated) from the execution of processing logic associated with overlays within the executable graph-based model 100. In another example, the stimulus 230 may be externally triggered and may be generated based on an input received via a user interface associated with the controller module 206. The externally triggered stimulus 230 may be received in the form of a signal, a textual, audio, or visual input. The externally triggered stimulus 230 may be associated with the intent of a user to execute an operation indicated by the stimulus 230. The operation is executed in accordance with information included in the context 226 associated with the stimulus 230. The stimulus 230 may be indicative of one or more audio operations (for example, audio creation operations, audio modification operations, audio analysis operations, audio deletion operations, rollback operations, or the like) associated with one or more audio nodes of the plurality of audio nodes of the executable graph-based model 100.

The stimuli management module 212 may receive the stimuli (such as the stimulus 230) in real-time or near-real-time and communicate the received stimuli to one or more other modules or nodes of the executable graph-based model 100. In some examples, the stimuli are scheduled in a batch process. The stimuli management module 212 utilizes any suitable synchronous or asynchronous communication architectures or approaches in communicating the stimuli (along with associated information). The stimuli within the overlay system 202 are received and processed (along with a corresponding context) by the stimuli management module 212, which then determines the processing steps to be performed for the communication of data associated with each stimulus.

In one embodiment, the stimuli management module 212 processes the received stimuli in accordance with a predetermined configuration (e.g., the configuration 224) or dynamically determines what processing needs to be performed based on the contexts associated with the stimuli and/or based on a state of the executable graph-based model 100. The state of the executable graph-based model 100 refers to the current state of each node of the executable graph-based model 100 at a given point in time. The state of the executable graph-based model 100 is dynamic, and hence, may change based on processing of data by any of its nodes. In some examples, the processing of a stimulus (such as the stimulus 230) results in the generation, communication, or processing of data that further results in one or more outcomes (e.g., the outcome 234) being generated. Such outcomes are either handled internally by one or more modules in the overlay system 202 or communicated via the interface module 204 as an external outcome. In one embodiment, all stimuli and corresponding outcomes are recorded for auditing and post-processing purposes by, for example, the operations module 238 of the overlay system 202.

The data management module 214 may include suitable logic, circuitry, interfaces, and/or code, executable by the circuitry, configured to manage all data or information within the overlay system 202 (e.g., the data 228) for a given application. Operations performed by the data management module 214 include data loading, data unloading, data modeling, and data processing. The data management module 214 is communicatively coupled (e.g., connected either directly or indirectly) to one or more other modules within the overlay system 202 to complete some or all of these operations. For example, data storage is handled by the data management module 214 in conjunction with the storage management module 220. The data management module 214 may be further configured to manage data and information associated with each audio node of the plurality of audio nodes. In other words, the data management module 214 is further configured to manage configuration (namely, audio configurations) associated with each audio node of the plurality of audio nodes within the overlay system 202.

The audio node management module 216 may include suitable logic, circuitry, interfaces, and/or code, executable by the circuitry, configured to manage, design, store, and implement the plurality of audio nodes in the overlay system 202. The audio node management module 216 may be further configured to manage association between audio files of the external system and the audio nodes. In other words, the audio node management module 216 may cause each audio node to include an audio reference of an audio file of the external system being represented thereby. The audio node management module 216 may be further configured to manage association of each audio node of the plurality of audio nodes with audio configurations of a corresponding audio file of the external system that is being represented thereby. Additionally, the audio node management module 216 may be further configured to manage association between audio action modules of the external system and audio action overlay nodes of the executable graph-based model 100. The audio nodes may include the generic audio nodes and the run-time audio nodes. Further, each audio node may have an edge node-type. The audio node management module 216 is further configured to facilitate operations associated with execution of one or more transactions using the audio nodes.

The memory management module 218 may include suitable logic, circuitry, interfaces, and/or code, executable by the circuitry, configured to manage and optimize the memory usage of the overlay system 202. The memory management module 218 thus helps to improve the responsiveness and efficiency of the processing performed by one or more modules within the overlay system 202 by optimizing the memory handling performed by these modules. The memory management module 218 uses direct memory or some form of distributed memory management architecture (e.g., a local or remote caching solution). Additionally, or alternatively, the memory management module 218 deploys multiple different types of memory management architectures and solutions (e.g., reactive caching approaches such as lazy loading or a proactive approach such as write-through cache may be employed). These architectures and solutions are deployed in the form of a flat (single-tiered) or multi-tiered caching architecture where each layer of the caching architecture can be implemented using a different caching technology or architecture solution approach. In such implementations, each cache or caching tier can be configured (e.g., by the configuration 224) independent of the requirements for one or more modules of the overlay system 202. For example, data priority and an eviction strategy, such as least-frequently-used (LFU) or least-recently-used (LRU), can be configured for all or parts of the executable graph-based model 100. In one embodiment, the memory management module 218 is communicatively coupled (e.g., connected either directly or indirectly) to one or more overlays within the executable graph-based model 100.

The storage management module 220 may include suitable logic, circuitry, interfaces, and/or code, executable by the circuitry, configured to manage the temporary or permanent storage of data associated with the overlay system 202. The storage management module 220 is any suitable low-level storage device solution (such as a file system) or any suitable high-level storage technology such as another database technology (e.g., relational database management system (RDBMS) or NoSQL database). The storage management module 220 is directly connected to the storage device upon which the relevant data is persistently stored. For example, the storage management module 220 can directly address the computer-readable medium (e.g., hard disk drive, external disk drive, or the like) upon which the data is being read or written. Alternatively, the storage management module 220 is connected to the storage device via a network such as the network 232. As will be described in more detail later in the present disclosure, the storage management module 220 uses manifests to manage the interactions between the storage device and the modules within the overlay system 202. In one embodiment, the storage management module 220 is communicatively coupled (e.g., connected either directly or indirectly) to one or more overlays within the executable graph-based model 100. Throughout the description, the term ‘storage device’ is used interchangeably with the term ‘storage element’.

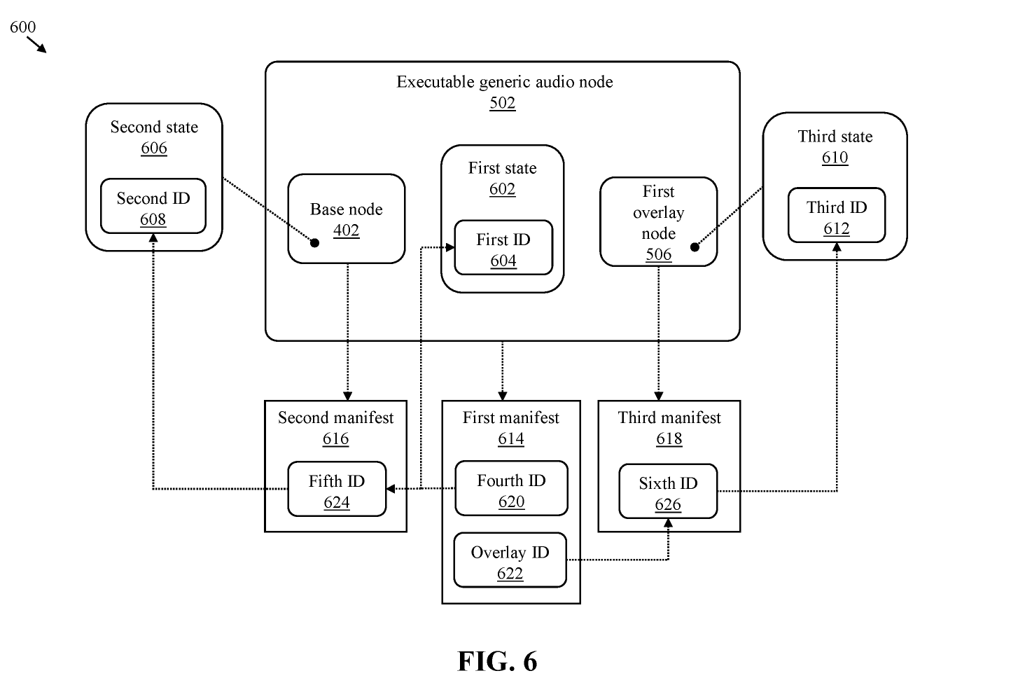

As described, storage, loading, and unloading of the executable graph-based model 100 or one or more components thereof (for example, the audio nodes) is facilitated by the memory management module 218 and the storage management module 220. The memory management module 218 and the storage management module 220 may facilitate such operations by interacting with the storage device that stores the executable graph-based model 100. The overlay system 202 further includes a plurality of manifest storages. The manifest storages are used by the memory management module 218 and the storage management module 220 to facilitate storage of manifest states (including manifest template states and manifest instance states) of nodes. The storage element may include a primary storage and a secondary storage. The primary storage may store the executable graph-based model 100 and may also store nodes (for example, the audio nodes) that are loaded in the executable graph-based model 100. The secondary storage may store node states, manifests, and manifest states associated with nodes (for example, the audio nodes) that are unloaded from the executable graph-based model 100. Storage and retrieval of nodes (for example, the audio nodes) are described in detail in conjunction with FIG. 6.

The security module 222 may include suitable logic, circuitry, interfaces, and/or code, executable by the circuitry, configured to manage the security of the overlay system 202. This includes security at a system level and a module level. Security is hardware-related, network-related, or software-related, depending on the operational environment, the architecture of the deployment, or the data and information contained within the overlay system 202. For example, if the system is deployed with a web-accessible API (as described above in relation to the interface module 204), the security module 222 can enforce a hypertext transfer protocol secure (HTTPS) protocol with the necessary certification. As a further example, if the data or information associated with the nodes (for example, the audio nodes) of the overlay system 202 contains Personally Identifiable Information (PII) or Protected Health Information (PHI), the security module 222 can implement one or more layers of data protection to ensure that sensitive audio configurations (for example, audio configuration that corresponds to confidential data) associated with audio files of the external system are correctly processed and stored. In an additional example, in implementations whereby the overlay system 202 operates on United States of America citizen medical data, the security module 222 may enforce additional protections or policies as defined by the United States Health Insurance Portability and Accountability Act (HIPAA). Similarly, if the overlay system 202 is deployed in the European Union (EU), the security module 222 may enforce additional protections or policies to ensure that the data processed and maintained by the overlay system 202 complies with the General Data Protection Regulation (GDPR). In one embodiment, the security module 222 is communicatively coupled (e.g., connected either directly or indirectly) to one or more overlays within the executable graph-based model 100, thereby directly connecting security execution to the data/information in the executable graph-based model 100. The security module 222 thus acts as a centralized coordinator that works in conjunction with the overlay management module 236 for managing and executing security-based overlays.

The overlay management module 236 may include suitable logic, circuitry, interfaces, and/or code, executable by the circuitry, configured to manage all overlays (for example, standard operations overlay nodes, audio action overlay nodes) within the overlay system 202. The overlays may be generic standard operations overlays, run-time standard operations overlays, generic audio action overlays, or run-time audio action overlays. Audio action overlays are nodes that are associated with one or more audio nodes by way of a direct connection or an indirect connection. Direct connection may refer to association between an audio action overlay node and an associated audio node without any intermediate node. Indirect connection may refer to association between an audio action overlay node and an associated audio node by way of one or more intermediate nodes. An audio action overlay may be associated with an audio node by extending functionality of the audio node. Alternatively, the audio action overlay node may be associated with the audio node by way of one or more audio nodes (for example, based on inheritance, based on group level association, or the like). An audio action overlay may include a module reference (for example, a pointer, a storage location, or the like) to an audio action module of the external system. The audio action overlay may include processing logic that, when executed, may cause the audio action module to perform a corresponding operation on an audio file of the external system being represented by an audio node associated with the audio action overlay node. The audio action overlay node that may not be a run-time audio action overlay node may be referred to as a generic audio action overlay node. The run-time audio action overlay node may have a description similar to the audio action overlay node. In addition, the run-time audio action overlay node may include a node template and a node instance. The term audio action overlay node is used throughout the description to refer to the generic audio action overlay node and the run-time audio action overlay node, collectively.

Operations performed by the audio node management module 216 may further include overlay storage management, overlay structure modeling, overlay logic creation and execution, and overlay loading and unloading (within the executable graph-based model 100). The audio node management module 216 is communicatively coupled (e.g., connected either directly or indirectly) to one or more other modules (for example, the overlay management module 236, or the like) within the overlay system 202 to complete some or all of these operations. For example, overlays can be persisted in some form of physical storage using the storage management module 220 (as described in more detail below). As a further example, overlays can be compiled and preloaded into memory via the memory management module 218 for faster run-time execution.

The overlay management module 236 may include a standard operations overlay management sub-module 236a and an audio action overlay management sub-module 236b. The standard operations overlay management sub-module 236a is configured to perform operations of the overlay management module 236 that are associated with the standard operations overlays and run-time standard operations overlays. The audio action overlay management sub-module 236b is configured to perform operations of the overlay management module 236 that are associated with the audio action overlays and run-time audio action overlays.

The operations module 238 may include suitable logic, circuitry, interfaces, and/or code, executable by the circuitry, configured to track operational metrics and the behavior of all modules of the overlay system 202. Operational metrics of a module are indicative of statistics associated with the performance of the module while performing an operation (for example, communication, data processing, stimulus processing, or the like) associated with the nodes (for example, the audio nodes) of the executable graph-based model 100.

The templating module 240 may include suitable logic, circuitry, interfaces, and/or code, executable by the circuitry, configured to enable the overlay system 202 to implement a templated version of one or more nodes (for example, the audio nodes) of the executable graph-based model 100. The templating module 240 may be configured to create one or more predefined templates in the executable graph-based model 100. The templating module 240 may be further configured to generate one or more node instances of the predefined node templates for the implementation of the templated version of the executable graph-based model 100. Notably, the templating module 240 ensures ontology integrity by enforcing structure and rules of a template when generating instances of the template at run-time. Ontology integrity refers to consistency, accuracy, and correctness of an ontology. Thus, the templating module 240 ensures that the consistency, accuracy, and correctness of the ontology of the executable graph-based model 100 are maintained while generating the instances of the template at run-time. The templating module 240 may be communicatively coupled (i.e., connected either directly or indirectly) to one or more nodes and/or one or more overlays within the executable graph-based model 100.

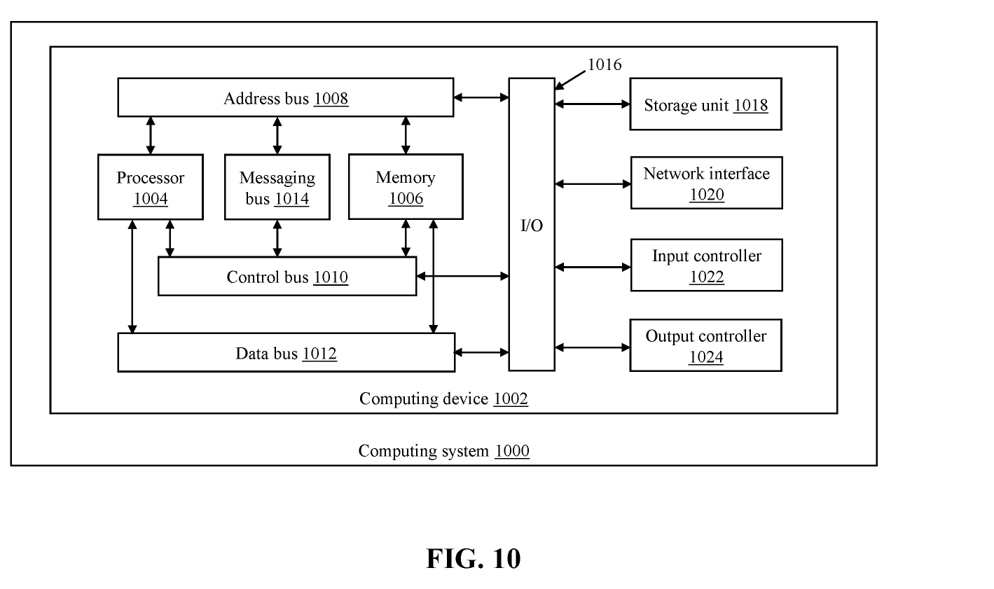

Beneficially, various features of the overlay system 202 support the processing circuitry and a computing system (shown in FIG. 10) implementing the overlay system 202 in significantly enhancing its performance. The significant enhancement in performance may include significantly increased throughput and efficiency, as well as significantly reduced cost complexity, processing complexity, time complexity, latency, waiting time, turnaround time, or the like.

The functionality of two or more of the modules included in the overlay system 202 may be combined within a single module. Conversely, the functionality of a single module can be split into two or more further modules which can be executed on two or more devices. The modules described above in relation to the overlay system 202 can operate in a parallel, distributed, or networked fashion. The overlay system 202 may be implemented in software, hardware, or a combination of both software and hardware. Examples of suitable hardware modules include, but are not limited to, a general-purpose processor, a field programmable gate array (FPGA), and/or an application-specific integrated circuit (ASIC). Software modules can be expressed in a variety of software languages such as C, C++, Java, Ruby, Visual Basic, Python, and/or other object-oriented, procedural, or functional programming languages.

Although it is described that the overlay system 202 includes a single executable graph-based model (e.g., the executable graph-based model 100), the scope of the present disclosure is not limited to it. In other embodiments, the overlay system 202 may include more than one executable graph-based model, without deviating from the scope of the present disclosure. In such a scenario, each executable graph-based model is implemented and managed in a manner that is similar to the executable graph-based model 100.

Having described the overlay system 202 for executing and managing executable graph-based models, the description will now turn to the elements of an executable graph-based model, specifically, the concept of a node. Unlike conventional graph-based systems, all elements (e.g., data, overlays, etc.) within the executable graph-based model 100 are implemented as nodes. As will become clear, this allows executable graph-based models to be flexible, extensible, and highly configurable.

FIG. 3A is a block diagram 300A that illustrates a standard structure of a generic node 302 within the executable graph-based model 100, consistent with disclosed embodiments of the present disclosure. Referring to FIG. 3A, the generic node 302 corresponds to a generic node of the executable graph-based model 100. The generic node 302 further corresponds to the core structure of the executable graph-based model 100 and forms the foundational building block for all data and processing logic within the executable graph-based model 100. The generic node 302 includes properties 304, inheritance IDs 306, and a node-type 308. The generic node 302 optionally includes one or more attributes 310, metadata 312 associated with the attributes 310, and a node configuration 314.

The properties 304 of the generic node 302 include a unique ID 304a, a version ID 304b, a namespace 304c, and a name 304d. The properties 304 optionally include one or more icons 304e, one or more labels 304f, and one or more alternative IDs 304g. The inheritance IDs 306 of the generic node 302 include an abstract flag 316, a leaf flag 318, and a root flag 320. The node configuration 314 optionally includes one or more node configuration strategies 322 and one or more node configuration extensions 324.

The unique ID 304a is unique for each node within the executable graph-based model 100. The unique ID 304a is used to register, manage, and reference the generic node 302 within the system (e.g., the overlay system 202). In some embodiments, the one or more alternative IDs 304g are associated with the unique ID 304a to help manage communications and connections with external systems (e.g., during configuration, sending stimuli, or receiving outcomes). The version ID 304b of the generic node 302 is incremented when the generic node 302 undergoes a transactional change. This allows the historical changes between versions of the generic node 302 to be tracked by modules or overlays within the overlay system 202. The namespace 304c of the generic node 302, along with the name 304d of the generic node 302, is used to help organize nodes within the executable graph-based model 100. That is, the generic node 302 is assigned a unique name 304d within the namespace 304c such that the name 304d of the generic node 302 need not be unique within the entire executable graph-based model 100, only within the context of the namespace 304c to which the generic node 302 is assigned. The generic node 302 optionally includes one or more icons 304e, which are used to provide a visual representation of the generic node 302 when visualized via a user interface. The one or more icons 304e can include icons at different resolutions and display contexts such that the visualization of the generic node 302 is adapted to different display settings and contexts. The generic node 302 also optionally includes one or more labels 304f, which are used to override the name 304d when the generic node 302 is rendered or visualized.

The generic node 302 supports the concept of inheritance of data and processing logic associated with any other node of the executable graph-based model 100 that is inherited by the generic node 302. This allows the behavior and functionality of the generic node 302 to be extended or derived from the inherited node of the executable graph-based model 100. The inheritance IDs 306 of the generic node 302 indicate the inheritance-based information, which may apply to the generic node 302. The inheritance IDs 306 comprise a set of Boolean flags that identify the inheritance structure of the generic node 302. The abstract flag 316 allows the generic node 302 to support the construct of abstraction. When the abstract flag 316 takes a value ‘true’, the generic node 302 is flagged as abstract that is to say that it cannot be instantiated or created within an executable graph-based model (e.g., the executable graph-based model 100). Thus, in an instance when the generic node 302 has the abstract flag 316 set to ‘true’, the generic node 302 may only form the foundation of other nodes that inherit therefrom. By default, the abstract flag 316 of the generic node 302 is set to ‘false’. The leaf flag 318 is used to indicate whether any other node may inherit from the generic node 302. If the leaf flag 318 is set to ‘true’, no other node may inherit from the generic node 302 (but unlike an abstract node, a node with the leaf flag 318 set may be instantiated and created within the executable graph-based model 100). The root flag 320 is used to indicate whether the generic node 302 inherits from any other node. If the root flag 320 is set to ‘true’, the generic node 302 does not inherit from any other node. The generic node 302 is flagged as leaf (e.g., the leaf flag 318 is set to ‘true’) and/or root (e.g., the root flag 320 is set to ‘true’), or neither (e.g., both the leaf flag 318 and the root flag 320 are set to ‘false’). It will be apparent to a person skilled in the art that a node cannot be flagged as both abstract and leaf (e.g., the abstract flag 316 cannot be set to ‘true’ whilst the leaf flag 318 is set to ‘true’).

As stated above, all elements of the executable graph-based model 100 are defined as nodes. This functionality is in part realized due to the use of a node-type. The node-type 308 of the generic node 302 is used to extend the functionality of the generic node 302. All nodes within the executable graph-based model 100 comprise a node-type that defines additional data structures and implements additional executable functionality. A node-type thus includes data structures and functionality that are common across all nodes that share that node-type. Therefore, composition of a node with a node-type improves extensibility by allowing the generation of specialized node functionalities for specific application areas. Such extensibility is not present in prior art graph-based models. As illustrated in FIG. 3A, the generic node 302 and the node-type 308 are one logical unit that is not separated in the context of an executing system at run-time (e.g., in the context of execution of an executable graph-based model).

FIG. 3A further shows the plurality of predetermined node-types 326, which provides a non-exhaustive list of node-types for the node-type 308 associated with the generic node 302. The plurality of predetermined node-types 326 includes a vertex node-type 328 and an edge node-type 330. The vertex node-type 328 (also referred to as a data node-type or a value node-type) includes common data structures and functionality related to the ‘things’ modeled in the graph (e.g., the data). The edge node-type 330 includes common data structures and functionality related to coupling/linking/associating two or more nodes. A node having the edge node-type 330 may connect two or more nodes, and thus the edge node-type 330 constructs associations and connections between nodes (for example, objects or ‘things’) within the executable graph-based model 100. The edge node-type 330 is not restricted to the number of nodes that can be associated or connected by a node having the edge node-type 330. The data structures and functionality of the edge node-type 330 thus define a hyper-edge, which allows two or more nodes to be connected through a defined set of roles. A role defines a connective relationship between the two or more nodes and hence allows an edge node to connect two or more nodes such that the two or more nodes may have more than one relationship therebetween.

The plurality of predetermined node-types 326 further includes an overlay node-type 332 and a role node-type 334. As will be described in more detail below, a node with the overlay node-type 332 is used to extend the functionality of a node, such as the generic node 302, to incorporate processing logic. Unlike non-overlay nodes, an overlay node (e.g., a node having the overlay node-type 332) includes processing logic which determines the functionality of the overlay node. The processing logic of an overlay node includes a block of executable code, or instructions, which carries out one or more operations associated with the communication of data within the executable graph-based model 100. The block of executable code is pre-compiled code, code that requires interpretation at run-time, or a combination of both. Different overlay nodes provide different processing logic to realize different functionality. For example, an encryption overlay node includes an encryption technique using which an associated node is to be protected/secured and processing logic for facilitating such security/protection of the associated node. A generic node 302 with the overlay node-type 332 may be a standard operations overlay node or an audio action overlay node. The overlay node-type 332 may be a standard operations overlay node-type or an audio action overlay node-type. In an instance, when the generic node 302 may have processing logic that, when executed, may cause an audio operation to be performed based on an associated audio node, the generic node may correspond to an audio action overlay node. In another instance, when the generic node 302 may include processing logic that, when executed, may perform one or more operations on an associated node (for example, generic node or audio node) that may be different from audio operations, the generic node 302 may correspond to as a standard operations overlay node. The standard operations overlay node may include processing logic that, when executed, may perform one or more operations that may be internal to the overlay system 202 and may not require any interaction with the external system. The generic node 302 with the overlay node-type 332 may be a generic overlay node (for example, a generic standard operations overlay node and a generic audio actions overlay node).

The role node-type 334 defines a connective relationship between two nodes, for example, an edge node and a first vertex node. A node with the role node-type 334 defines a relationship without expressly defining the first vertex node to which the edge node connects. A number of roles (and thus a number of connections) that an edge node-type can have is not limited.

The one or more attributes 310 correspond to the data associated with the generic node 302 (e.g., the data represented by the generic node 302 within the executable graph-based model 100 as handled by the data management module 214). Notably, a node in the executable graph-based model 100 that is not associated with data may not have any attributes. The one or more attributes 310 represent a complex data type. Each attribute of the one or more attributes 310 is composed of an attribute behavior. Attribute behavior may be one of a standard attribute behavior, a reference attribute behavior, a derived attribute behavior, or a complex attribute behavior. The attribute behavior of each attribute defines the behavior of the corresponding attribute. The attribute behavior of each attribute may be configured by associated attribute configurations. The attribute configurations are examples of attribute configuration extensions which are node configuration extensions (e.g., they are part of the one or more node configuration extensions 324 of the generic node 302 shown in FIG. 3A). The standard attribute behavior may be configured by a standard attribute configuration, the reference attribute behavior may be configured by a reference attribute configuration, the derived attribute behavior is configured by a derived attribute configuration, and the complex attribute behavior is configured by a complex attribute configuration.

The attribute behavior defines the behavior of the corresponding attribute. The standard attribute behavior is a behavior that allows read-write access to the data of the corresponding attribute. The reference attribute behavior is a behavior that allows read-write access to the data of the corresponding attribute but restricts possible values of the data to values defined by a reference data set. The reference attribute configuration associated with the reference attribute behavior includes appropriate information to obtain a reference data set of possible values. The derived attribute behavior is a behavior that allows read-only access to data of the corresponding attribute. Also, data of the corresponding attribute is derived from other data or information, within the executable graph-based model 100 in which an executable node of the corresponding attribute is used. The data is derived from one or more other attributes associated with the node or is derived from more complex expressions depending on the application area. In one embodiment, the derived attribute configuration (which is used to configure the derived attribute behavior) includes mathematical and/or other forms of expressions (e.g., regular expressions, templates, or the like) that are used to derive the data (value) of the corresponding attribute. The complex attribute behavior is a behavior that allows the corresponding attribute to act as either a standard attribute behavior if the data of the corresponding attribute is directly set, or a derived attribute behavior if the data of the corresponding attribute is not directly set.

As shown, the generic node 302 further includes the metadata 312 (e.g., data stored as a name, a confidentiality indicator for indicating data as sensitive and/or confidential, an average processing time required for processing data, or the like) which is associated with either the generic node 302 or an attribute (for example, the one or more attributes 310) of the generic node 302. An attribute within the one or more attributes 310 may either have an independent state or a shared state. That is to say, an attribute may be a value-shared attribute or a non-value-shared attribute. An independent attribute has data that is not shared with any other node within the executable graph-based model 100. Conversely, a shared attribute has data that is shared with one or more other nodes within the executable graph-based model 100. For example, if two nodes within the executable graph-based model 100 comprise a shared-data attribute with a value state shared by both nodes, updating the data (e.g., the value) of this shared attribute will be reflected across both nodes.

The node configuration 314 provides a high degree of configurations for the different elements of the generic node 302. The node configuration 314 optionally includes the one or more node configuration strategies 322 and/or the one or more node configuration extensions 324 which are complex data types. An example of a concrete node configuration strategy is an ID strategy, associated with the configuration of the unique ID 304a of the generic node 302, which creates message source IDs. A further example of the concrete node configuration strategies 322 is a versioning strategy, associated with the configuration of the version ID 304b of the generic node 302, which supports major and minor versioning (depending on the type of transactional change incurred by the generic node 302). The versioning strategy may be adapted to a native filing system of a user device hosting the overlay system 202 or a third-party data storage (for example, Snowflake^{®}, or the like) associated with the overlay system 202. All attribute configurations may be examples of node configuration extensions 324.

FIG. 3B is a block diagram 300B that illustrates a standard structure of a run-time node 336 within the executable graph-based model 100, consistent with disclosed embodiments of the present disclosure. Referring to FIG. 3B, the run-time node 336 corresponds to the core structure of the executable graph-based model 100 and forms the foundational building block for all data and processing logic within the executable graph-based model 100. The run-time node 336 is shown to include a node template 338 and a node instance 340. The node instance 340 is generated according to the node template 338. The node template 338 forms a data structure for the node instance 340. The run-time node 336 is shown in FIG. 3B is a compositional structure that is generated and executed, at run-time as part of the executable graph-based model 100. In other words, the node template 338 is defined as ‘offline’ and the node instance 340 and the run-time node 336 may be run-time structures that may be dynamically generated during execution of the executable graph-based model 100.

The node template 338 comprises a predetermined node structure. Further, the node template 338 defines one or more rules that govern the generation of the node instance 340. The node instance 340 is an implementation of the node template 338. In other words, the node instance 340 is generated based on the predetermined node structure and the one or more rules of the node template 338. The node template 338 cannot be modified during the execution but may be modified during offline mode or at rest. During execution, only the node instance 340 of the run-time node 336 may be modified.

The node template 338 may include properties 342, node type template 343, inheritance IDs 344, and a set of attribute templates 346. The node template 338 may optionally include metadata 348 and node configuration 350. The properties 342 of the node template 338 include a unique identifier (ID) 342a, a version ID 342b, a namespace 342c, a name 342d, and optionally include one or more icons 342e and a set of labels 342f. The inheritance IDs 344 comprise an abstract flag 352, a leaf flag 354, and a root flag 356. The node configuration 350 optionally comprises one or more node configuration strategies 358 and/or one or more node configuration extensions 360. FIG. 3B further shows a plurality of predetermined node type templates 362. The plurality of predetermined node type templates 362 may include a vertex node type template 364, an edge node type template 366, and an overlay node type template 368. Further, the node instance 340 may include a unique ID 370, a version ID 372, a node type instance 374, and a set of attribute instances 376. The node instance 340 may optionally include metadata 378. FIG. 3B further shows a plurality of predetermined node type instances 380. The plurality of predetermined node type instances 380 include a vertex node type instance 382, an edge node type instance 384, and an overlay node type instance 386.

The unique ID 342a is unique for each node template within the executable graph-based model 100. Similarly, the unique ID 370 is unique for each node instance within the executable graph-based model 100. The unique ID 342a and the unique ID 370 may be used to register, manage, and reference the node template 338 and the node instance 340, respectively, within the overlay system 202. The version ID 342b of the node template 338 represents a version of the node template 338. The version ID 342b gets incremented when the node template 338 undergoes a transactional change. Similarly, the version ID 372 of the node instance 340 represents a version of the node instance 340. The version ID 372 gets incremented when the node instance 340 undergoes a transactional change. The namespace 342c of the node template 338, along with the name 342d of the node template 338, is used to organize node templates within the executable graph-based model 100. That is, the node template 338 is assigned a unique name 342d within the namespace 342c such that the name 342d of the node template 338 need not be unique within the entire executable graph-based model 100, only within the context of the namespace 342c to which the node template 338 is assigned. The node template 338 optionally comprises one or more icons 342e, which may be used to provide a visual representation of the node template 338. The one or more icons 342e can include icons at different resolutions and display contexts such that the visualization of the node is adapted to different display contexts and settings. The node template 338 also optionally comprises the set of labels 342f, which may be used to override the name 342d when the node template 338 is rendered or visualized.

The node template 338 supports the software development feature of multiple inheritance by maintaining references (not shown) to zero or more other node templates, which then act as the base of the node template 338. This allows the behavior and functionality of a node template to be extended or derived from one or more other node templates within an executable graph-based model. The node instance 340 likewise supports multiple inheritance because it is an instance representation of the node template 338. The multiple inheritance structure of the node instance 340 is, however, limited to the corresponding instance realization of the multiple inheritance structure defined by the node template 338, i.e., one node instance 340 is created and managed for each node template 338 defined in the inheritance hierarchy for a node instance of a node template.

The inheritance IDs 344 of the node template 338 provide an indication of the inheritance-based information, which is applicable, or can be applicable, to the node template 338. The node template 338 supports the concept of inheritance of data and processing logic associated with any other node template of the executable graph-based model 100 that is inherited by the node template 338. This allows the behavior and functionality of the node template 338 to be extended or derived from the inherited node template of the executable graph-based model 100. The inheritance IDs 344 of the node template 338 indicate the inheritance-based information, which may apply to the node template 338. The inheritance IDs 344 comprise a set of Boolean flags that identify the inheritance structure of the run-time node 336. The abstract flag 352 allows the node template 338 to support the construct of abstraction. When the abstract flag 352 takes a value ‘true’, the node template 338 is flagged as abstract that is to say that it cannot be instantiated or created within an executable graph-based model (e.g., the executable graph-based model 100). Thus, in an instance when the node template 338 has the abstract flag 352 set to ‘true’, the node template 338 may only form the foundation of other node templates that inherit therefrom. By default, the abstract flag 352 of the node template 338 is set to ‘false’. The leaf flag 354 is used to indicate whether any other node template may inherit from the node template 338. If the leaf flag 354 is set to ‘true’, then no other node template may inherit from the node template 338 (but unlike an abstract node, a node with the leaf flag 354 set may be instantiated and created within the executable graph-based model 100). The root flag 356 is used to indicate whether the node template 338 inherits from any other node template. If the root flag 356 is set to ‘true’, the node template 338 does not inherit from any other node. The node template 338 is flagged as leaf (e.g., the leaf flag 354 is set to ‘true’) and/or root (e.g., the root flag 356 is set to ‘true’), or neither (e.g., both the leaf flag 354 and the root flag 356 may be set to ‘false’). It will be apparent to a person skilled in the art that a node cannot be flagged as both abstract and leaf (e.g., the abstract flag 352 cannot be set to ‘true’ whilst the leaf flag 354 is set to ‘true’).

In instances when nodes of the executable graph-based model 100 may be run-time nodes, all elements within the executable graph-based model 100 may be defined as node templates or node instances. The functionality of the node template 338 and the node instance 340 may be realized due to the use of the node type template 343 and the node type instance 374. The node type template 343 of the node template 338 is used to extend the functionality of the node template 338 by defining the standard set of capabilities, including data and associated behavior. The vertex node type template 364 (also referred to as a data node type) may include a template of common data structures and functionality related to the ‘things’ modeled in the graph (e.g., the data). The vertex node type instance 382 may include the common data structures and functionality related to the ‘things’ modeled in the graph based on the vertex node type template 364. The edge node type template 366 may include a template of common data structures and functionality related to joining two or more nodes.

A node instance having the edge node type instance 384 may connect two or more nodes, and thus the edge node type instance 384 constructs associations and connections between nodes (for example, objects or ‘things’) within the executable graph-based model 100. The edge node type instance 384 is not restricted to the number of nodes that can be associated or connected by a node having the edge node type instance 384. The data structures and functionality of the edge node type instance 384 thus define a hyper-edge, which allows two or more nodes to be connected through a defined set of roles. A role defines a connective relationship between the two or more nodes and hence allows an edge node to connect two or more nodes such that the two or more nodes may have more than one relationship therebetween.

The plurality of predetermined node type templates 362 may further include the overlay node type template 368. The overlay node type template 368 is used to extend the functionality of a node template (e.g., the node template 338) to incorporate processing logic. Similarly, the overlay node type instance 386 is used to extend the functionality of a node instance (e.g., the node instance 340) to incorporate processing logic. The run-time node 336, having the node template 338 with the overlay node type template 368 and the overlay node type instance 386 may be a run-time overlay node (for example, a run-time standard operations overlay node and a run-time audio actions overlay node). In addition, the run-time standard operations overlay node may have a description that may be similar to the description of the generic standard operations overlay node, whereas the run-time audio action overlay node may have a description that may be similar to the description of the generic audio action overlay node.

The set of attribute templates 346 corresponds to the data defined by the node template 338. For example, the set of attribute templates 346 may define the names and value types (e.g., integer, string, float, etc.) of one or more attributes but not the values of these attributes. The values of the set of attribute templates 346 may be defined by the set of attribute instances 376 of the node instance 340 through one or more values or instance values. For example, the node template 338 may define a string attribute ‘surname’, and the corresponding node instance 340 may assign the instance value ‘Bell-Richards’ to this string attribute. Each attribute instance of the set of attribute instances 376 may be associated with an attribute template of the set of attribute templates 346. The node template 338 may define one or more default values for the set of attribute templates 346. The default values correspond to the values that the attributes take if no value is assigned. The metadata 348 (e.g., data stored as a name, a value type, and a value triplet) may be associated with either the node template 338 or one or more of the set of attribute templates 346 of the node template 338. Similarly, the node instance 340 also optionally comprises the metadata 378 (e.g., data stored as a name, a value type, and a value triplet), which may be associated with either the node instance 340 or one or more of the set of attribute instances 376.

The node configuration 350 provides a high degree of configurability for the different elements of a node template and/or a node instance. An example of a concrete node configuration strategy is an ID strategy, associated with the configuration of the unique ID 342a of the node template 338. A further example of a concrete node configuration strategy is a versioning strategy, associated with the configuration of the version ID 342b of the node template 338, which supports major and minor versioning (depending on the type of transactional change incurred). The versioning strategy may be adapted to a native filing system of a user device hosting the overlay system 202 or a third-party data storage (for example, Snowflake^{®}, or the like) associated with the overlay system 202.

It will be apparent to a person skilled in the art that each run-time node of the executable graph-based model 100 has a standard structure that is similar to the run-time node 336 of FIG. 3B.

FIG. 4A is a block diagram 400A that illustrates a standard structure of a generic audio node 402 within the executable graph-based model 100, consistent with disclosed embodiments of the present disclosure. Referring to FIG. 4A, the generic audio node 402 corresponds to the core structure of the executable graph-based model 100 and forms the foundational building block for various data and processing logics within the executable graph-based model 100. The standard structure of the generic audio node 402 is derived from the standard structure of the generic node 302. The generic audio node 402 includes properties 404, inheritance IDs 406, attributes 408, metadata 410, and a node configuration 412.

The properties 404 include a unique ID 404a, a version ID 404b, a namespace 404c, a name 404d, one or more icons 404e, one or more labels 404f, and one or more alternative IDs 404g. The properties 404 of the generic audio node 402 may have a description similar to the description of the properties 304 of the generic node 302. In other words, the unique ID 404a, the version ID 404b, the namespace 404c, the name 404d, the one or more icons 404e, the one or more labels 404f, and the one or more alternative IDs 404g may have a description similar to the description of the unique ID 304a, the version ID 304b, the namespace 304c, the name 304d, the one or more icons 304e, the one or more labels 304f, and the one or more alternative IDs 304g, respectively, of the generic node 302.

The inheritance IDs 406 of the generic audio node 402 include an abstract flag 414, a leaf flag 416, and a root flag 418. The inheritance IDs 406 of the generic audio node 402 may have a description similar to the description of the inheritance IDs 306 of the generic node 302. In other words, the abstract flag 414, the leaf flag 416, and the root flag 418 may have a description similar to the description of the abstract flag 316, the leaf flag 318, and the root flag 320, respectively, of the generic node 302.

The node configuration 412 of the generic audio node 402 includes node configuration strategies 420 and node configuration extensions 422. The node configuration 412 is same as the node configuration 314 of the generic node 302. In other words, the node configuration strategies 420 and the node configuration extensions 422 of the generic audio node 402 may have a description similar to the description of the node configuration strategies 322 and the node configuration extensions 324, respectively, of the generic node 302.

The generic audio node 402 further has an edge node-type 423. The edge node-type 423 may have a description similar to the description of the edge node-type 330. The generic audio node 402 with the edge node-type 423 may further include features of a role node-type that may have a description similar to the description of the role node-type 334.

Further, the generic audio node 402 may include an audio configuration 424 indicative of various configurations, data, information, or the like associated with an audio file of the external system. The audio file may be represented in the overlay system 202 by way of the generic audio node 402. The audio configuration 424 may include (i) one or more audio parameters, (ii) an encoding format, (iii) one or more feature representations, (iv) one or more processing settings, (v) metadata, or (vi) one or more annotations, associated with the audio file being represented by the generic audio node 402.

The one or more audio parameters may correspond to numerical values or settings that define characteristics of an audio signal associated with the audio file, such as sampling rate, bit depth, loudness, frequency range, or the like. These parameters influence the quality, clarity, and representation of the audio file.

The encoding format corresponds to a method used to compress and store an audio signal, such as MPEG-1 Audio Layer 3, Advanced Audio Codec, Free Lossless Audio Codec, or the like. The encoding format determines the trade-off between file size, audio quality, and compatibility with playback devices.

The one or more feature representations correspond to data extracted from the audio file that captures its key characteristics, such as Mel-Frequency Cepstral Coefficients, spectral centroids, or pitch contours.

The one or more processing settings correspond to configurable parameters that affect how an audio file is processed, including equalization, noise reduction, compression, and reverb. These settings modify the sound output to enhance clarity, balance, or artistic effect.

The metadata corresponds to a descriptive information embedded within or associated with an audio file, such as title, artist, album, genre, and technical details like codec type and bitrate. Metadata helps in organizing, categorizing, and retrieving audio content efficiently.

The one or more annotations may correspond to labels or markers linked to specific segments or characteristics of the audio file, such as timestamps for speech segments, musical notes, or frequency-related descriptors. Annotations aid in analysis, transcription, and automated processing of audio content.

In addition, the generic audio node 402 may include an audio reference 425 that may be a storage location, a pointer, a uniform resource locator (URL), or the like associated with the audio file being represented by the generic audio node 402. The audio reference 425 may be used to access or refer to the audio file of the external system being represented by the generic audio node 402.

FIG. 4B is a block diagram 400B that illustrates a standard structure of a run-time audio node 426 within the executable graph-based model 100, consistent with disclosed embodiments of the present disclosure. Referring to FIG. 4B, the run-time audio node 426 corresponds to the core structure of the executable graph-based model 100 and forms the foundational building block for all data and processing logic within the executable graph-based model 100. The standard structure of the run-time audio node 426 may be derived from the standard structure of the run-time node 336. The run-time audio node 426 is shown to include a node template 428 and a node instance 430. The node template 428 of the run-time audio node 426 may correspond to an audio node template, whereas the node instance 430 of the run-time audio node 426 may correspond to an audio node instance. The node instance 430 is generated according to the node template 428. The node template 428 forms a data structure for the node instance 430. Notably, the node template 428 corresponds to a predefined audio node structure. The node template 428 includes a reference (for example, a pointer, an identifier, or the like) to node template of each run-time node associated with the run-time audio node 426. Similarly, the node instance 430 may include a reference (for example, a pointer, an identifier, or the like) to node template of each run-time node associated with the run-time audio node 426. The run-time audio node 426 shown in FIG. 4B is a compositional structure that is generated and executed at run-time as part of the executable graph-based model 100. In other words, the node template 428 is defined as ‘offline’ and the node instance 430 and the run-time audio node 426 may be run-time structures that may be dynamically generated during execution of the executable graph-based model 100.

The node template 428 may have a description similar to the node template 338 described in conjunction with FIG. 3B. Similarly, the node instance 430 may have a description similar to the node instance 340 described in conjunction with FIG. 3B.

The node template 428 may include properties 432, inheritance IDs 434, and a set of attribute templates 436. The node template 428 may optionally include metadata 438 and node configuration 440. The properties 432 of the node template 428 include a unique identifier (ID) 432a, a version ID 432b, a namespace 432c, a name 432d, and optionally include one or more icons 432e and a set of labels 432f. The inheritance IDs 434 comprise an abstract flag 442, a leaf flag 444, and a root flag 446. The node configuration 440 optionally comprises one or more node configuration strategies 448 and/or one or more node configuration extensions 450. Further, the node instance 430 may include a unique ID 452, a version ID 454, and a set of attribute instances 456. The node instance 430 may optionally include metadata 458.

The properties 432 of the node template 428 have a description that is similar to the description of the properties 342 described in conjunction with FIG. 3B. In other words, the unique identifier (ID) 432a, the version ID 432b, the namespace 432c, the name 432d, the icons 432e, and the set of labels 432f have descriptions that may be similar to descriptions of the unique identifier (ID) 342a, the version ID 342b, the namespace 342c, the name 342d, the icons 342e, and the set of labels 342f, respectively, shown in FIG. 3B.

The inheritance IDs 434 of the node template 428 may have a description that is similar to the inheritance IDs 344 of the node template 338. In other words, the abstract flag 442, the leaf flag 444, and the root flag 446 may have descriptions that may be similar to the abstract flag 352, the leaf flag 354, and the root flag 356, respectively, shown in FIG. 3B.

The set of attribute templates 436 has a description that is similar to the description of the set of attribute templates 346 described in conjunction with FIG. 3B. The metadata 438 has a description that is similar to the metadata 348 depicted in FIG. 3B. Similarly, the set of attribute instances 456 has a description that is similar to the set of attribute instances 376 of FIG. 3B and the metadata 458 have a description that is similar to the metadata 378 of FIG. 3B.

The node configuration 440 has a description that may be similar to the node configuration 350 of FIG. 3B. In other words, descriptions of the node configuration strategies 448 and the node configuration extensions 450 may be similar to the descriptions of the node configuration strategies 358 and the node configuration extensions 360, respectively, of FIG. 3B.

The node template 428 and the node instance 430 may have an edge node type template 460 and an edge node type instance 462, respectively. The edge node type template 460 may have a description similar to the edge node type template 366 and the edge node type instance 462 may have a description similar to the edge node type instance 384. Therefore, the run-time audio node 426 may have an edge node-type.

Moreover, the run-time audio node 426 may further include an audio configuration of an audio file being represented thereby in the executable graph-based model 100. To enable such a representation, as shown, the node template 428 may further include an audio configuration template 464 that may define a template for storing the audio configuration of the audio file. The node instance 430 may further include an audio configuration instance 466 that may include values of the audio configuration of the audio file to be stored based on the audio configuration template 464. The audio configuration template 464 and the audio configuration instance 466 may, collectively, form the audio configuration. That audio configuration being represented by the run-time audio node 426 may have a description that may be similar to the audio configuration 424.

The run-time audio node 426 may further include an audio reference of an audio file being represented thereby in the executable graph-based model 100. To enable such a representation, as shown, the node template 428 may further include an audio reference template 468 that may define a template for storing the audio reference of the audio file. The node instance 430 may further include an audio reference instance 470 that may include a reference value of the audio reference of the audio file to be stored based on the audio reference template 468. The audio reference template 468 and the audio reference instance 470 may, collectively, form the audio reference. That audio reference included in the run-time audio node 426 may have a description that may be similar to the audio reference 425.

To summarize, an audio node (for example, a generic audio node and a run-time audio node) may have a standard structure that may be derived from a generic node or a run-time node. The audio node may present an audio file in the overlay system 202 by representing an audio configuration of the audio file in the overlay system 202. In addition, the audio node also includes an audio reference (for example, a pointer, a storage location, or the like) associated with the audio file. The audio reference may be used to directly or indirectly access the audio file in the external system.

As mentioned previously, an audio node (for example, a generic audio node and a run-time audio node) may represent an audio file of the external system. The audio file may correspond to (i) an encoded audio signal, (ii) metadata describing an audio signal, (iii) one or more feature representations of an audio content, (iv) one or more annotations indicative of temporal characteristics of the audio signal, or (v) one or more annotations indicative of spectral characteristics of the audio signal, or the like associated with the audio file being represented by the generic audio node 402.

The encoded audio signal may correspond to a digital representation of an audio file that may have been compressed or transformed using an encoding format (e.g., MPEG-1 audio layer 3, Advanced audio codec, Free lossless audio codec, or the like) to facilitate storage or transmission. Such encoding of the audio file may involve lossy or lossless compression to balance quality and file size.

The metadata describing an audio signal may correspond to a descriptive information about an audio file, including attributes such as title, artist, genre, duration, sampling rate, and encoding format. The metadata may also include technical details like bit depth, codec type, and copyright information.

One or more feature representations of an audio content may correspond to numerical or structured data extracted from an audio signal that characterizes its properties, such as Mel-frequency cepstral coefficients, spectrograms, or pitch contours. These features are used for tasks like speech recognition, classification, and synthesis.

One or more annotations indicative of temporal characteristics of the audio signal may correspond to markers or labels associated with specific time segments of the audio signal, associated with the audio file, that describe events, beats, phonemes, or other time-dependent properties. These annotations facilitate segmentation, alignment, and analysis of audio over time.

One or more annotations indicative of spectral characteristics of the audio signal may correspond to labels or indicators that describe frequency-related attributes of the audio signal, such as formants, harmonics, or noise levels. These annotations aid in tasks like speech analysis, music transcription, and sound classification.

An audio file may correspond to various forms, including time-domain waveforms, frequency-based spectrograms, feature-based representations like Mel-Frequency Cepstral Coefficients and chromagrams, structured graph models, parametric models, symbolic text formats such as Musical Instrument Digital Interface and phonetic scripts, and compressed encodings such as Moving Picture Experts Group Audio Layer 3, Advanced Audio Codec, and Free Lossless Audio Codec.

Notably, a generic node (for example, the generic node 302), a run-time node (for example, the run-time node 336), a generic audio node (for example, the generic audio node 402), and a run-time audio node (for example, the run-time audio node 426) when associated with an overlay node may be referred to as an executable generic node, an executable run-time node, an executable generic audio node, and an executable run-time audio node, respectively. An overlay associated with a node (for example, a generic node, a run-time node, a generic audio node, and a run-time audio node) may extend a functionality thereof. An overlay node (for example, a standard operations overlay node and an audio action overlay node) that has a node structure as described in conjunction with FIG. 3B may be a run-time overlay node (for example, a run-time standard operations overlay node and a run-time audio action overlay node). In other words, a standard operations overlay node having a node structure similar to the run-time node 336 may correspond to a run-time standard operations overlay node whereas, an audio action overlay node having a node structure similar to the run-time node 336 may correspond to a run-time audio action overlay node.

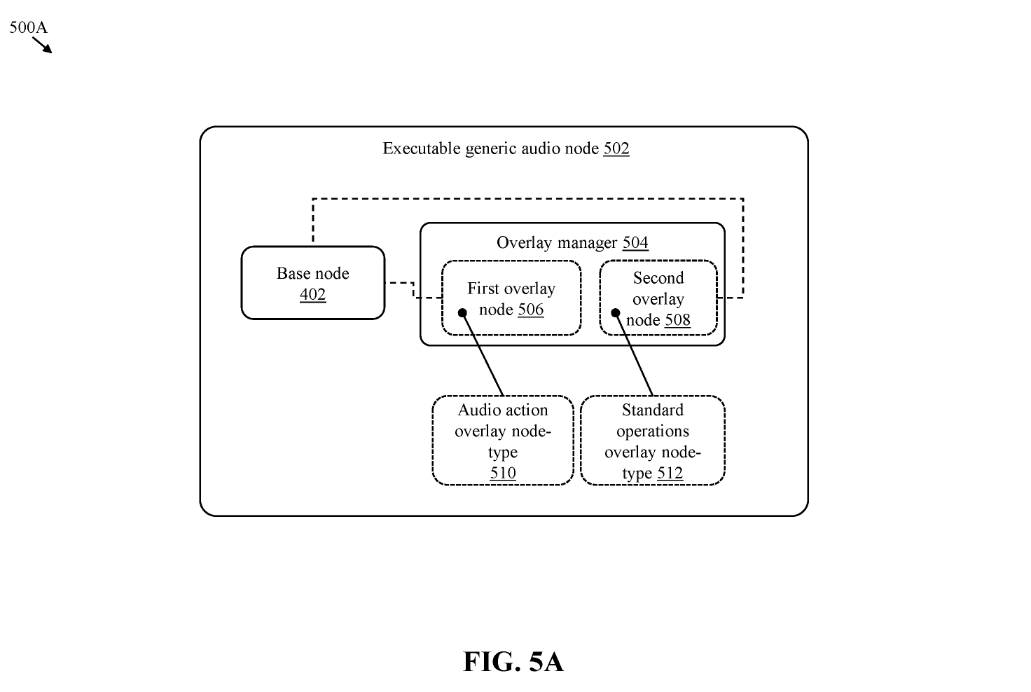

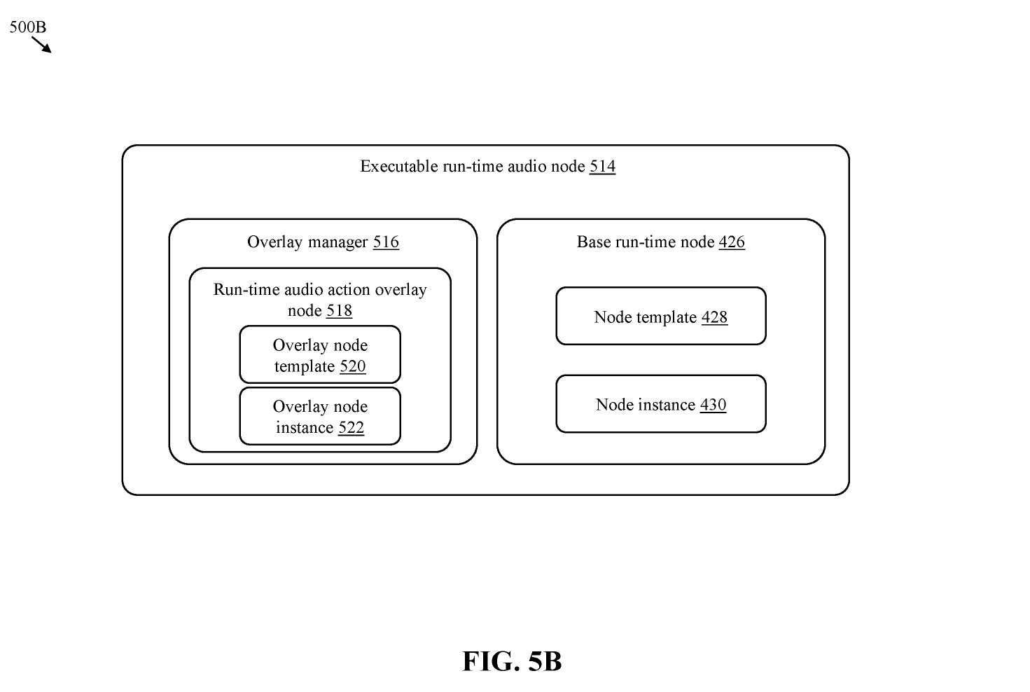

FIG. 5A is a block diagram 500A that illustrates an executable generic audio node 502 within the executable graph-based model 100, consistent with disclosed embodiments of the present disclosure. Referring to FIG. 5A, the executable generic audio node 502 is shown to include a base node (e.g., the generic audio node 402) and an overlay manager 504. For the sake of ongoing discussion, the base node corresponds to the generic audio node 402, and is hereinafter referred to as the “base node 402”. The base node 402, when extended by way of one or more overlay nodes, becomes the executable generic audio node 502.

The executable generic audio node 502 provides processing functionality (e.g., processing logic) to the base node 402 via one or more associated overlay nodes (for example, first and second overlay nodes 506 and 508, respectively). Beneficially, the data and processing capability of the base node 402 may be dynamically and significantly extended using the concept of an executable node (for example, the executable generic audio node 502). As shown, the first overlay node 506 has an audio action overlay node-type 510, and the second overlay node 508 has a standard operations overlay node-type 512.

The audio action overlay node-type 510 may be an audio generation overlay node-type, an audio modification overlay node-type, an audio analyzer overlay node-type, an audio deletion overlay node-type, or a rollback overlay node-type. Based on the audio action overlay node-type 510 being the audio generation overlay node-type, the first overlay node 506 may be an audio generation overlay node. Based on the audio action overlay node-type 510 being the audio modification overlay node-type, the first overlay node 506 may be an audio modification overlay node. Based on the audio action overlay node-type 510 being the audio analyzer overlay node-type, the first overlay node 506 may be an audio analyzer overlay node. Based on the audio action overlay node-type 510 being the audio deletion overlay node-type, the first overlay node 506 may be an audio deletion overlay node. Based on the audio action overlay node-type 510 being the rollback overlay node-type, the first overlay node 506 may be a rollback overlay node.

Based on the audio action overlay node-type 510 being the audio generation overlay node-type, the first overlay node 506 may include processing logic that when executed may cause creation of an audio file in the external system and/or an associated audio node representing an audio file of the external system.

Based on the audio action overlay node-type 510 being the audio modification overlay node-type, the first overlay node 506 may include processing logic that, when executed, may cause modification of an audio file being represented by an audio node associated therewith. In addition, the processing logic, when executed, may also cause modification of the associated audio node.

Based on the audio action overlay node-type 510 being the audio analyzer overlay node-type, the first overlay node 506 may include processing logic, that when executed, may cause analysis of different parameters, an audio configuration of an audio file being represented by the audio node associated therewith.

Based on the audio action overlay node-type 510 being the audio deletion overlay node-type, the first overlay node 506 may include processing logic, that when executed, may cause deletion of an audio file of the external system represented by the audio node associated therewith. In addition, the processing logic, when executed, may also cause deletion of the associated audio node.

Based on the audio action overlay node-type 510 being the rollback overlay node-type, the first overlay node 506 may include processing logic, that when executed, may cause a desired set of audio operations executed on the audio file represented by the associated audio node to be ineffective and consequently may cause the audio file of the external system to roll back to a previous state. In addition, the processing logic, when executed, may also cause the associated audio node to roll back to a previous node state.

Examples of an audio action overlay node (for example, the first overlay node 506) may include, but are not limited to, an audio recording overlay node, an audio playback overlay node, an audio editing overlay node, an audio compression overlay node, an audio decompression overlay node, an equalization overlay node, an audio mixing overlay node, a pitch shifting overlay node, a time stretching overlay node, an audio effects overlay node, a noise reduction overlay node, an audio synthesis overlay node, an audio analysis overlay node, an automatic transcription overlay node, a beat detection overlay node, an audio recognition overlay node, an audio classification overlay node, a music recommender overlay node, an audio conversion overlay node, a dynamic range compression overlay node, and a sound recognition node.

The audio recording overlay node may include processing logic, that when executed, may cause capturing or recording of audio using microphones or other recording devices associated with the external system. The audio recording overlay node is associated with an uninitialized audio node (or audio node template), and a process of retrieval of audio configuration of an audio corresponds to audio captured. The audio is typically stored in an audio file that is then connected to the audio node by way of corresponding audio configuration and audio reference. In addition, other aspects of the audio file, like namespace, name, audio, etc. can be configured analogous to the naming of a file when an audio is recorded. Further, the audio configuration may also be set as default and/or updated on-demand at a later time.

The audio playback overlay node may include processing logic, that when executed, may cause playing of a recorded or pre-existing audio content of an audio file being represented by an associated audio node. The audio content may be played using an audio playback device associated with the external system.

The audio editing overlay node may include processing logic, that when executed, may cause modification of the audio file being represented by the associated audio node. The audio file may be modified through audio operations like cutting, splicing, or rearranging segments to create an edited version.

The audio compression overlay node may include processing logic, that when executed, may cause a reduction in a file size of an audio file being represented by an associated audio node. The file size may be reduced to optimize the use of storage space or facilitate faster transmission of audio files over networks.

The audio decompression overlay node may include processing logic, that when executed, may cause expansion of a compressed audio file being represented by an associated audio node to its original size. In an example, such expansion of the compressed audio file may be performed for playback or further processing.

The equalization overlay node may include processing logic, that when executed, may cause one or more adjustments in balance of frequencies (e.g., bass, midrange, treble, or the like) in an audio file being represented by an associated audio file to achieve a desired tonal quality.

The audio mixing overlay node may include processing logic, that when executed, may combine multiple audio tracks or elements into a single, composite audio mix. Such a combination may be performed based on audio files being represented by two or more audio nodes associated with the audio mixing overlay node.

The pitch shifting overlay node may include processing logic, that when executed, may cause an alteration in pitch of an audio file being represented by an associated audio node. The alteration may be performed by raising or lowering the frequency of the audio file.

The time stretching overlay node may include processing logic, that when executed, may cause adjustment of a duration of an audio file being represented by an associated audio node without affecting its pitch.

The audio effects overlay node may include processing logic, that when executed, may cause application of various audio effects such as reverb, delay, chorus, distortion, or the like to modify an audio file being represented by an associated audio node.

The noise reduction overlay node may include processing logic, that when executed, may cause removal of unwanted background noise or artifacts from an audio file being represented by an associated audio node.

The audio synthesis overlay node may include processing logic, that when executed, may cause creation of artificial sounds or music, using synthesizers or electronic instruments, for an audio file being represented by an associated audio node.

The audio analysis overlay node may include processing logic, that when executed, may cause analysis of an audio file being represented by an associated audio node to extract features such as amplitude, frequency, or spectral content.

The automatic transcription overlay node may include processing logic, that when executed, may cause conversion of audio content of an audio file being represented by an associated audio node into written text. Such conversion may be useful for tasks like transcribing lyrics.

The beat detection overlay node may include processing logic, that when executed, may cause identification of beats or rhythmic patterns in an audio file being represented by an associated audio node.

The audio recognition overlay node may include processing logic, that when executed, may cause recognition of audio patterns, such as musical genres, instruments, or vocal elements in an audio file represented by an associated audio node.

The audio classification overlay node may include processing logic, that when executed, may cause categorization of an audio file, being represented by an associated audio node, into predefined classes or genres.

The music recommender overlay node may include processing logic, that when executed, may cause recommendation of audio files (for example, music, podcast, or the like) to users based on their preferences, listening history, or similar users.

The audio conversion overlay node may include processing logic, that when executed, may cause conversion of an audio file, being represented by an associated audio node, from one format to another.

The dynamic range compression overlay node may include processing logic, that when executed, may cause adjustment in a dynamic range of an audio file, being represented by an associated audio node, to balance loud and soft portions of the audio file.

The sound recognition overlay node may include processing logic, that when executed, may cause identification and classification of audio patterns within an audio file, being represented by an associated audio node. Such classification may be performed based on one or more machine learning algorithms or computer vision algorithms. The audio file, while persisted in from of a file, may be loaded into a form of artificial neural-network (ANN) that may be defined within the overlay system 202, or external to the overlay system 202. The audio file may first undergo a chain of audio operations, as stated above, before being converted to a set of appropriate vectors defined in the ANN. An output of the ANN may be returned back to the audio node for further processing and/or storage.

An audio action overlay node may include a module reference of a corresponding audio action module of the external system. Based on the module reference the audio action module may communicate with the corresponding audio action module and cause a corresponding operation to be performed on an audio file of the external system being represented by an associated audio node. The audio action overlay node may realize/execute the corresponding operation to be caused by way of the corresponding audio action module of the external system.

The second overlay node 508 with the standard operations overlay node-type 512 may perform various operations within the overlay system that may have to be performed within the overlay system 202 and without interacting with the external system or any component of the external system. Examples of the standard operations overlay node-type 512 may include, but are not limited to, a subscriber overlay node-type, a publisher overlay node-type, and an encryption overlay node-type.

A node with the subscriber overlay node-type is a subscriber overlay node that is indicative of an operation of receiving an input from an associated node (for example, the audio node). The subscriber overlay node also includes processing logic to receive the input. A node with the publisher overlay node-type is a publisher overlay node that is indicative of an operation of publishing an output of an associated node. The publisher overlay node also includes processing logic to publish the output. A node with the encryption overlay node-type is an encryption overlay node that is indicative of an encryption technique using which an associated node (for example, an audio node) is to be secured. The encryption overlay node also includes processing logic to secure a corresponding node. Examples of the encryption technique include a symmetric encryption algorithm, an asymmetric encryption algorithm, a combination of these, or any other encryption technique.

Although, the executable generic audio node 502 is assumed to include the first and second overlay nodes 506 and 508 and, in other embodiments, the executable generic audio node 502 may include any number of overlay nodes, without deviating from the scope of the present disclosure.

The executable generic audio node 502 extends the base node 402 (or is a subtype of the base node 402) such that all the functionality and properties of the base node 402 are accessible to the executable generic audio node 502. The executable generic audio node 502 also dynamically extends the functionality of the base node 402 by associating the first and second overlay nodes 506 and 508 maintained by the overlay manager 504 with the base node 402. The executable generic audio node 502 may thus be considered a combination of the base node 402 and the first and second overlay nodes 506 and 508. The executable generic audio node 502 may be alternatively referred to as a node with overlay(s). Therefore, the executable generic audio node 502 acts as a decorator of the base node 402 adding the functionality of the overlay manager 504 to the base node 402.

It will be apparent to a person skilled in the art that the base node 402 may correspond to any suitable generic audio node within the executable graph-based model 100. Alternatively, the base node 402 may be an executable generic audio node such that the functionality of the (executable) base node 402 is dynamically extended. In this way, complex and powerful processing functionality can be dynamically generated by associating and extending overlay nodes.

Extending the functionality of a base node through one or more overlay nodes is at the heart of the overlay system 202. As illustrated in FIG. 2, the data (e.g., a vertex node as represented by the base node 402 in FIG. 5A) and the functionality that acts upon that data (e.g., an overlay node) can be separated and independently maintained offline, but at run-time, an association between the data node and the overlay node is determined and an executable audio node is generated (e.g., the executable generic audio node 502 shown in FIG. 5A).

It will be apparent to a person skilled in the art that functionalities of the first and second overlay nodes 506 and 508 may be performed by a single overlay node that includes processing logic associated with both the first and second overlay nodes.

It will be apparent to a person skilled in the art that the list of overlay types (for example, the audio action overlay node-type 510 and the standard operations overlay node-type 512) is not exhaustive, and the number of different overlay types that can be realized is not limited. Because an overlay node is itself a node, all functionality of a node described in relation to the base node 402 is thus applicable to an overlay node. For example, an overlay node (for example, the first and second overlay nodes 506 and 508) includes a unique ID, a name, etc., can have attributes (e.g., an overlay node can have its data defined), supports multiple inheritance, and can be configured via node configurations. Furthermore, because an overlay node (for example, the first and second overlay nodes 506 and 508) is a node, the overlay node can have one or more overlay nodes associated therewith (e.g., the overlay node may be an overlay node with an overlay). Moreover, the processing functionality of an overlay node (for example, the first and second overlay nodes 506 and 508) extends to the node-type of the node to which the overlay node is applied.

An overlay node, such as the first overlay node 506 or the second overlay node 508, is not bound to a single executable audio node or a single executable graph-based model (unlike nodes that have non-overlay node-types). This allows overlay nodes (for example, the first and second overlay nodes 506 and 508) to be centrally managed and reused across multiple instances of executable graph-based models. Notably, a node (for example, a base node, an executable node, and an overlay node) may be extended by way of overlays. Further, each overlay node may be extended to have one or more overlays. Such overlays may be termed chaining overlays. Also, a single overlay node may be associated with multiple executable nodes. Thus, the overlay node and functionality thereof may be shared among the multiple executable nodes.

The overlay manager 504 of the executable generic audio node 502 is responsible for executing all overlays registered therewith. The overlay manager 504 also coordinates the execution of all associated overlay nodes. As shown in FIG. 5A, the executable generic audio node 502 associates the base node 402 with two overlay nodes, that is, the first overlay node 506 and the second overlay node 508. Thus, the overlay manager 504 employs a strategy to manage the potentially cascading execution flow. Example strategies to manage the cascading execution of overlays include the visitor pattern and the pipe and filter pattern. Further examples include strategies that apply either breadth-first or depth-first processing patterns, a prioritization strategy, or a combination thereof. All execution strategies are defined and registered with the overlay manager 504 and are associated with an overlay via a node configuration extension for the overlay. Additionally, the overlay manager 504 may be configured to provide a set of attributes associated with the executable generic audio node 502 to the first overlay node 506 and/or the second overlay node 508. The first overlay node 506 and/or the second overlay node 508 may apply/execute corresponding processing logic based on the executable generic audio node 502.

It will be apparent to a person skilled in the art that a generic audio node may be associated with one or more overlay nodes as described in conjunction with FIG. 5A. Further, an overlay manager of the generic audio node may have a description similar to the description of the overlay manager 504.

Although FIG. 5A is described with respect to the generic audio node 402, the concepts and embodiments described herein may also be applicable to the generic node 302.

FIG. 5B is a block diagram 500B that illustrates an executable run-time audio node 514 within the executable graph-based model 100, consistent with disclosed embodiments of the present disclosure. Referring to FIG. 5B, the executable run-time audio node 514 is shown to include the run-time audio node 426 (hereinafter referred to as ‘the base run-time node 426’) and an overlay manager 516. The overlay manager 516 may include a run-time audio action overlay node 518. The executable run-time audio node 514 provides processing functionality (e.g., processing logic) to the base run-time node 426 via one or more associated overlay nodes (for example, the run-time audio action overlay node 518). Beneficially, the data and processing capability of the base run-time node 426 may be dynamically and significantly extended using the concept of an executable run-time node (for example, the executable run-time audio node 514).

Although, the executable run-time audio node 514 is shown to include a single run-time audio action overlay node 518, in other embodiments, the executable run-time audio node 514 may include any number of run-time overlay nodes (for example, run-time standard operations overlay node, run-time audio action overlay node). The run-time audio action overlay node 518 may include an overlay node template 520 and an overlay node instance 522. The overlay node template 520 and the overlay node instance 522 may, collectively, constitute the run-time audio action overlay node 518.

The executable run-time audio node 514 extends the base run-time node 426 (or is a subtype of the base run-time node 426) such that all the functionality and properties of the base run-time node 426 may be accessible to the executable run-time audio node 514. The executable run-time audio node 514 also dynamically extends the functionality of the base run-time node 426 by associating the run-time overlay nodes maintained by the overlay manager 516 with the base run-time node 426. The executable run-time audio node 514 may thus be considered a composition of the base run-time node 426 and the run-time audio action overlay node 518. The executable run-time audio node 514 may be alternatively referred to as a run-time audio node with overlay(s). Therefore, the executable run-time audio node 514 acts as a decorator of the base run-time node 426 adding the functionality of the overlay manager 516 to the base run-time node 426.

It will be apparent to a person skilled in the art that the base run-time node 426 refers to any suitable run-time audio node within the executable graph-based model 100. Alternatively, the base run-time node 426 may itself be an executable node such that the functionality of the (executable) base run-time node 426 is dynamically extended. In this way, complex and powerful processing functionality can be dynamically generated by associating and extending overlay nodes.

The overlay manager 516 registers and maintains one or more run-time overlay nodes (such as the run-time audio action overlay node 518) associated with the base run-time node 426. The overlay manager 516 may register and maintain the one or more run-time overlay nodes using one or more overlay node templates and one or more overlay node instances. For example, the overlay manager 516 may register the run-time audio action overlay node 518 using the overlay node template 520 and the overlay node instance. The assignment of the run-time audio action overlay node 518 to the base run-time node 426 (via the overlay manager 516) endows the base run-time node 426 with processing logic and executable functionality defined within the run-time audio action overlay node 518. In other words, the run-time audio action overlay node 518 may interact at run-time, with the node template 428 and/or the node instance 430 of the base run-time node 426. In an example, the node template 428 and the node instance 430 may be not executable nodes. That is, neither the node template 428 nor the node instance 430 comprises an overlay manager with one or more run-time overlay nodes. In another example, the node template 428 and/or the node instance 430 may be executable nodes, thereby extending the functionality, complexity, and configurability of executable run-time nodes.

Extending the functionality of a base run-time node through one or more run-time overlay nodes is at the heart of the overlay system 202. As illustrated in FIG. 2, the data (e.g., a vertex node as represented by the base run-time node 426 in FIG. 5B) and the functionality that acts upon that data (e.g., an overlay node) can be separated and independently maintained offline, but at run-time, an association between the data node and the run-time overlay node is determined and an executable run-time node is generated (e.g., the executable run-time audio node 514).

Each run-time overlay node comprises an overlay node template and an overlay node instance. The overlay node template is a node template with the overlay node type template. Similarly, the overlay node instance is a node instance with the overlay node type instance. The overlay node instance is an implementation of the overlay node template. The overlay node template comprises one or more generic rules that may be implemented by the processing logic of the overlay node instance. Examples of the run-time audio action overlay node 518 may be same as the first overlay node 506.

A run-time standard operations overlay node, is a node having a standard operations overlay node-type. Examples of run-time standard operations overlay node-type include an encryption overlay node type, an obfuscation overlay node type, an audit overlay node type, an analytics overlay node type, a handler overlay node type, a publisher overlay node type, or the like. It will be apparent to a person skilled in the art that the list of overlay types is not exhaustive, and the number of different overlay types that can be realized is not limited. Examples of node-type of a run-time standard operations overlay node may be same as examples of the standard operations overlay node-type 512. Examples of node-types of a run-time audio action overlay node (for example, the run-time audio action overlay node 518) may be same as the examples of the audio action overlay node-type 510.

Because an overlay node (for example, a run-time standard operations overlay node and a run-time audio action overlay node) is itself a node, all functionality of a node described in relation to the base run-time node 426 is thus applicable to an overlay node. For example, an overlay node may include a unique ID, a name, etc., can have attributes (e.g., an overlay node can have its data defined), supports multiple inheritance, and can be configured via node configurations. Furthermore, because an overlay node is a node, the overlay node can have one or more overlay nodes associated therewith (e.g., the overlay node may be an overlay node with an overlay).

A run-time overlay node, such as the run-time audio action overlay node 518, is not bound to a single executable node or a single executable graph-based model (unlike nodes that have non-overlay node types). This allows run-time overlay nodes to be centrally managed and reused across multiple instances of executable graph-based models. Notably, a node (for example, a base node, an audio node, an executable node, and an overlay node) may be extended by way of overlays. Further, each overlay node may be extended to have one or more overlays. Such overlays may be termed chaining overlays.

Unlike non-run-time overlay nodes, a run-time overlay node (for example, a run-time audio action overlay node and a run-time standard operations overlay node) may include processing logic (not shown in FIG. 5B), which determines the functionality of the run-time overlay node. The processing logic of a run-time overlay node may include a block of executable code, or instructions, which carries out one or more operations associated with the facilitation of indexing within the executable graph-based model 100. The block of executable code is pre-compiled code, code that requires interpretation at run-time, or a combination of both. Different run-time overlay nodes provide different processing logic to realize different functionality. The overlay manager 516 of the executable run-time audio node 514 is responsible for executing all overlays registered therewith. The overlay manager 516 also coordinates the execution of all associated overlay nodes. As shown in FIG. 5B, the executable run-time audio node 514 associates the base run-time node 426 with the run-time audio action overlay node 518.

In some embodiments, the overlay manager 516 employs a strategy to manage potentially cascading execution flow of overlays such that one overlay may be associated with one or more other overlays. Example strategies to manage the cascading execution of overlays include the visitor pattern and the pipe and filter pattern. Further examples include strategies that apply either breadth-first or depth-first processing patterns, a prioritization strategy, or a combination thereof. All execution strategies may be defined and registered with the overlay manager 516 and may be associated with an overlay via a node configuration extension for the overlay.

It will be apparent to a person skilled in the art that a run-time node may be associated with one or more run-time overlay nodes as described in conjunction with FIG. 5B. Further, an overlay manager of the run-time node may have a description similar to the description of the overlay manager 516.

Throughout the description, an executable node (for example, an executable generic node, an executable run-time node, the executable generic audio node 502, and the executable run-time audio node 514) is represented by way of two concentric circles. In other words, the executable node is represented by way of an inner circle encircled by an outer circle, where the incircle represents a base node and the outer circle represents an overlay node associated with the base node.

It will be apparent to a person skilled in the art that an operation being performed by a node corresponds to an operation being performed by the processing circuitry while using the node.

Notably, an audio node (for example, the generic audio node 402, the run-time audio node 426, the executable generic audio node 502, and the executable run-time audio node 514) may be a stateful node or a stateless node. The audio node, being the stateful node, may be referred to as a stateful audio node. Based on the audio node being stateful, a node state of the audio node persists in the storage element of the overlay system 202 upon unloading thereof. The node state of the audio node may be used to regenerate/load the audio node in the executable graph-based model 100 based on a requirement thereof. Loading of the audio node is described in detail later in the description. Further, based on the audio node being the stateless node, the audio node may cease to exist in the storage element upon unloading thereof from the executable graph-based model 100. That is to say that, the audio node may be discarded from the overlay system 202 based on the unloading thereof. The audio node, being the stateless node, may be referred to as a stateless audio node.

Similarly, an overlay node (for example, the first and second overlay nodes 506 and 508, and the run-time audio action overlay node 518) may also be the stateful node or the stateless node. Based on the overlay node being the stateful node, a node state of the overlay node persists in the storage element of the overlay system 202 upon unloading thereof. The node state of the overlay node may be used to regenerate/load the overlay node in the executable graph-based model 100 based on a requirement thereof. The overlay node, being the stateful node, may be referred to as a stateful overlay node. Loading of the overlay node is described in detail later in the description. Further, based on the overlay node being the stateless node, the overlay node may cease to exist in the storage element upon the unloading. That is to say that, the overlay node may be discarded from the overlay system 202 based on the unloading thereof. The overlay node, being the stateless node, may be referred to as a stateless overlay node.

FIG. 6 is a block diagram 600 that illustrates a composition of the executable generic audio node 502 that enables persistent storage of data and processing logic associated therewith, consistent with disclosed embodiments of the present disclosure.

As described in conjunction with FIG. 5A, the executable generic audio node 502 includes the base node 402 and one or more overlay nodes (e.g., the first and second overlay nodes 506 and 508, respectively). For brevity of the ongoing description, the persistent storage is explained for the executable generic audio node 502 including only the first overlay node 506. One or more operations performed for ensuring the persistence of the first overlay node 506 may be performed for the second overlay node 508 as well.

Referring to FIG. 6, the executable generic audio node 502 includes the base node 402 and the first overlay node 506. The executable generic audio node 502 has a corresponding first state 602 having a first ID 604. The base node 402 has a second state 606 having a second ID 608, and the first overlay node 506 has a third state 610 having a third ID 612. A manifest (for example, first through third manifests 614-818) is generated for each of the base node 402, the executable generic audio node 502, and the first overlay node 506. In an embodiment, the manifests may be generated by the storage management module 220. The first manifest 614 is associated with the executable generic audio node 502 and has a fourth ID 620 and an overlay ID 622. The second manifest 616 is associated with the base node 402 and has a fifth ID 624. The third manifest 618 is associated with the first overlay node 506 and has a sixth ID 626. Further, the manifests are stored at respective storage locations that may be centralized or distributed storage locations associated with the overlay system 202. The manifests may be stored by the storage management module 220.

The first state 602 of the executable generic audio node 502 includes data required to reconstruct the executable generic audio node 502 (e.g., attributes, properties, etc.). The first state 602 of the executable generic audio node 502 is persistently stored along with the first ID 604. The first manifest 614 is generated for the executable generic audio node 502 and has (i) the fourth ID 620 (which is the same as the first ID 604), (ii) the storage location of the first state 602 of the executable generic audio node 502, and (iii) the overlay ID 622 (which is the same as the sixth ID 626). Notably, the fourth ID 620 is the same as the first ID 604 and the fifth ID 624, hence, the first manifest 614 includes the ID of the state of the base node 402 and the executable generic audio node 502. Further, the overlay ID 622 is the same as the sixth ID 626 of the state of the first overlay node 506. Therefore, the first manifest 614 may be used to identify and retrieve the states of the base node 402, the executable generic audio node 502, and the first overlay node 506. Subsequently, the retrieved states may be used to reconstruct the executable generic audio node 502 and the first overlay node 506. In an instance, the executable generic audio node 502 may be further extended to include additional overlay nodes. In such an instance, the first manifest 614 may include state IDs of the additional overlay nodes as well. A first manifest state (not shown) is then generated for the first manifest 614 and persistently stored along with the fourth ID 620.

The second state 606 of the base node 402 includes data required to reconstruct the base node 402 (e.g., attributes, properties, etc.) and is persistently stored along with the second ID 608. The second manifest 616 is generated for the base node 402 and has the fifth ID 624 and the storage location of the second state 606 of the base node 402. The second ID 608 of the second state 606 and the fifth ID 624 of the second manifest 616 are the same as the first ID 604 of the first state 602 of the executable generic audio node 502 (which is also the same as the fourth ID 620 of the first manifest 614 of the executable generic audio node 502). As mentioned above, along with the first state 602, the first manifest 614 may also be used to identify and retrieve the second manifest 616 which in turn may be used to identify the second state 606 of the base node 402. A second manifest state (not shown) is then generated for the second manifest 616 and persistently stored along with the fifth ID 624. Thus, the states, manifests, and manifest states for the executable generic audio node 502 and the base node 402 include the same, shared, ID. A shared ID can be used in this instance because the states, manifests, and manifest states are stored separately. The separate storage of the states, manifests, and manifest states exhibit a distributed architecture of the overlay system 202.

The third state 610 of the first overlay node 506 includes data required to reconstruct the first overlay node 506 (e.g., attributes, properties, processing logic, etc.) and is persistently stored along with the third ID 612. The third manifest 618 is generated for the first overlay node 506 and includes the sixth ID 626, which is the same as the third ID 612. Therefore, the first manifest 614 may be further used to identify and retrieve the third manifest 618 which in turn may be used to identify and retrieve the third state 610 of the first overlay node 506. A third manifest state (not shown) is then generated for the third manifest 618 and is persistently stored along with the sixth ID 626.

In operation, when the executable generic audio node 502 is to be loaded, the transaction module 208, in conjunction with the storage management module 220, may execute one or more operations to retrieve the first manifest state stored at a known storage location. Based on the first manifest state, the storage management module 220 may re-construct the first manifest 614, which includes the fourth ID 620, which is the same as the fifth ID 624 of the second manifest 616. Based on the fifth ID 624, the storage management module 220 may identify the second manifest state and may generate the second manifest 616 based on which the second state 606 is identified. Subsequently, the base node 402 is loaded, and the storage management module 220 may determine that the base node is a node with an overlay. Based on the fourth ID 620 (that is the same as the first ID 604 of the first state 602 of the executable generic audio node 502) of the first manifest 614, the first state 602 is identified and retrieved. Subsequently, the executable generic audio node 502 is loaded. Moreover, based on the overlay ID 622 (that is the same as the sixth ID 626 of the third manifest 618) of the first manifest 614, the third manifest state is identified, and the third manifest 618 is generated. Subsequently, based on the sixth ID 626 (that is the same as the third ID of the third state) of the third manifest 618, the third state 610 is identified and retrieved. Based on the third state 610, the first overlay node 506 is reconstructed and loaded in the executable graph-based model 100.

Based on a context of a stimulus (for example, the stimulus 230) associated with the overlay system 202, the processing logic (such as the context module 210) may determine an ID that is the same as the fifth ID 624. Based on the determined ID, the processing logic (such as the memory management module 218 and the storage management module 220) may identify the second manifest 616. Subsequently, the processing logic (such as the memory management module 218 and the storage management module 220) may identify the second state 606 that has the second ID 608 that matches the fifth ID 624. Further, the processing logic (such as the memory management module 218 and the storage management module 220) may retrieve the second state 606 associated with the second manifest 616 from a corresponding storage element. Subsequently, the processing logic (such as the memory management module 218 and the storage management module 220) may determine, by checking the manifest storage(s) associated with the overlay system 202, whether there is another manifest (such as the first manifest of the executable generic audio node 502) with an ID that matches the second ID 608 and the fifth ID 624. Notably, the first manifest 614 includes storage locations of each overlay node (for example, the first overlay node 506) of the executable generic audio node 502. Based on the overlay ID 622 included in the first manifest 614 that matches the sixth ID 626 included in the third manifest 618, the processing logic (such as the memory management module 218 and the storage management module 220) may identify and retrieve the third manifest 618 from a manifest storage of a plurality of manifest storages of the overlay system 202.

Subsequently, the processing logic (such as the memory management module 218 and the storage management module 220) may identify the third state 610 which has the third ID 612 that matches the sixth ID 626. Further, the processing logic (such as the memory management module 218 and the storage management module 220) may retrieve the third state 610 associated with the third manifest 618 from a corresponding storage element. To determine whether the first overlay node 506 has an overlay node associated therewith, the processing logic (such as the memory management module 218 and the storage management module 220) may also perform a check to determine whether any of the plurality of manifest storages of the overlay system 202 includes any other manifest with an ID that matches the sixth ID 626. Since the first overlay node 506 does not have an overlay associated therewith, no other manifest has the ID that matches the sixth ID.

Notably, the manifest (the third manifest 618) of the first overlay node 506 includes a reference (such as an identifier that is common to the second manifest 616 and the third manifest 618, a link, a path, a storage location, or the like) to the second manifest 616 of the base node 402. Therefore, the re-formation of the executable generic audio node 502 includes a re-creation of the first overlay node 506 prior to a re-creation of the base node 402. Subsequently, the first overlay node 506 and the base node 402 are organized by associating the base node 402 with the first overlay node 506 to re-form the executable generic audio node 502.

In some embodiments, the first overlay node 506 may not be loaded in case it is not required for executing the operation associated with the stimulus 230. The loaded executable generic audio node 502 and the first overlay node 506 may be unloaded in case they remain unused for a predefined time period, whereas one or more executable nodes that are used at least once during the predefined time period may remain loaded in the executable graph-based model 100. In some embodiments, the data and processing logic associated with a loaded executable node and/or overlay node may be transferred to a local memory of the overlay system 202 if the data and the processing logic remain unused for a first predefined period of time. Further, the data and the processing logic associated with the executable node/overlay node are transferred to an external storage from the local memory in case the executable node/overlay node remains unused for a second predefined period of time. The second predefined period of time is greater than the first predefined period of time. The term unloading refers to storing a state of a node with a current version of data and processing logic associated therewith at a storage location in the secondary storage of the storage element that is pointed by the corresponding manifest.

An executable graph-based model (for example, the executable graph-based model 100) may be stored (and loaded) using the above-described composition. Beneficially, each component is stored separately, thereby allowing a user to maintain and store their data independently of the storage of the structure and functionality of the executable graph-based model 100.

Notably, the management and storage of manifests is managed by the controller module 206, the memory management module 218, the storage management module 220, a combination of these, or any other module of the overlay system 202. Also, all manifest states are stored together at a storage location (such as a manifest storage) that is known to the storage management module 220. Such centralized storage of the manifest states ensures that node states associated therewith are easily accessible.

It will be apparent to a person skilled in the art that although FIG. 6 illustrates only a single overlay node associated with a generic audio node, in other embodiments, the executable generic audio node 502 may include additional or different overlay nodes (for example, the second overlay node 508). It will also be apparent to a person skilled in the art that only those overlay nodes that are required for responding to the stimulus 230 may be loaded.

In some embodiments, the run-time audio node 426 may be loaded by loading the node template 428 and the node instance 430. Each of the node template 428 and the node instance 430 may be loaded in a manner similar to the loading of the base node 402 as described in conjunction with FIG. 6. Additionally, the node instance 430 may include a reference to the node template 428. Therefore, the node template 428 may be identified based on the node instance 430 and may be loaded prior to the node instance 430. In some embodiments, the node template 428 and the node instance 430 may be associated with node templates and node instances, respectively, of one or more overlay nodes associated with the executable run-time audio node 514. In such embodiments, each of the node template 428 and the node instance 430 may be loaded in a manner that is similar to the loading of the executable generic audio node 502.

It will be apparent to a person skilled in the art that the generic node 302 may be loaded in a manner that is similar to the loading of the base node 402. Additionally, the generic node 302, when extended by way of an overlay node, may be loaded in a manner similar to the loading of the executable generic audio node 502.

In some embodiments, the run-time node 336 may be loaded by loading the node template 338 and the node instance 340. Each of the node template 338 and the node instance 340 of the run-time node 336 may be loaded in a manner similar to the loading of the base node 402. Additionally, in an instance when the run-time node 336 may be extended by way of a run-time overlay node, the node template 338 and the node instance 340 may be associated with an overlay node template and an overlay node instance, respectively, of the run-time overlay node. In such a scenario, each of the node template 338 and the node instance 340 may be loaded in a manner similar to the loading of the executable generic audio node 502.

Having described various features associated with the audio nodes and overlay nodes (for example, the standard operations overlay nodes and audio action overlay nodes), the description now moves towards implementation of the audio nodes in the overlay system 202 by leveraging the above-discussed features.

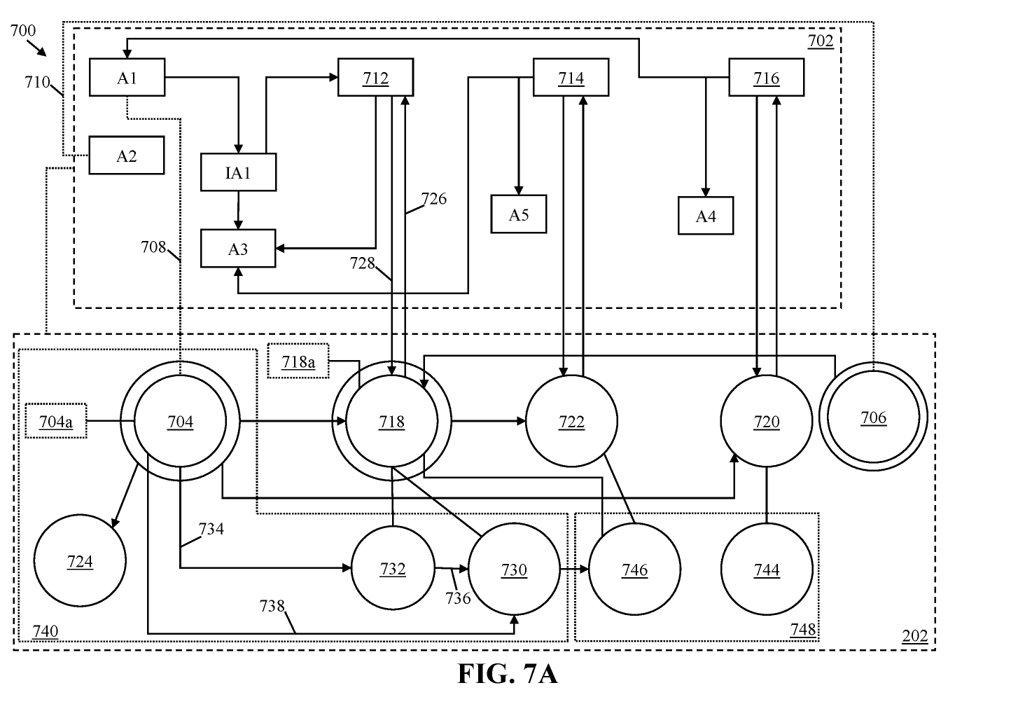

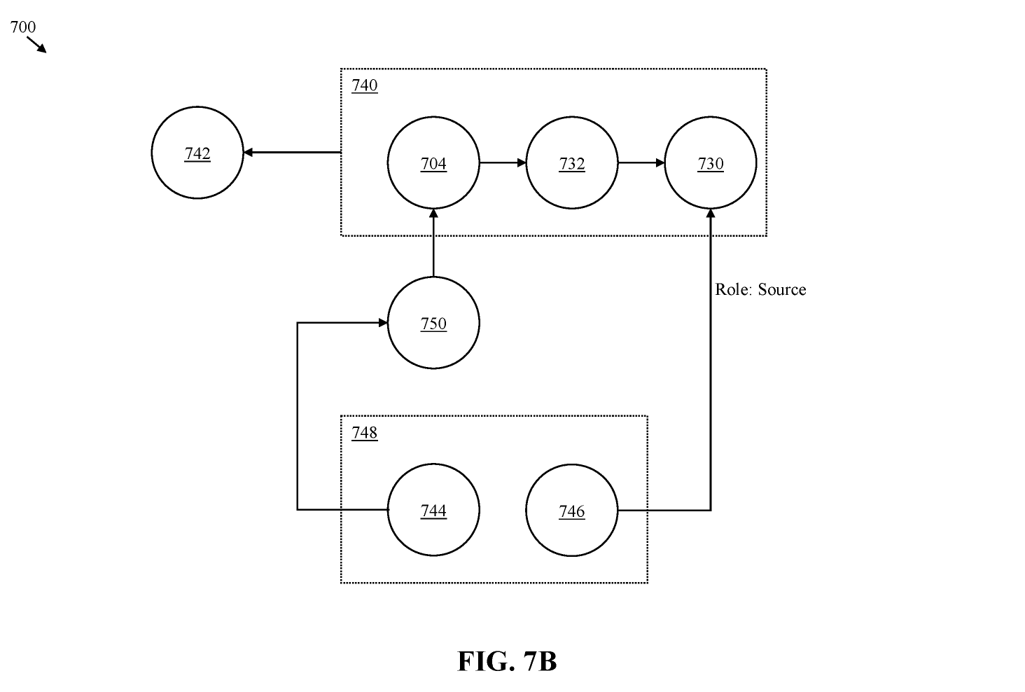

FIGS. 7A and 7B, collectively, illustrate a graph 700 that depicts an implementation of a plurality of audio nodes in the executable graph-based model 100, consistent with disclosed embodiments of the present disclosure. The audio nodes depicted in FIGS. 7A and 7B may be generic audio nodes or run-time audio nodes. Based on the audio nodes being the generic audio nodes, a plurality of audio action overlay nodes depicted in FIGS. 7A and 7B may be generic audio action overlay nodes. Based on the audio nodes being the run-time audio nodes, the plurality of audio action overlay nodes may be run-time audio action overlay nodes.

Referring to FIG. 7A, shown is the overlay system 202 and an external system 702 associated therewith. The external system 702 may include a plurality of audio files including audio files A1 and A2. The term “audio file” refers to any electronically stored or transmitted representation of sound data in a format suitable for processing, manipulation, or analysis by the overlay system 202. An audio file may include, but is not limited to, digital representations of speech, music, ambient noise, machine-generated sounds, or any other audible signals. The audio file may be encoded in any digital format, whether compressed (e.g., MPEG-1 Audio Layer 3, Advanced Audio Coding, Ogg Vorbis) or uncompressed (e.g., Waveform Audio File Format, Audio Interchange File Format), and may include additional data such as metadata, annotations, or markers to support playback, synchronization, or analysis.

The term ‘audio file’ encompasses audio data in single-channel (mono), dual-channel (stereo), or multi-channel configurations, and may represent continuous streams or discrete recordings. Audio files may further include container formats (e.g., MPEG-4 Part 14, Matroska Video) that encapsulate audio streams with other media or auxiliary information. The term ‘audio file’ also includes any in-memory data structure, stream buffer, or intermediate representation derived from or convertible to a standard audio format, that may be operable by the overlay system 202 for executing various audio operations.

The association between the overlay system 202 and the external system 702 may be such that the plurality of audio files associated with the external system 702 may be represented by the plurality of audio nodes of the executable graph-based model 100. The plurality of audio nodes may include audio nodes 704 and 706. Each audio node (for example, the audio nodes 704 and 706) of the plurality of audio nodes may have an edge node-type (for example, the edge node-type 423) and may be an edge node. Further, as shown by way of dotted lines 708 and 710, the audio nodes 704 and 706 may represent the audio files A1 and A2, respectively. The audio nodes 704 and 706 represent the audio files A1 and A2, respectively, based on audio configurations thereof. In other words, the audio configurations of the audio files A1 and A2 may be stored in the overlay system 202 in association with the audio nodes 704 and 706, respectively. Each audio node of the plurality of audio nodes (hereinafter, the plurality of audio nodes 704-706) may include an audio reference of an audio file of the external system 702 being represented thereby. For example, the audio node 704 may include a first audio reference of the audio file A1. The first audio reference may correspond to a pointer, a storage location, or a URL to the audio file A1. Similarly, the audio node 706 may include a second audio reference of the audio file A2.

An audio configuration of an audio file may include (i) one or more audio parameters, (ii) an encoding format, (iii) one or more feature representations, (iv) one or more processing settings, (v) metadata, or (vi) one or more annotations, associated with the audio file.

Each audio node of the plurality of audio nodes 704-706 may be a stateful node or a stateless node. The stateful node may be a node of the executable graph-based model 100 that may persist in the storage element upon unloading thereof. Hence, based on a requirement of an audio node that may be the stateful node, the audio node may be loaded/re-generated as described in conjunction with FIG. 6. The stateless node may be a node of the executable graph-based model 100 that may cease to exist in the storage element upon unloading thereof. Therefore, the stateless node may not exist in the overlay system 202 upon unloading thereof. In an instance, when the audio node 704 may be the stateful node, based on unloading of the audio node 704, the audio configuration of the audio file A1 may persist in the storage element in association with the audio node 704. In another instance, when the audio node 704 may be the stateless node, based on unloading of the audio node 704, the audio configuration of the audio file A1 may cease to exist in the overlay system 202.

The external system 702 may further include a plurality of audio action modules 712-716. Each audio action module of the plurality of audio action modules 712-716 may be associated with a processor (for example, CPU, GPU, or the like) and may have processing logic that, when implemented, may execute an audio operation on an audio file of the plurality of audio files. The audio operation may correspond to an audio generation operation, an audio modification operation, an audio analysis operation, an audio deletion operation, or a rollback operation. For the sake of brevity, the plurality of audio action modules 712-716 are shown to be a part of the external system 702. In some embodiments, the plurality of audio action modules 712-716 may be parts of same or distinct external systems that may be different from the external system 702.

In some embodiments, the external system 702 may have a centralized architecture. Hence, the plurality of audio files and the plurality of audio action modules may be organized and stored in a centralized manner. Alternatively, in some embodiments, the external system 702 may have a distributed architecture. Hence, the plurality of audio files and the plurality of audio action modules may be organized and stored in a distributed manner.

The overlay system 202 may further include a plurality of audio action overlay nodes 718-720. Each audio action overlay node of the plurality of audio action overlay nodes 718-720 may be an audio generation overlay node (alternatively, audio creation overlay node), an audio modification overlay node (alternatively, audio file manipulation overlay node), an audio analyzer overlay node, an audio deletion overlay node, a rollback overlay node, or any other overlay node with an audio action overlay node-type (for example, the audio action overlay node-type 510). Each audio action overlay node of the plurality of audio action overlay nodes 718-720 may include a module reference of a corresponding audio action module of the plurality of audio action modules 712-716. The module reference of each audio action overlay node may be a pointer, a storage location, a URL, or the like to the corresponding audio action module. Each audio action overlay node of the plurality of audio action overlay nodes 718-720 may include processing logic, that when executed, may use the corresponding module reference to communicate with the corresponding audio action module. Based on such communication, the corresponding audio action module of each audio action overlay node may execute an audio operation on an audio file of the plurality of audio files. The audio action overlay node 718 may include a first module reference of the audio action module 712. Similarly, the audio action overlay node 720 may include a second module reference of the audio action module 716. Therefore, the audio action overlay nodes 718 and 720 may be communicatively coupled to the audio action modules 712 and 716, respectively.

In some embodiments, an audio action overlay node may be shared among two or more audio nodes. In other words, the audio action overlay node may be associated with at least two audio nodes. For example, the audio action overlay node 718 may be associated with the audio node 704 as well as the audio node 706.

In some embodiments, the executable graph-based model 100 may include additional overlay nodes, including overlay nodes 722 and 724. The overlay nodes 722 and 724 may be standard operations overlay nodes or audio action overlay nodes. For the sake of brevity of description, the overlay node 722 is assumed to be an audio action overlay node and hereinafter is referred to as the audio action overlay node 722. As shown, the audio action overlay node 722 may include a third module reference of the audio action module 714 of the external system 702. The audio action overlay node 718 may include an overlay manager 718a configured to manage association of the audio action overlay node 718 with the audio action overlay node 722. The overlay manager 718a may have a description similar to the description of the overlay manager 504.

In some embodiments, the audio node 704 may be further associated with the overlay node 724. For the sake of brevity of the ongoing description, the overlay node 724 is assumed to be a standard operations overlay node. Hereinafter, the overlay node 724 is referred to as the standard operations overlay node 724. For example, the overlay node 724 may be an encryption overlay node or a contract overlay node. The standard operations overlay node 724 may execute an operation based on the audio node 704 such that the operation may be internal to the overlay system 202. That is to say that, the standard operations overlay node 724 may execute a corresponding processing logic on the audio configuration of the audio file A1 represented by the audio node 704 without interacting with any component of the external system 702. In an example, the overlay node 724 may be an encryption overlay node. In such an example, the standard operations overlay node 724 may execute the corresponding processing logic on the audio node 704 to encrypt/decrypt the audio configuration of the audio file A1 represented by the audio node 704.

Each audio node of the plurality of audio nodes 704-706 may also include a corresponding overlay manager. An overlay manager 704a of the audio node 704 may be configured to manage association of the audio node 704 with the audio action overlay node 718 and the standard operations overlay node 724. The overlay manager 704a may have a description similar to the description of the overlay manager 504.

The processing circuitry (for example, the controller module 206, the transaction module 208, the stimuli management module 212, or the like) may be configured to receive a first stimulus (for example, the stimulus 230) associated with a first audio action to be executed based on the audio file A1 of the plurality of audio files of the external system 702. The first audio action may include a set of audio operations (for example, audio creation operations, audio manipulation operations, audio analysis operations, audio deletion operations, rollback operations, or the like). Based on a context of the first stimulus, the processing circuitry (for example, the controller module 206, the transaction module 208, the stimuli management module 212, or the like) may be configured to identify the audio node 704 that represents the audio file A1 in the overlay system 202.

In some embodiments, the audio node 704 may be associated with multiple overlay nodes including audio action overlay nodes and standard operations overlay nodes. From the multiple overlay nodes associated with the audio node 704, the processing circuitry (for example, the controller module 206, the transaction module 208, the stimuli management module 212, the audio action overlay management sub-module 236b, or the like) may be configured to determine at least the audio action overlay node 718. In some embodiments, the audio node 704 may be associated with a single audio action overlay node e.g., the audio action overlay node 718. Therefore, based on the first stimulus, the processing circuitry (for example, the controller module 206, the transaction module 208, the stimuli management module 212, the audio action overlay management sub-module 236b, or the like) may be configured to determine the audio action overlay node 718.

Additionally, the audio action overlay node 718 may be determined based on a functionality or processing logic associated thereof being in conformity with the first audio action. In other words, the audio action overlay node 718 may be determined based on the processing logic thereof, when executed, being configured to execute one or more audio operations of the set of audio operations associated with the first audio action.

Based on the identification of the audio node 704 and the determination of the audio action overlay node 718, the processing circuitry (for example, the memory management module 218, the storage management module 220, or the like) may be configured to determine whether the audio node 704 and/or the audio action overlay node 718 may be unloaded from the executable graph-based model 100. Based on the audio node 704 and/or the audio action overlay node 718 being unloaded from the executable graph-based model 100, the processing circuitry (for example, the memory management module 218, the storage management module 220, or the like) may be configured to load the audio node 704 and/or the audio action overlay node 718 in the executable graph-based model 100 as described in conjunction with FIG. 6.

Subsequently, the processing circuitry (for example, the controller module 206, the transaction module 208, the audio node management module 216, or the like) may be configured to execute the first audio action in response to the first stimulus. The first audio action may be executed based on the audio node 704 and at least the audio action overlay node 718. The first audio action may be executed further based on the audio file A1 and the audio action module 712 of the external system 702.

For executing the first audio action, the processing circuitry (for example, the controller module 206, the transaction module 208, the audio node management module 216, or the like) may use the audio action overlay node 718 to retrieve the first audio reference of the audio file A1 from the audio node 704. The processing logic of the audio action overlay node 718 when executed by the processing circuitry (for example, the controller module 206, the transaction module 208, the audio node management module 216, or the like) may retrieve the first audio reference of the audio file A1 from the audio node 704. Subsequently, the processing circuitry (for example, the controller module 206, the transaction module 208, the audio node management module 216, or the like) may be configured to communicate (as shown by an arrow 726), using the first module reference of the audio action module 712, the first audio reference of the audio file A1 to the audio action module 712. In addition, the processing circuitry (for example, the controller module 206, the transaction module 208, the audio node management module 216, or the like) may be configured to communicate (as shown by an arrow 726), using the first module reference of the audio action module 712, one or more instructions to the audio action module 712. Based on the one or more instructions and the first audio reference, the audio action module 712 may execute the set of audio operations, associated with the first audio action, on the audio file A1. The audio operations may include audio generation (for example, re-generation) operations, audio modification operations, audio deletion operations, audio analysis operations, rollback operations, or a combination thereof. Based on the execution of the set of audio operations on the audio file A1, the audio action module 712 may generate an audio file A3. Upon generation of the audio file A3, the audio action module 712 may communicate (as shown by an arrow 728) an audio configuration of the audio file A3 to the audio action overlay node 718. In addition, the audio action module 712 may also communicate (as shown by the arrow 728) a third audio reference to the audio file A3 to the audio action overlay node 718.

The processing circuitry (for example, the controller module 206, the transaction module 208, the audio node management module 216, or the like) may be configured to receive the audio configuration of the audio file A3 from the audio action module 712. The processing circuitry (for example, the controller module 206, the transaction module 208, the audio node management module 216, or the like) may use the audio action overlay node 718 to receive the audio configuration of the audio file A3 from the audio action module 712.

Subsequently, the processing circuitry (for example, the controller module 206, the transaction module 208, the audio node management module 216, or the like) may be configured to generate (namely, instantiate or create) an audio node 730 that represents the audio file A3. The audio node 730 may be generated based on the audio configuration of the audio file A3 received from the audio action module 712. The audio node 730 may also include the third audio reference of the audio file A3. The processing circuitry (for example, the controller module 206, the transaction module 208, the audio node management module 216, or the like) may use the audio action overlay node 718 to generate the audio node 730. In some embodiments, based on the generation of the audio node 730, the audio nodes 704 and 730, and the audio action overlay node 718 may be unloaded from the executable graph-based model 100. In some embodiments, the audio nodes 704 and 730 and the audio action overlay node 718 may not be unloaded or may be loaded again based on a requirement thereof for execution of one or more operations associated with the overlay system 202 or the external system 702.

In some embodiments, the audio node 704 may be encrypted using an encryption logic of the standard operations overlay node 724. Therefore, the audio configuration of the audio file A1 and the first audio reference of the audio file A1 may also be encrypted. In such embodiments, the first audio action may be performed further based on the standard operations overlay node 724. For execution of the first audio action, a decryption logic of the standard operations overlay node 724 may be used to decrypt the audio node 704. Based on the decryption of the audio node 704, the audio configuration of the audio file A1 and the first audio reference of the audio file A1 may also be decrypted. Subsequently, the first audio action may be executed as described above.

In some embodiments, the set of audio operations associated with the first audio action is assumed to be a set of audio mutation operations. An audio mutation operation may refer to a process of modifying one or more parameters of an audio file. Examples of parameters of an audio file may include, but are not limited to, sampling rate, bit depth, amplitude, frequency, pitch, tempo, loudness, dynamic range, phase, spectral centroid, formants, harmonics, noise level, reverberation, echo, compression, equalization, filtering, stereo width, and time-stretching.

In some embodiments, when the set of audio operations is assumed to be the set of audio mutation operations, based on the execution of the first audio action, the processing circuitry (for example, the controller module 206, the transaction module 208, the audio node management module 216, or the like) may be configured to associate the audio configuration of the audio file A1 with the audio action overlay node 718. In such embodiments, the processing circuitry (for example, the controller module 206, the transaction module 208, the audio node management module 216, the memory management module 218, the storage management module 220, or the like) may be configured to discard the audio node 704. Such discarding of the audio node 704 may cause deletion of the audio node 704 from the executable graph-based model 100. The audio configuration of the audio file A1 may be stored in association with the audio action overlay node 718. In an instance, the audio action overlay node 718 may be the stateless node. In such an instance, the audio configuration of the audio file A1 may cease to exist in the overlay system 202 based on unloading of the audio action overlay node 718. In another instance, the audio action overlay node 718 may be the stateful node. In such an instance, the audio configuration of the audio file A1 may persist in the storage element based on unloading of the audio action overlay node 718. Such persistence of the audio configuration of the audio file A1 may be in association with the audio action overlay node 718.

In some embodiments, when an audio trail of (i) a lifecycle of the audio file A1 or (ii) various operations performed on the audio file A1 may have to be maintained within the overlay system 202, the audio node 704 may not be discarded. For the sake of ongoing description, it is assumed that the audio node 704 may not be discarded. The audio trail of the audio file A1 may refer to a temporal record of various audio nodes that may be generated directly or indirectly based on the audio file A1 or any other audio file (for example, the audio file A3) associated with the audio file A1. Such an audio trail may be stored in form a snapshot that may be an unmodifiable state of the audio nodes associated with the audio trail. Beneficially, this ensures that an initial state and various modifications made to the audio file A1 are available within the overlay system 202 at all times.

In some embodiments, when the set of audio operations is assumed to be the set of audio mutation operations, the audio file A3 may be a final output of the set of audio mutation operations. Prior to the generation of the audio file A3, the audio action module 712 may generate at least an intermediate audio file IA1 based on the execution of one or more audio mutation operations of the set of audio mutation operations. The intermediate audio file IA1 may be generated based on the execution of the one or more mutation operations of the set of audio mutation operations on the audio file A1. The intermediate audio file IA1 may be generated prior to the generation of the audio file A3. In such embodiments, the audio file A3 may be generated based on remaining mutation operations of the set of mutation operations executed on the intermediate audio file IA1. In addition, prior to communication of the audio configuration of the audio file A3, the audio action module 712 may communicate an audio configuration of the intermediate audio file IA1 to the audio action overlay node 718. Therefore, the processing circuitry (for example, the controller module 206, the transaction module 208, the audio node management module 216, or the like) may be configured to receive, using the audio action overlay node 718, the audio configuration of the intermediate audio file IA1. In addition, the audio action module 712 may also communicate a fourth audio reference to the intermediate audio file IA1. Therefore, the processing circuitry (for example, the controller module 206, the transaction module 208, the audio node management module 216, or the like) may be configured to receive, using the audio action overlay node 718, the fourth audio reference of the intermediate audio file IA1.

In some embodiments, the audio configuration of the intermediate audio file IA1 may be represented by the audio action overlay node 718. In an instance, the audio action overlay node 718 may be the stateless node. In such an instance, the audio configuration of the intermediate audio file IA1 may cease to exist in the overlay system 202 based on unloading of the audio action overlay node 718. In another instance, the audio action overlay node 718 may be the stateful node. In such an instance, the audio configuration of the intermediate audio file IA1 may persist in the storage element based on unloading of the audio action overlay node 718. Such persistence of the audio configuration of the intermediate audio file IA1 may be in association with the audio action overlay node 718.

In some embodiments, the processing circuitry (for example, the controller module 206, the transaction module 208, the audio node management module 216, or the like) may be configured to instantiate (namely, create and generate) an intermediate audio node 732. The intermediate audio node 732 may represent the audio configuration of the intermediate audio file IA1. The intermediate audio node 732 may include the fourth audio reference of the intermediate audio file IA1. The processing circuitry (for example, the controller module 206, the transaction module 208, the audio node management module 216, or the like) may be further configured to correlate (as shown by an arrow 734) the audio node 704 with the intermediate audio node 732. Such correlation of the audio node 704 and the intermediate audio node 732 may be indicative of a relation therebetween. In other words, the correlation of the audio node 704 with the intermediate audio node 732 may be indicative of a transition of the audio file A1 to form the intermediate audio file IA1. Similarly, the processing circuitry (for example, the controller module 206, the transaction module 208, the audio node management module 216, or the like) may be further configured to correlate (as shown by an arrow 736) the intermediate audio node 732 with the audio node 730. Such correlation of the intermediate audio node 732 and the audio node 730 may be indicative of a relation therebetween. In other words, the correlation of the intermediate audio node 732 with the audio node 730 may be indicative of a transition of the intermediate audio file IA1 to form the audio file A3.

In some embodiments, when the audio configuration of the intermediate audio file IA1 may be represented by the audio action overlay node 718, the intermediate audio node 732 may not be generated. In such embodiments, the processing circuitry (for example, the controller module 206, the transaction module 208, the audio node management module 216, or the like) may be further configured to correlate (as shown by an arrow 738) the audio node 704 with the audio node 730. Such correlation of the audio node 704 and the audio node 730 may be indicative of a relation therebetween. In other words, the correlation of the audio node 704 with the audio node 730 may be indicative of a transition of the audio file A1 to form the audio file A3.

In some embodiments, the processing circuitry (for example, the controller module 206, the transaction module 208, the audio node management module 216, or the like) may be further configured to generate a group node 740 based on the audio nodes 704 and 730, and the intermediate audio node 732. The group node 740 may include the audio nodes 704 and 730, and the intermediate audio node 732. The group node 740 may be generated to maintain the audio trail of the audio file A1. The group node 740 may refer to a composite structure (for example, a sub-graph, a container, or the like) within the executable graph-based model 100 that may include a plurality of audio nodes having a correlation therebetween.

A group node may have a standard structure similar to a generic node (for example, the generic node 302) or a run-time node (for example, the run-time node 336). The group node may persist in the executable graph-based model 100 as described in conjunction with FIG. 6.

In some embodiments, the processing circuitry (for example, the controller module 206, the transaction module 208, the audio node management module 216, or the like) may be further configured to generate the audio trail associated with the audio file A1 based on the group node 740. The audio trail associated with the audio file A1 may include the audio nodes 704 and 730, and the intermediate audio node 732 in a time-synchronized order of generation thereof. In other embodiments, the audio trail may be time-synchronized in accordance with a different constraint for example time of modification, or any other constraint. An audio trail for other audio files being represented by other audio nodes in the group node 740 may also be generated in a similar manner. In some embodiments, the audio trail may be generated from a reference time instance. In such embodiments, the audio trail may be generated in a forward time progression or a reverse time progression.

In some embodiments, the group node 740 may be a persistable node. Based on the group node 740 being the persistable node, the correlation among the audio nodes 704 and 730, and the intermediate audio node 732 may exist in the storage element of the overlay system 202. In other words, based on the group node 740 being the persistable node, the audio trail of the audio file A1 may persist in the storage element of the overlay system 202 at all times.

In some embodiments, the group node 740 may be a non-persistable node. Based on the group node 740 being the non-persistable node, the correlation among the audio nodes 704 and 730, and the intermediate audio node 732 may cease to exist in the overlay system 202 after a threshold time-interval. In other words, based on the group node 740 being the persistable node, the audio trail of the audio file A1 may cease to persist in the storage element of the overlay system 202 after an expiration of the threshold time-interval. The threshold time-interval may correspond to a time period for which the audio trail associated with the audio file A1 may be required for one or more operations associated with the overlay system 202.

Referring to FIG. 7B, in some embodiments, the processing circuitry (for example, the controller module 206, the transaction module 208, the audio node management module 216, or the like) may be further configured to associate the group node 740 with an overlay node 742. The overlay node 742 may be a standard operations overlay node or an audio action overlay node. The first audio action may be executed further based on the overlay node 742. In an instance, the overlay node 742 may be the standard operations overlay node, such as an obfuscation overlay node. In such an instance, the overlay node 742 may obfuscate the audio configurations represented by the audio nodes 704 and 730, and the intermediate audio node 732 encompassed within the group node 740. In an instance, the overlay node 742 may be the audio action overlay node, such as an audio compression overlay node. In such an instance, the overlay node 742 may communicate with a corresponding audio action module of the external system 702 and cause the corresponding audio action module to compress the audio files A1 and A3 and the intermediate audio file IA1 represented by the audio nodes 704, 730, and 732 encompassed within the group node 740.

Referring back to FIG. 7A, in some embodiments, based on the first stimulus, the processing circuitry (for example, the controller module 206, the transaction module 208, the stimuli management module 212, or the like) may be further configured to determine the audio action overlay node 720 associated with the audio node 704. The audio action overlay node 720 may include the second module reference of the audio action module 716 of the external system 702. The audio action module 716 may be configured to execute an audio operation that may be different from the audio operations performed by the audio action module 712. The first audio action may be executed further based on the audio action overlay node 720 in a manner similar to the execution of the first audio action based on the audio action overlay node 718. Based on the execution of the first audio action using the audio action overlay node 720, the audio action module 716 may generate an audio file A4 based on execution of the corresponding audio operation on the audio file A1. The processing circuitry (for example, the controller module 206, the transaction module 208, the audio node management module 216, or the like) may be further configured to receive, using the audio action overlay node 720, an audio configuration of the audio file A4 from the audio action module 716. The processing circuitry (for example, the controller module 206, the transaction module 208, the audio node management module 216, or the like) may be further configured to receive, using the audio action overlay node 720, a fifth audio reference of the audio file A4. The processing circuitry (for example, the controller module 206, the transaction module 208, the audio node management module 216, or the like) may be further configured to generate, using the audio action overlay node 720, an audio node 744 representing the audio configuration of the audio file A4 and including the fifth audio reference of the audio file A4.

In some embodiments, based on the first stimulus, the processing circuitry (for example, the controller module 206, the transaction module 208, the stimuli management module 212, or the like) may be further configured to determine the audio action overlay node 722 associated with the audio action overlay node 718. The audio action overlay node 722 may include the third module reference of the audio action module 714 of the external system 702. The audio action module 714 may be configured to execute an audio operation that may be different from the audio operations performed by the audio action modules 712 and 716. The first audio action may be executed further based on the audio action overlay node 722 in a manner similar to the execution of the first audio action based on the audio action overlay node 718. Based on the execution of the first audio action using the audio action overlay node 722, the audio action module 714 may generate an audio file A5 based on execution of a corresponding audio operation on the audio file A3. The processing circuitry (for example, the controller module 206, the transaction module 208, the audio node management module 216, or the like) may be further configured to receive, using the audio action overlay node 722, an audio configuration of the audio file A5 and a sixth audio reference of the audio file A5, from the audio action module 714. The processing circuitry (for example, the controller module 206, the transaction module 208, the audio node management module 216, or the like) may be further configured to generate, using the audio action overlay node 718 and/or the audio action overlay node 720, an audio node 746 representing the audio configuration of the audio file A5 and including the sixth audio reference.

In some embodiments, the audio files A4 and A5 may be associated with a common attribute (for example, time of generation, purpose of generation, owner, user, or the like). Therefore, the processing circuitry (for example, the controller module 206, the transaction module 208, the audio node management module 216, or the like) may be further configured to correlate, using at least one of the audio action overlay nodes 718, 720, or 722, the audio nodes 744 and 746 representing the audio files A4 and A5, respectively. The processing circuitry (for example, the controller module 206, the transaction module 208, the audio node management module 216, or the like) may be further configured to generate, using at least one of the audio action overlay nodes 718, 720, or 722, a group node 748 including the audio nodes 744 and 746.

Referring again to FIG. 7B, the processing circuitry (for example, the controller module 206, the transaction module 208, the audio node management module 216, or the like) may be further configured to correlate the group nodes 740 and 748. The correlation between the group nodes 740 and 748 may be based on the audio file A1 being an initial (namely, start, source) point for generation of each audio node included in the group nodes 740 and 748. In other embodiments, such correlation between two or more group nodes may be based on other factors such as (date of generation, owner, purpose of generation, associations among audio trails of one or more audio nodes in the group nodes, or the like).

As shown, the group nodes 740 and 748 are correlated based on the audio node 730 being associated with the audio node 746 by way of a role ‘source’. In other words, the audio node 730 may be a source node for the audio node 746. The audio node 730 is a source node to the audio node 746 based on the audio file A3 being a source for the audio file A5. Notably, the audio file A3 is the source for the audio file A5 as the audio file A5 is generated based on the audio file A3.

The group nodes 740 and 748 are further correlated by way of a contract overlay node 750 of the executable graph-based model 100. The group node 740 is associated with the contract overlay node 750 by way of the audio node 704 being associated with the contract overlay node 750. The contract overlay node 750 may be further associated with the group node 748. The group node 748 may be associated with the contract overlay node 750 based on the audio node 744 being associated with the contract overlay node 750. The contract overlay node 750 may be a standard operations overlay node and may be associated with a set of constraints that implement access control for accessing the audio node 704 or the group node 740 by way of the audio node 744. The access control associated with the audio node 704 or the group node 740 may be a private access, a public access, or a protected access. The public access of a node (for example, the audio node 704 and the group node 740) may correspond to the node being accessible from any other node in the executable graph-based model 100 without any restrictions. The private access of a node corresponds to the node being accessible only to itself or directly connected nodes within a restricted portion of the executable graph-based model 100. The protected access of a node corresponds to the node being accessible to its directly connected nodes and certain privileged nodes, such as those within a specific portion or hierarchy of the executable graph-based model 100.

In some embodiments, the audio nodes depicted in FIGS. 7A and 7B may be generic nodes and the overlay nodes (for example, standard operations overlay node and audio action overlay node) depicted in FIGS. 7A and 7B may be generic overlay nodes (for example, generic standard operations overlay node and generic audio action overlay node).

In some embodiments, the audio nodes depicted in FIGS. 7A and 7B may be run-time nodes and the overlay nodes (for example, run-time standard operations overlay node and run-time audio action overlay node) depicted in FIGS. 7A and 7B may be run-time overlay nodes (for example, run-time standard operations overlay node and run-time audio action overlay node). In such embodiments, each run-time audio node may include a corresponding node template and a corresponding node instance. For example, the audio node 704 may be associated with a node template and a node instance as described in conjunction with 4B. Based on the plurality of audio nodes shown in FIGS. 7A and 7B being run-time audio nodes, the overlay nodes (such as the audio action overlay nodes 718 and 720, and the overlay nodes 722 and 724) shown in FIGS. 7A and 7B may be run-time overlay nodes. Hence, each overlay node shown in FIGS. 7A and 7B may include an overlay node template and an overlay node instance. Notably, node template of a run-time node with overlay node-type corresponds to an overlay node template and node instance of a run-time node with overlay node-type corresponds to an overlay node instance as described in conjunction with FIGS. 4B and 5B. Additionally, based on the audio action overlay node 718 and the overlay node 722 being associated with the audio node 704 in a cascading manner, a sequence of execution and an output approach of processing logic thereof may be defined by the overlay node template of the audio action overlay node 718. A sequence of execution may refer to an order of execution of associated overlay nodes of a run-time node. An output approach refers to one or more rules in accordance with which an output of an audio operation is to be reflected in the executable graph-based model 100. In some embodiments, based on the sequence of execution defined by the overlay node template of the audio action overlay node 718, the processing logic of the overlay node 722 may be executed prior to the execution of the processing logic of the audio action overlay node 718. In some embodiments, based on the sequence of execution defined by the overlay node template, the processing logic of the audio action overlay node 718 may be executed prior to the execution of the processing logic of the overlay node 722. In addition, the group nodes 740 and 748 may be run-time nodes and may include corresponding node templates and corresponding node instances.

Additionally, loading of a run-time node (for example, a run-time audio node, a run-audio action overlay node, a run-time standard operations overlay node, or the like) is performed based on loading of its node template and node instance. Each of the node instance and the node template may be loaded as described in conjunction with FIG. 6.

It will be apparent to a person skilled in the art that an operation being executed by a node (for example, an audio node, an audio action overlay node, a standard operations overlay node, or the like) is actually executed by the processing circuitry using the node.

It should be appreciated that the references to ‘first audio node,’ ‘second audio node,’ and ‘intermediate audio node’ or other similar terms in the claims are not intended to refer to specific nodes but are used for distinguishing elements. These nodes may correspond to any of the audio nodes described in the specification, including, but not limited to, the audio nodes 704 and 706, or any other applicable audio node discussed herein.

It should be appreciated that the references to ‘first audio file,’ ‘second audio file,’ and ‘intermediate audio file’ or other similar terms in the claims are not intended to refer to specific audio files but are used for distinguishing elements. These audio files may correspond to any of the audio files described in the specification, including, but not limited to, the audio files A1 and A2, or any other applicable audio file discussed herein.

Although FIGS. 7A and 7B depict the plurality of audio files and the plurality of audio action modules to be associated with a single external system, in practical implementations the plurality of audio files and the plurality of audio action modules may be associated with distinct external systems associated with the overlay system 202.

Having discussed various concepts associated with the audio nodes in the executable graph-based model 100, the description now moves towards an implementation of the audio nodes in the executable graph-based model 100 for performing various audio operations for manipulation and modification of audio files represented by the audio nodes.

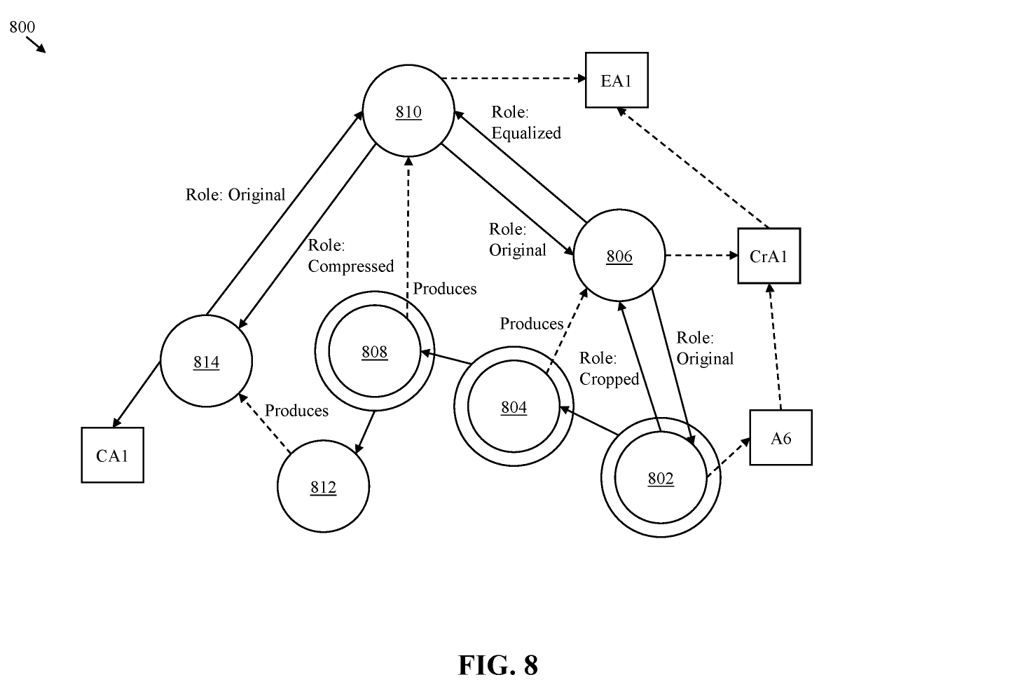

FIG. 8 illustrates a graph 800 that depicts an exemplary implementation of the executable graph-based model 100, consistent with disclosed embodiments of the present disclosure. Referring to FIG. 8, illustrated is an exemplary implementation of the audio nodes for the modification of audio files of an external system (for example, the external system 702). For the sake of description of FIG. 8, it is assumed that audio nodes depicted in FIG. 8 are generic audio nodes and audio action overlay nodes depicted in FIG. 8 are generic audio action overlay nodes.

As shown, the executable graph-based-model 100 may include an audio node 802 representing an audio file A6 of an external system (for example, the external system 702). Therefore, the audio node 802 may include a seventh audio reference (for example, a pointer, a storage location, a URL, or the like) associated with the audio file A6. The processing circuitry (for example, the controller module 206, the transaction module 208, the stimuli management module 212, or the like) may receive a second stimulus (for example, the stimulus 230) indicative of a second audio action to be executed on the audio file A6. Based on the second stimulus, the processing circuitry (for example, the controller module 206, the transaction module 208, stimuli management module 212, or the like) may identify the audio node 802 representing the audio file A6. Further, based on the audio node 802, the processing circuitry (for example, the controller module 206, the transaction module 208, the stimuli management module 212, or the like) may determine an audio cropping overlay node 804 from one or more audio action overlay nodes associated with the audio node 802. The audio cropping overlay node 804 may be determined based on a functionality thereof being able to execute a first audio operation of the second audio action indicated by the second stimulus. The first audio operation may correspond to an audio cropping operation.

The audio cropping overlay node 804 may include a fourth module reference of a crop audio action module (not shown) of the external system. The processing circuitry (for example, the controller module 206, the transaction module 208, the audio node management module 216, the overlay management module 236, or the like) may use audio cropping overlay node 804 to communicate the seventh audio reference associated with the audio file A6 to the crop audio action module. Subsequently, the crop audio action module may execute the audio cropping operation on the audio file A6. Based on the audio cropping operation executed on the audio file A6, a cropped audio CrA1 may be generated in the external system. The processing circuitry (for example, the controller module 206, the transaction module 208, the audio node management module 216, the overlay management module 236, or the like) may use the audio cropping overlay node 804 to receive audio configurations of the cropped audio CrA1 from the crop audio action module. The cropped audio CrA1 may not be a final output of the second audio action being executed on the audio file A6. Hence, the cropped audio CrA1 may be a first intermediate audio file. The processing circuitry (for example, the controller module 206, the transaction module 208, the audio node management module 216, or the like) may use the audio cropping overlay node 804 to produce (namely, generate, create, instantiate) an intermediate audio node 806. The intermediate audio node 806 may include an eighth audio reference of the cropped audio CrA1. Subsequently, the processing circuitry (for example, the controller module 206, the transaction module 208, the audio node management module 216, or the like) may use the audio cropping overlay node 804 to correlate the audio node 802 and the intermediate audio node 806 such that the audio node 802 may be associated with a role ‘Original’ and the intermediate audio node 806 may be associated with a role ‘Cropped’.

Subsequently, based on the audio cropping overlay node 804, the processing circuitry (for example, the controller module 206, the transaction module 208, the stimuli management module 212, or the like) may determine an audio equalizer overlay node 808 from one or more audio action overlay nodes associated with the audio cropping overlay node 804. The audio equalizer overlay node 808 may be determined based on a functionality thereof being able to execute a second audio operation of the second audio action indicated by the second stimulus. The second audio operation may correspond to an audio equalizer operation of the first intermediate audio file e.g., the cropped audio CrA1, generated based on the first audio operation.

The audio equalizer overlay node 808 may include a fifth module reference of an equalize audio action module (not shown) of the external system. The processing circuitry (for example, the controller module 206, the transaction module 208, the audio node management module 216, the overlay management module 236, or the like) may use the audio equalizer overlay node 808 to communicate the eighth audio reference associated with the cropped audio CrA1 to the equalize audio action module. Subsequently, the equalize audio action module may execute the audio equalizer operation on the cropped audio CrA1. Based on the audio equalizer operation executed on the cropped audio CrA1, an equalized audio EA1 may be generated in the external system.

The processing circuitry (for example, the controller module 206, the transaction module 208, the audio node management module 216, the overlay management module 236, or the like) may use the audio equalizer overlay node 808 to receive an audio configuration of the equalized audio EA1 from the equalize audio action module. The equalized audio EA1 may not be the final output of the second audio action being executed on the audio file A6. Hence, the equalized audio EA1 may be a second intermediate audio file. The processing circuitry (for example, the controller module 206, the transaction module 208, the audio node management module 216, or the like) may use the audio equalizer overlay node 808 to produce (namely, generate, create, instantiate) an intermediate audio node 810. The intermediate audio node 810 may include a ninth audio reference associated with the equalized audio EA1. Subsequently, the processing circuitry (for example, the controller module 206, the transaction module 208, the audio node management module 216, or the like) may use the audio equalizer overlay node 808 to correlate the intermediate audio node 806 and the intermediate audio node 810 such that the intermediate audio node 806 may be associated with a role ‘Original’ and the intermediate audio node 810 may be associated with a role ‘Equalized’.

Subsequently, based on the audio equalizer overlay node 808, the processing circuitry (for example, the controller module 206, the transaction module 208, the stimuli management module 212, or the like) may determine an audio compression overlay node 812 from one or more audio action overlay nodes associated with the audio equalizer overlay node 808. The audio compression overlay node 812 may be determined based on a functionality thereof being able to execute a third audio operation of the second audio action indicated by the second stimulus. The third audio operation may correspond to an audio compression operation of the second intermediate audio file e.g., the equalized audio EA1, generated based on the second audio operation.

The audio compression overlay node 812 may include a sixth module reference of an audio compression overlay node (not shown) of the external system. The processing circuitry (for example, the controller module 206, the transaction module 208, the audio node management module 216, the overlay management module 236, or the like) may use the audio compression overlay node 812 to communicate the ninth audio reference associated with the equalized audio EA1 to the audio compression action module. Subsequently, the audio compression action module may execute the audio compression operation on the equalized audio EA1. Based on the audio compression operation executed on the equalized audio EA1, a compressed audio CA1 may be generated in the external system.

The processing circuitry (for example, the controller module 206, the transaction module 208, the audio node management module 216, the overlay management module 236, or the like) may use audio compression overlay node 812 to receive an audio configuration of the compressed audio CA1 from the audio compression action module. The compressed audio CA1 may be the final output of the second audio action being executed on the audio file A6. The processing circuitry (for example, the controller module 206, the transaction module 208, the audio node management module 216, or the like) may use the audio compression overlay node 812 to produce (namely, generate, create, instantiate) a compressed audio node 814. Subsequently, the processing circuitry (for example, the controller module 206, the transaction module 208, the audio node management module 216, or the like) may use the audio compression overlay node 812 to correlate the intermediate audio node 810 and the compressed audio node 814 such that the intermediate audio node 810 may be associated with a role ‘Original’ and the compressed audio node 814 may be associated with a role ‘Compressed’. The first, second, and third audio operations may constitute the second audio action. Completion of the first, second, and third audio operations may mark a completion of the second audio action indicated by the second stimulus.

In some embodiments, based on the generation of the equalized audio EA1, the cropped audio CrA1 may be discarded. In such embodiments, in an event of execution of a rollback operation, the cropped audio CrA1 may be re-created based on the audio node 806. Alternatively, an inverse operation may be performed on the equalized audio EA1 to re-create the cropped audio CrA1. The inverse operation may be performed by the overlay system 202 as described throughout the description.

Notably, the audio cropping operation, the audio equalizer operation, and the audio compression operation are executed by the crop audio action module, equalize audio action module, and the compress audio action module, respectively, of the external system. Each of the crop audio action module, equalize audio action module, and the compress audio action module may execute corresponding operations (for example, the audio cropping operation, the audio equalizer operation, and the audio compression operation) based on a processor (for example, CPU, GPU, or the like) associated with the external system.

The audio files A6, CrA1, EA1, CA1, or any other audio file associated with the external system may be stored in a storage (for example, main memory, file system, or the like) in various forms, including but not limited to, waveform-based formats (Pulse Code Modulation, Adaptive Differential Pulse Code Modulation), spectral representations (Short-Time Fourier Transform, Wavelet Transform), parametric models (Linear Predictive Coding, Sinusoidal Modeling), compressed formats (MPEG Audio Layer-3, Advanced Audio Coding, Free Lossless Audio Codec), symbolic representations (Musical Instrument Digital Interface, Note-based Transcriptions), and graph-based representations (Feature-based Graphs, Temporal Graphs, Frequency Component Graphs).

Notably, the second audio action performed on the audio file A6 may be performed dynamically based on one or more inputs received via the API facilitated by the processing circuitry (for example, the interface module 204, or the like). In other words, a sequence of execution of the first, second, and third audio operations may not be predefined and may be dynamically selected by way of the API. In addition, generation of various intermediate audio files and corresponding audio nodes may not be predefined and hence may be dynamic and based on one or more user inputs received via the API.

Having discussed the implementation example for the executable graph-based model 100 with audio nodes that may be generic audio nodes, the description now moves towards an implementation example of the executable graph-based model 100 with audio nodes that may be run-time audio nodes.

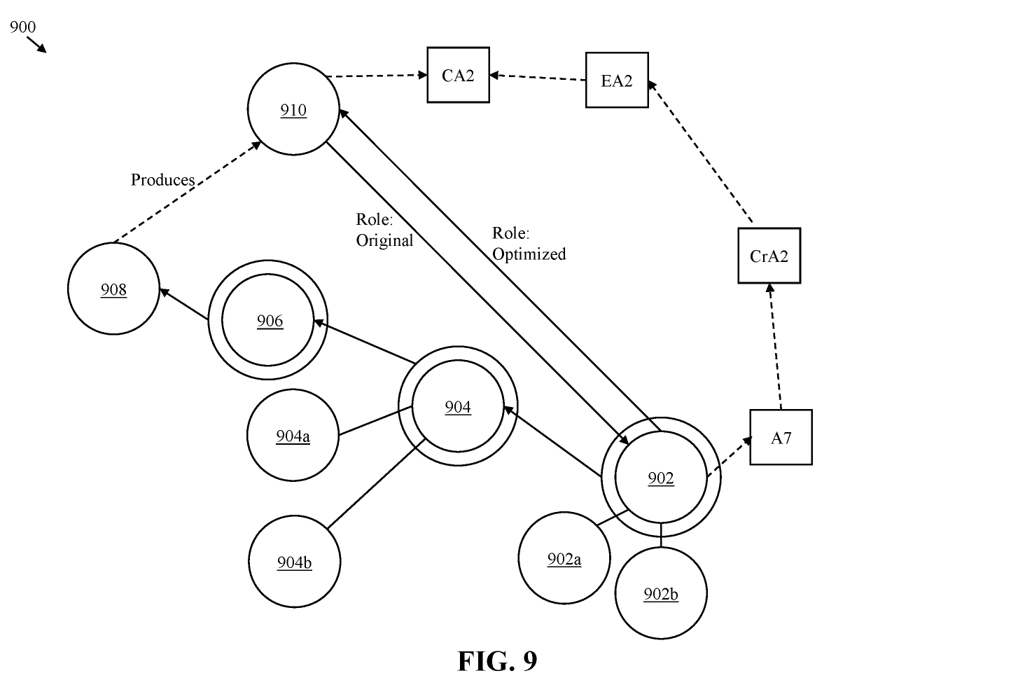

FIG. 9 illustrates a graph 900 that depicts another exemplary implementation of the executable graph-based model 100, consistent with disclosed embodiments of the present disclosure. Referring to FIG. 9, illustrated is an exemplary implementation of the audio nodes for modification of audio files of an external system (for example, the external system 702). For the sake of description of FIG. 9, it is assumed that audio nodes and audio action overlay nodes depicted in FIG. 9 correspond to run-time audio nodes run-time overlay nodes, respectively. Therefore, each audio node and audio action overlay node depicted in FIG. 9 may include a node template and a node instance. For example, a run-time audio node 902 depicted in FIG. 9 may include a node template 902a and a node instance 902b. Similarly, each of the other run-time audio nodes depicted in FIG. 9 may also include a corresponding node template and a corresponding node instance. Moreover, a run-time audio action overlay node 904 may include a node template 904a and a node instance 904b. Similarly, each of the other run-time audio action overlay nodes depicted in FIG. 9 may also include corresponding node templates and corresponding node instances.

The run-time audio node 902 may represent an audio file A7 of an external system (for example, the external system 702). Therefore, the run-time audio node 902 may include a tenth audio reference (for example, a pointer, a storage location, a URL, or the like) associated with the audio file A7. The processing circuitry (for example, the controller module 206, the transaction module 208, the stimuli management module 212, or the like) may receive a third stimulus (for example, the stimulus 230) indicative of a third audio action to be executed on the audio file A7. Based on the third stimulus, the stimuli management module 212, or the like) may identify the run-time audio node 902 representing the audio file A7. Further, based on the run-time audio node 902, the processing circuitry (for example, the controller module 206, the transaction module 208, the stimuli management module 212, or the like) may determine a run-time audio action overlay node 904 from one or more run-time audio action overlay nodes associated with the run-time audio node 902. The run-time audio action overlay node 904 may be determined based on a functionality thereof being able to execute a fourth audio operation of the third audio action indicated by the third stimulus. The fourth audio operation may correspond to an audio cropping operation and the functionality of the run-time audio action overlay node 904 may be processing logic that when executed causes a cropping operation of an audio file represented by an associated audio node.

Based on the identification of the run-time audio node 902 and the determination of the run-time audio action overlay node 904, the processing circuitry (for example, the memory management module 218, the storage management module 220, or the like) may be configured to determine whether the run-time audio node 902 and/or the run-time audio action overlay node 904 is unloaded from the executable graph-based model 100. Based on the determination that the run-time audio node 902 and/or the run-time audio action overlay node 904 is unloaded from the executable graph-based model 100, the processing circuitry (for example, the memory management module 218, the storage management module 220, or the like) may load the run-time audio node 902 and/or the run-time audio action overlay node 904. The run-time audio node 902 may be loaded based on loading of the node template 902a and the node instance 902b. Similarly, the run-time audio action overlay node 904 may be loaded based on loading of the node template 904a and the node instance 904b.

As shown, the run-time audio action overlay node 904 may be further associated with run-time audio action overlay nodes 906 and 908 in a cascading manner. In other words, the run-time audio action overlay node 906 may be directly associated with the run-time audio action overlay node 904 and the run-time audio action overlay node 908 may be associated with the run-time audio action overlay node 904 via the run-time audio action overlay node 906. In such a scenario, based on the run-time audio action overlay nodes 904, 906, and 908 being run-time nodes, the node template 904a of the run-time audio action overlay node 904 may define an operation sequence and an output strategy associated with an execution of processing logics of the run-time audio action overlay nodes 904, 906 and 908. In other words, the node template 904a may define various parameters, constraints, or the like associated with the execution of the processing logic of the run-time audio action overlay nodes 904, 906, and 908. In addition, the node template 904a may define various parameters, constraints, formats, storage, or the like associated with generation of outputs based on the execution of the processing logic of the run-time audio action overlay nodes 904, 906, and 908.

The run-time audio action overlay node 904 may include a seventh module reference of a crop audio action module (not shown) of the external system. The processing circuitry (for example, the controller module 206, the transaction module 208, the audio node management module 216, the overlay management module 236, or the like) may use run-time audio action overlay node 904 to communicate the tenth audio reference associated with the audio file A7 to the crop audio action module. Subsequently, the crop audio action module may execute the audio cropping operation on the audio file A7. Based on the audio cropping operation executed on the audio file A7, a cropped audio CrA2 may be generated in the external system. The processing circuitry (for example, the controller module 206, the transaction module 208, the audio node management module 216, the overlay management module 236, or the like) may use the run-time audio action overlay node 904 to receive an audio configuration and an eleventh audio reference of the cropped audio CrA2 from the crop audio action module. The cropped audio CrA2 may not be a final output of the third audio action being executed on the audio file A7. Hence, the cropped audio CrA2 may be a third intermediate audio file. In addition, the node template 904a of the run-time audio action overlay node 904 may define the output strategy in accordance with which only final outputs may be represented in the executable graph-based model 100. Therefore, the cropped audio CrA2 is not represented by way of an audio node in the executable graph-based model 100.

Subsequently, based on the run-time audio action overlay node 904, the processing circuitry (for example, the controller module 206, the transaction module 208, the stimuli management module 212, or the like) may determine the run-time audio action overlay node 906 from one or more run-time audio action overlay nodes associated with the run-time audio action overlay node 904. The run-time audio action overlay node 906 may be determined based on a functionality thereof being able to execute a fifth audio operation of the third audio action indicated by the third stimulus. The fifth audio operation may correspond to an audio equalizer operation of the third intermediate audio file e.g., the cropped audio CrA2, generated based on the fourth audio operation.

The run-time audio action overlay node 906 may include an eighth module reference of an equalize audio action module (not shown) of the external system. The processing circuitry (for example, the controller module 206, the transaction module 208, the audio node management module 216, the overlay management module 236, or the like) may use the run-time audio action overlay node 904 to provide the eleventh audio reference of the cropped audio CrA2 to the run-time audio action overlay node 906. The processing circuitry (for example, the controller module 206, the transaction module 208, the audio node management module 216, the overlay management module 236, or the like) may use the run-time audio action overlay node 906 to communicate the eleventh audio reference associated with the cropped audio CrA2 to the equalize audio action module. Subsequently, the equalize audio action module may execute the audio equalizer operation on the cropped audio CrA2. Based on the audio equalizer operation executed on the cropped audio CrA2, an equalized audio EA2 may be generated in the external system.

The processing circuitry (for example, the controller module 206, the transaction module 208, the audio node management module 216, the overlay management module 236, or the like) may use the run-time audio action overlay node 906 to receive an audio configuration and a twelfth audio reference of the equalized audio EA2 from the equalize audio action module. The equalized audio EA2 may not be the final output of the third audio action being executed on the audio file A7. Hence, the equalized audio EA2 may be a fourth intermediate audio file. Hence, based on the output strategy defined by the node template 904a, the equalized node EA2 may not be represented in the executable graph-based model 100.

Subsequently, based on the run-time audio action overlay nodes 904 and 906, the processing circuitry (for example, the controller module 206, the transaction module 208, the stimuli management module 212, or the like) may determine the run-time audio action overlay node 908 from one or more run-time audio action overlay nodes associated with the run-time audio action overlay nodes 904 and 906. The run-time audio action overlay node 908 may be determined based on a functionality thereof being able to execute a sixth audio operation of the third audio action indicated by the third stimulus. The sixth audio operation may correspond to an audio compression operation of the fourth intermediate audio file e.g., the equalized audio EA2, generated based on the fifth audio operation.

The run-time audio action overlay node 908 may include a ninth module reference of a compress audio action module (not shown) of the external system. The processing circuitry (for example, the controller module 206, the transaction module 208, the audio node management module 216, the overlay management module 236, or the like) may use the run-time audio action overlay node 906 to provide the twelfth audio reference of the equalized audio EA2 to the run-time audio action overlay node 908. Further, the processing circuitry (for example, the controller module 206, the transaction module 208, the audio node management module 216, the overlay management module 236, or the like) may use the run-time audio action overlay node 908 to communicate the twelfth audio reference associated with the equalized audio EA2 to the audio compression action module. Subsequently, the audio compression action module may execute the audio compression operation on the equalized audio EA2. Based on the audio compression operation executed on the equalized audio EA2, a compressed audio CA2 may be generated in the external system.

The processing circuitry (for example, the controller module 206, the transaction module 208, the audio node management module 216, the overlay management module 236, or the like) may use run-time audio action overlay node 908 to receive an audio configuration and a thirteenth audio reference of the compressed audio CA2 from the audio compression action module. The compressed audio CA2 may be the final output of the third audio action being executed on the audio file A7. Therefore, based on the output strategy defined by the node template 904a, the compressed audio CA2 may be represented in the executable graph-based model 100.

The processing circuitry (for example, the controller module 206, the transaction module 208, the audio node management module 216, or the like) may use the run-time audio action overlay node 908 to produce (namely, generate, create, instantiate) an optimized audio node 910. Subsequently, the processing circuitry (for example, the controller module 206, the transaction module 208, the audio node management module 216, or the like) may use the run-time audio action overlay node 908 to correlate the optimized audio node 910 and the audio node 902 such that the optimized audio node 910 may be associated with a role ‘Optimized’ and the audio node 902 may be associated with a role ‘Original’. The optimized audio node 910 may represent the compressed audio CA2 that may be a cropped, equalized, and compressed version of the audio file A7, and may be the final output of the third audio action. The fourth, fifth, and sixth audio operations may constitute the third audio action. Completion of the fourth, fifth, and sixth audio operations may mark completion of the third audio action indicated by the third stimulus.

Although the exemplary scenario described herein pertains to modification of an audio file, the scope of the disclosure is not limited to it. In other embodiments, the overlay system 202 disclosed herein may be implemented to execute various other operations associated with audio files. In an example, the overlay system 202 may be implemented for performing analysis of audio files of an external system. In such an example, various audio action overlay node, having processing logic that when executed may cause analysis of one or more associated audio nodes, may be associated with audio nodes representing the audio files in the overlay system 202. Thus, analysis (for example, music genre analysis, music artist analysis, music lyrics analysis, or the like may be performed. Examples of various operations performed based on audio nodes and audio action overlay nodes may include but are not limited to, collaborative operations, genre classification, artist similarity, song similarity, playlist recommendations, music recommendation system, music streaming network, lyrics analysis, event and concert network, influence and impact, music production chain. Metadata management, taste clusters, historical evolution, and interactive music exploration.

Having discussed the implementation examples for the executable graph-based model 100 with audio nodes and audio action overlay nodes that may be the generic audio nodes or the run-time audio nodes, the description now discusses a computing system that facilitates such implementations of the executable graph-based model 100.

FIG. 10 shows an example computing system 1000 for carrying out the methods of the present disclosure, consistent with disclosed embodiments of the present disclosure. Specifically, FIG. 10 shows a block diagram of an embodiment of the computing system 1000 according to example embodiments of the present disclosure.

The computing system 1000 may be configured to perform any of the operations disclosed herein, such as, for example, any of the operations discussed with reference to the functional modules described in relation to FIG. 2. The computing system 1000 can be implemented as a conventional computer system, an embedded controller, a laptop, a server, a mobile device, a smartphone, a set-top box, a kiosk, a vehicular information system, one or more processors associated with a television, a customized machine, any other hardware platform, or any combination or multiplicity thereof. In one embodiment, the computing system 1000 is a distributed system configured to function using multiple computing machines interconnected via a data network or bus system.

The computing system 1000 includes computing devices (such as a computing device 1002). The computing device 1002 includes one or more processors (such as a processor 1004) and a memory 1006. The processor 1004 may be any general-purpose processor(s) configured to execute a set of instructions. For example, the processor 1004 may be a processor core, a multiprocessor, a reconfigurable processor, a microcontroller, a digital signal processor (DSP), an application-specific integrated circuit (ASIC), a graphics processing unit (GPU), a neural processing unit (NPU), an accelerated processing unit (APU), a brain processing unit (BPU), a data processing unit (DPU), a holographic processing unit (HPU), an intelligent processing unit (IPU), a microprocessor/microcontroller unit (MPU/MCU), a radio processing unit (RPU), a tensor processing unit (TPU), a vector processing unit (VPU), a wearable processing unit (WPU), a field programmable gate array (FPGA), a programmable logic device (PLD), a controller, a state machine, gated logic, discrete hardware component, any other processing unit, or any combination or multiplicity thereof. In one embodiment, the processor 1004 may be multiple processing units, a single processing core, multiple processing cores, special purpose processing cores, co-processors, or any combination thereof. The processor 1004 may be communicatively coupled to the memory 1006 via an address bus 1008, a control bus 1010, a data bus 1012, and a messaging bus 1014.

The memory 1006 may include non-volatile memories such as a read-only memory (ROM), a programable read-only memory (PROM), an erasable programmable read-only memory (EPROM), a flash memory, or any other device capable of storing program instructions or data with or without applied power. The memory 1006 may also include volatile memories, such as a random-access memory (RAM), a static random-access memory (SRAM), a dynamic random-access memory (DRAM), and a synchronous dynamic random-access memory (SDRAM). The memory 1006 may include single or multiple memory modules. While the memory 1006 is depicted as part of the computing device 1002, a person skilled in the art will recognize that the memory 1006 can be separate from the computing device 1002.

The memory 1006 may store information that can be accessed by the processor 1004. For instance, the memory 1006 (e.g., one or more non-transitory computer-readable storage mediums, memory devices) may include computer-readable instructions (not shown) that can be executed by the processor 1004. The computer-readable instructions may be software written in any suitable programming language or may be implemented in hardware. Additionally, or alternatively, the computer-readable instructions may be executed in logically and/or virtually separate threads on the processor 1004. For example, the memory 1006 may store instructions (not shown) that when executed by the processor 1004 cause the processor 1004 to perform operations such as any of the operations and functions for which the computing system 1000 is configured, as described herein. Additionally, or alternatively, the memory 1006 may store data (not shown) that can be obtained, received, accessed, written, manipulated, created, and/or stored. The data can include, for instance, the data and/or information described herein in relation to FIGS. 1-9. In some implementations, the computing device 1002 may obtain from and/or store data in one or more memory device(s) that are remote from the computing system 1000.

The computing device 1002 may further include an input/output (I/O) interface 1016 communicatively coupled to the address bus 1008, the control bus 1010, and the data bus 1012. The data bus 1012 and messaging bus 1014 may include a plurality of tunnels that may support parallel execution of messages by the overlay system 202. The I/O interface 1016 is configured to couple to one or more external devices (e.g., to receive and send data from/to one or more external devices). Such external devices, along with the various internal devices, may also be known as peripheral devices. The I/O interface 1016 may include both electrical and physical connections for operably coupling the various peripheral devices to the computing device 1002. The I/O interface 1016 may be configured to communicate data, addresses, and control signals between the peripheral devices and the computing device 1002. The I/O interface 1016 may be configured to implement any standard interface, such as a small computer system interface (SCSI), a serial-attached SCSI (SAS), a fiber channel, a peripheral component interconnect (PCI), a PCI express (PCIe), a serial bus, a parallel bus, an advanced technology attachment (ATA), a serial ATA (SATA), a universal serial bus (USB), Thunderbolt, FireWire, various video buses, or the like. The I/O interface 1016 is configured to implement only one interface or bus technology. Alternatively, the I/O interface 1016 is configured to implement multiple interfaces or bus technologies. The I/O interface 1016 may include one or more buffers for buffering transmissions between one or more external devices, internal devices, the computing device 1002, or the processor 1004. The I/O interface 1016 may couple the computing device 1002 to various input devices, including mice, touch screens, scanners, biometric readers, electronic digitizers, sensors, receivers, touchpads, trackballs, cameras, microphones, keyboards, any other pointing devices, or any combinations thereof. The I/O interface 1016 may couple the computing device 1002 to various output devices, including video displays, speakers, printers, projectors, tactile feedback devices, automation control, robotic components, actuators, motors, fans, solenoids, valves, pumps, transmitters, signal emitters, lights, and so forth.

The computing system 1000 may further include a storage unit 1018, a network interface 1020, an input controller 1022, and an output controller 1024. The storage unit 1018, the network interface 1020, the input controller 1022, and the output controller 1024 are communicatively coupled to the central control unit (e.g., the memory 1006, the address bus 1008, the control bus 1010, and the data bus 1012) via the I/O interface 1016. The network interface 1020 communicatively couples the computing system 1000 to one or more networks such as wide area networks (WAN), local area networks (LAN), intranets, the Internet, wireless access networks, wired networks, mobile networks, telephone networks, optical networks, or combinations thereof. The network interface 1020 may facilitate communication with packet-switched networks or circuit-switched networks which use any topology and may use any communication protocol. Communication links within the network may involve various digital or analog communication media such as fiber optic cables, free-space optics, waveguides, electrical conductors, wireless links, antennas, radio-frequency communications, and so forth.

The storage unit 1018 is a computer-readable medium, preferably a non-transitory computer-readable medium, comprising one or more programs, the one or more programs comprising instructions which when executed by the processor 1004 cause the computing system 1000 to perform the method steps of the present disclosure. Alternatively, the storage unit 1018 is a transitory computer-readable medium. The storage unit 1018 can include a hard disk, a floppy disk, a compact disc read-only memory (CD-ROM), a digital versatile disc (DVD), a Blu-ray disc, a magnetic tape, a flash memory, another non-volatile memory device, a solid-state drive (SSD), any magnetic storage device, any optical storage device, any electrical storage device, any semiconductor storage device, any physical-based storage device, any other data storage device, or any combination or multiplicity thereof. In one embodiment, the storage unit 1018 stores one or more operating systems, application programs, program modules, data, or any other information. The storage unit 1018 is part of the computing device 1002. Alternatively, the storage unit 1018 is part of one or more other computing machines that are in communication with the computing device 1002, such as servers, database servers, cloud storage, network attached storage, and so forth.

The input controller 1022 may include suitable logic, circuitry, interfaces, and/or code, executable by the circuitry, that may be configured to control one or more input devices that may be configured to receive an input (the stimulus 230) for the overlay system 202. The output controller 1024 may include suitable logic, circuitry, interfaces, and/or code, executable by the circuitry, that may be configured to control one or more output devices that may be configured to render/output the outcome of the operation executed to process the received input (the stimulus 230).

Having discussed the computing system 1000 that implements the audio nodes in the overlay system 202 disclosed herein, the description now moves towards methods that are executed to facilitate such an implementation of the audio nodes in the overlay system 202.

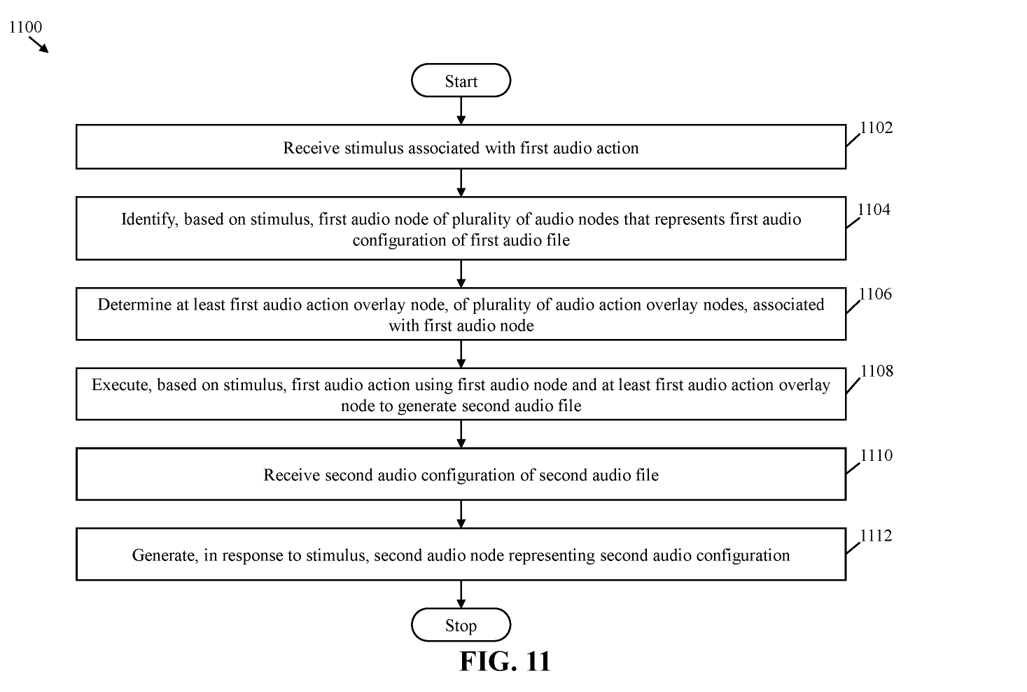

FIG. 11 illustrates a flowchart 1100 of a method for implementation of the audio nodes in the executable graph-based model 100, consistent with disclosed embodiments of the present disclosure. Referring to FIG. 11, at 1102, a stimulus associated with a first audio action may be received. The processing circuitry (such as the controller module 206, the transaction module 208, the stimuli management module 212, or the like) may receive the stimulus associated with the first audio action.

At 1104, a first audio node, of the plurality of audio nodes, that represents a first audio configuration of the first audio file may be identified. The processing circuitry (such as the controller module 206, the stimuli management module 212, or the like) may identify the first audio node from the plurality of audio nodes based on a context of the stimulus. The first audio node may represent the first audio configuration of the first audio file of the external system associated with the overlay system 202.

At 1106, at least a first audio action overlay node, of the plurality of audio action overlay nodes, associated with the first audio node may be determined. The processing circuitry (for example, the controller module 206, the transaction module 208, or the like) may be configured to determine the first audio action overlay node based on association with the first audio node.

At 1108, the first audio action may be executed based on the stimulus. The processing circuitry (for example, the controller module 206, the transaction module 208, or the like) may be configured to execute the first audio action. The processing circuitry (for example, the controller module 206, the transaction module 208, or the like) may be configured to execute the first audio action using the first audio node and at least the first audio action overlay node to generate a second audio file in the external system.

At 1110, a second audio configuration of the second audio file may be received from the external system. The processing circuitry (for example, controller module 206, the transaction module 208, or the like) may be configured to receive the second audio configuration of the second audio file from the external system using the first audio action overlay node.

At 1112, a second audio node, representing the second audio configuration of the second audio file, may be generated in the executable graph-based model 100 in response to the stimulus. The processing circuitry (for example, the controller module 206, the transaction module 208, or the like) may be configured to generate the second audio node using the first audio action overlay node.

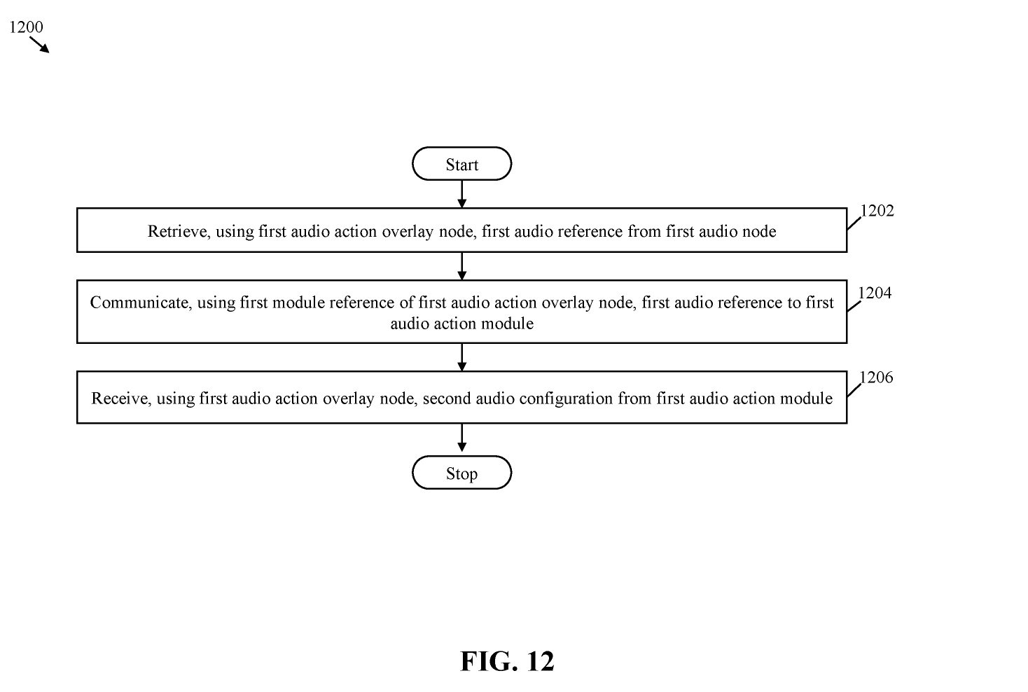

FIG. 12 illustrates a flowchart 1200 of a method for execution of the first audio action, consistent with disclosed embodiments of the present disclosure. Referring to FIG. 12, at 1202, a first audio reference of the first audio file of the external system may be retrieved from the first audio node. The processing circuitry (such as the controller module 206, the stimuli management module 212, the audio node management module 216, or the like) may retrieve the first audio reference using the first audio action overlay node.

At 1204, the first audio reference may be communicated to a first audio action module of the external system. The processing circuitry (such as the controller module 206, the stimuli management module 212, the audio node management module 216, or the like) may use the first audio action overlay node to communicate the first audio reference to the first audio action module. The processing circuitry (such as the controller module 206, the stimuli management module 212, the audio node management module 216, or the like) may perform such a communication based on a first module reference of the first audio action module included in the first audio action overlay node. The first audio action module uses the first audio reference to execute an audio operation, of the first audio action, on the first audio file to generate the second audio file.

At 1206, the second audio configuration associated with the second audio file may be received from the first audio action module. The processing circuitry (such as the controller module 206, the stimuli management module 212, the audio node management module 216, or the like) may use the first audio action overlay node to receive the second audio configuration associated with the second audio file.

The disclosed embodiments encompass numerous advantages, including a simple and user-friendly implementation of the executable graph-based model 100 that may be, in turn used to implement various complex and advanced applications. The disclosed systems and methods allow for facilitation and implementation of audio nodes in the executable graph-based model 100. The overlay system 202 disclosed herein introduces domain-specific optimizations pertaining to the domain of audio processing. Such optimization of the executable graph-based model 100 can significantly enhance the performance, scalability, and precision of the overlay system 202. By incorporating specialized audio node structures and tailored processing logic by way of audio action overlay nodes, the overlay system 202 may streamline data representation, ensuring that each audio node is optimized for its intended application. This specialization enables more efficient traversal, retrieval, and computation, reducing redundant processing and improving overall system responsiveness.

Beyond performance improvements, the disclosed overlay system 202 fosters greater interpretability and decision-making capabilities by embedding domain-aware intelligence into the executable graph-based model 100 by way of audio action overlay nodes. Unlike generic implementations, which require extensive customization for domain-specific insights, a structured and optimized approach facilitates seamless integration of industry-specific heuristics, machine learning models, and automated rule-based processing. As a result, users benefit from more accurate execution of operations associated with the audio nodes. Furthermore, the ability of the overlay system 202 to incorporate real-time adjustments based on evolving technological trends ensures sustained adaptability, making it a powerful tool for industries requiring high precision and efficiency in data-driven decision-making.

A person of ordinary skill in the art will appreciate that embodiments and exemplary scenarios of the disclosed subject matter may be practiced with various computer system configurations, including multi-core multiprocessor systems, minicomputers, mainframe computers, computers linked or clustered with distributed functions, as well as pervasive or miniature computers that may be embedded into virtually any device. Further, the operations may be described as a sequential process, however, some of the operations may be performed in parallel, concurrently, and/or in a distributed environment, and with program code stored locally or remotely for access by single or multiprocessor machines. In addition, in some embodiments, the order of operations may be rearranged without departing from the spirit of the disclosed subject matter.

Techniques consistent with the present disclosure provide, among other features, systems and methods for the implementation of a plurality of audio nodes in conjunction with a plurality of audio action overlay nodes in the executable graph-based models. While various embodiments of the disclosed systems and methods have been described above, it should be understood that they have been presented for purposes of example only, and not limitations. It is not exhaustive and does not limit the present disclosure to the precise form disclosed. Modifications and variations are possible in light of the above teachings or may be acquired from practicing the present disclosure, without departing from the breadth or scope.

Moreover, for example, the present technology/system may achieve the following configurations:

1. An overlay system, comprising:
   a storage element configured to store an executable graph-based model that includes a plurality of audio nodes and a plurality of audio action overlay nodes,
      wherein the plurality of audio nodes represent a plurality of audio configurations associated with a plurality of audio files, and
      wherein each audio node of the plurality of audio nodes is associated with one or more audio action overlay nodes of the plurality of audio action overlay nodes; and processing circuitry that is coupled to the storage element, and configured to:
      receive a stimulus associated with a first audio action to be executed based on a first audio file of the plurality of audio files;
      identify, based on the stimulus, from the plurality of audio nodes, a first audio node that represents a first audio configuration of the first audio file;
      determine a first audio action overlay node, of the plurality of audio action overlay nodes, associated with the first audio node;
      execute the first audio action based on the first audio node and the first audio action overlay node to generate a second audio file; and
      generate, in the executable graph-based model, in response to the stimulus, a second audio node, representing a second audio configuration of the second audio files.

2. The overlay system of 1, wherein the processing circuitry determines the first audio action overlay node based on the first audio action being in conformity with a functionality of the first audio action overlay node.

3. The overlay system of 1, wherein the first audio file corresponds to at least one of: (i) an encoded audio signal, (ii) metadata describing an audio signal, (iii) one or more feature representations of an audio content, (iv) one or more annotations indicative of temporal characteristics of the audio signal, or (v) one or more annotations indicative of spectral characteristics of the audio signal.

4. The overlay system of 1, wherein the first audio configuration corresponds to at least one of: (i) one or more audio parameters, (ii) an encoding format, (iii) one or more feature representations, (iv) one or more processing settings, (v) metadata, or (vi) one or more annotations, associated with the first audio file.

5. The overlay system of 1, wherein the first audio action overlay node is at least one of: an audio generation overlay node, an audio modification overlay node, or an audio analyzer overlay node.

6. The overlay system of 1, wherein the executable graph-based model further includes a plurality of standard operations overlay nodes, wherein the processing circuitry is further configured to determine a first standard operations overlay node, of the plurality of standard operations overlay nodes, associated with the first audio node, and wherein the first audio action is executed further based on the first standard operations overlay node.

7. The overlay system of 1, wherein the first audio node includes a first audio reference of the first audio file, wherein the first audio action overlay node includes a first module reference of a first audio action module, and wherein for the execution of the first audio action, the processing circuitry is further configured to: retrieve, based on the first audio action overlay node, the first audio reference from the first audio node; communicate, based on the first module reference of the first audio action overlay node, the first audio reference to the first audio action module, wherein an audio operation, of the first audio action, is executed on the first audio file by the first audio action module using the first audio reference, to generate the second audio file; and receive, using the first audio action overlay node, the second audio configuration from the first audio action module.

8. The overlay system of 7, wherein the execution of the first audio action generates at least one intermediate audio file associated with the first audio file, and wherein prior to the reception of the second audio configuration, the processing circuitry is further configured to receive, based on the first audio action overlay node, a third audio configuration of the at least one intermediate audio file from the first audio action module.

9. The overlay system of 1, wherein the processing circuitry is further configured to determine a second audio action overlay node, of the plurality of audio action overlay nodes, associated with the first audio node, wherein the second audio action overlay node includes a second module reference of a second audio action module, and wherein the first audio action is executed further based on the second audio action overlay node.

10. The overlay system of 1, wherein the first audio node further includes a first overlay manager configured to manage the association of the first audio node with the first audio action overlay node.

11. The overlay system of 1, wherein the processing circuitry is further configured to determine a third audio action overlay node, of the plurality of audio action overlay nodes, associated with the first audio action overlay node, and wherein the first audio action is executed further based on the third audio action overlay node.

12. The overlay system of 11, wherein the first audio action overlay node further includes a second overlay manager configured to manage the association of the first audio action overlay node with the third audio action overlay node.

13. The overlay system of 1, wherein the first audio node is one of a stateful node or a stateless node.

14. The overlay system of 13, wherein based on the first audio node being the stateful node, the first audio configuration remains stored with the storage element upon unloading of the first audio node.

15. The overlay system of 13, wherein based on the first audio node being the stateless node, the first audio configuration ceases to exist in the storage element upon unloading of the first audio node.

16. The overlay system of 1, wherein based on the execution of the first audio action, the processing circuitry is further configured to store the first audio configuration in association with the first audio action overlay node.

17. The overlay system of 16, wherein the first audio action overlay node is one of a stateful node or a stateless node.

18. The overlay system of 17, wherein based on the first audio action overlay node being the stateful node, the first audio configuration is stored in the storage element upon unloading of the first audio action overlay node.

19. The overlay system of 17, wherein based on the first audio action overlay node being the stateless node, the first audio configuration ceases to exist in the storage element upon unloading of the first audio action overlay node.

20. The overlay system of 1, wherein upon the execution of the first audio action, the processing circuitry is further configured to: associate the first audio configuration with the first audio action overlay node, and discard the first audio node from the executable graph-based model.

21. The overlay system of 1, wherein the execution of the first audio action generates at least one intermediate audio file associated with the first audio file, wherein the at least one intermediate audio file is generated prior to the generation of the second audio file, and wherein the processing circuitry is further configured to receive, using the first audio action overlay node, a third audio configuration of the at least one intermediate audio file.

22. The overlay system of 21, wherein the first audio action overlay node represents the third audio configuration of the at least one intermediate audio file.

23. The overlay system of 21, wherein the processing circuitry is further configured to instantiate, based on the first audio action overlay node, at least one intermediate audio node representing the third audio configuration of the at least one intermediate audio file.

24. The overlay system of 23, wherein the processing circuitry is further configured to correlate, based on the first audio action overlay node, the first audio node with at least one of the at least one intermediate audio node or the second audio node.

25. The overlay system of 23, wherein the processing circuitry is further configured to generate a first group node that includes at least one of: the first audio node, the at least one intermediate audio node, or the second audio node.

26. The overlay system of 25,
wherein the processing circuitry is further configured to generate, based on the first group node, an audio trail associated with the first audio file, and
wherein the audio trail includes a time-synchronized order of audio mutations of the first audio file.

27. The overlay system of 25,
wherein the first group node is associated with a second group node, and
wherein the second group node includes a third audio node correlated with at least one of: the first audio node, the at least one intermediate audio node, or the second audio node.

28. The overlay system of 25,
wherein the processing circuitry is further configured to associate a fourth audio action overlay node, of the plurality of audio action overlay nodes, with the first group node, and
wherein the first audio action is executed further based on the fourth audio action overlay node.

29. The overlay system of 25,
wherein the executable graph-based model further includes a plurality of standard operations overlay nodes,
wherein the first group node is further associated with a second standard operations overlay node of the plurality of standard operations overlay nodes,
and wherein the first audio action is executed further based on the second standard operations overlay node.

30. The overlay system of 25, wherein the first group node is one of a persistable node or a non-persistable node.

31. The overlay system of 30,
wherein based on the first group node being the persistable node, an audio trail of the first audio node is stored in the storage element, and
wherein the audio trail of the first audio node includes a time-synchronized order of at least one of:
   the first audio node,
   the at least one intermediate audio node,
   or the second audio node.

32. The overlay system of 30,
wherein based on the first group node being the non-persistable node, an audio trail of the first audio node ceases to exist from the storage element upon expiration of a threshold time-interval, and
wherein the audio trail of the first audio node includes a time-synchronized order of at least one of:
   the first audio node,
   the at least one intermediate audio node,
   or the second audio node.

33. The overlay system of 25,
wherein the first group node is further associated with a contract overlay node of the executable graph-based model, and
wherein the processing circuitry is further configured to execute, using the contract overlay node, a set of constraints that implements access control associated with the first group node.

34. The overlay system of 33, wherein the access control associated with the first group node includes one of a private access, a public access, or a protected access.

35. The overlay system of 1, wherein based on the stimulus, the processing circuitry is further configured to:
determine whether at least one of the first audio node or the first audio action overlay node is unloaded, from the executable graph-based model; and
load, in the executable graph-based model, based on at least one of the first audio node or the first audio action overlay node being unloaded from the executable graph-based model, at least one of the first audio node or the first audio action overlay node.

36. The overlay system of 1, wherein based on the generation of the second audio node, the processing circuitry is further configured to unload at least one of: the first audio node, the second audio node, or the first audio action overlay node, from the executable graph-based model.

37. The overlay system of 1, wherein the first audio node is a generic node and the first audio action overlay node is a generic overlay node.

38. The overlay system of 1,
wherein the first audio node is a run-time node that includes (i) a node template that defines a node structure and (ii) a node instance that is an implementation of the node template, and
wherein based on the first audio node being the run-time node, the first audio action overlay node is a run-time overlay node that includes
   (i) an overlay node template that defines an overlay node structure and
   (ii) an overlay node instance that is an implementation of the overlay node template.

39. The overlay system of 38, wherein the processing circuitry is further configured to:
load the run-time node based on loading of the node template and the node instance, and
load the run-time overlay node based on loading of the overlay node template and the overlay node instance.

40. The overlay system of 38,
wherein each audio action overlay node of the plurality of audio action overlay nodes is a run-time overlay node,
wherein the processing circuitry is further configured to determine one or more audio action overlay nodes, of the plurality of audio action overlay nodes, associated with the first audio action overlay node,
wherein the first audio action is executed further based on the one or more audio action overlay nodes, and
wherein the overlay node template of the first audio action overlay node defines a sequence of operations associated with the one or more audio action overlay nodes.

41. The overlay system of 1, wherein the first audio node is an edge node.

42. A method, comprising:
receiving, by processing circuitry of an overlay system, a stimulus associated with a first audio action,
   wherein the first audio action is to be executed based on a first audio file of a plurality of audio files,
   wherein an executable graph-based model is stored in a storage element of the overlay system and includes a plurality of audio nodes and a plurality of audio action overlay nodes,
   wherein the plurality of audio nodes represent a plurality of audio configurations of the plurality of audio files, and
   wherein each audio node of the plurality of audio nodes is associated with one or more audio action overlay nodes of the plurality of audio action overlay nodes;
identifying, by the processing circuitry, based on the stimulus, a first audio node of the plurality of audio nodes that represents a first audio configuration of the first audio file;
determining, by the processing circuitry, a first audio action overlay node, of the plurality of audio action overlay nodes, associated with the first audio node;
executing, by the processing circuitry, the first audio action based on the first audio node and the first audio action overlay node to generate a second audio file; and
generating, by the processing circuitry, in response to the stimulus, a second audio node, representing a second audio configuration of the second audio file.

What is claimed is:

1. An overlay system, comprising:
a storage element configured to store an executable graph-based model that includes a plurality of audio nodes and a plurality of audio action overlay nodes,
wherein the plurality of audio nodes represent a plurality of audio configurations associated with a plurality of audio files, and
wherein each audio node of the plurality of audio nodes is associated with one or more audio action overlay nodes of the plurality of audio action overlay nodes; and
processing circuitry that is coupled to the storage element, and configured to:
receive a stimulus associated with a first audio action to be executed based on a first audio file of the plurality of audio files;
identify, based on the stimulus, from the plurality of audio nodes, a first audio node that represents a first audio configuration of the first audio file;
determine a first audio action overlay node, of the plurality of audio action overlay nodes, associated with the first audio node;
execute the first audio action based on the first audio node and the first audio action overlay node to generate a second audio file; and
generate, in the executable graph-based model, in response to the stimulus, a second audio node, representing a second audio configuration of the second audio file.

2. The overlay system of claim 1, wherein the first audio file corresponds to at least one of: (i) an encoded audio signal, (ii) metadata describing an audio signal, (iii) one or more feature representations of an audio content, (iv) one or more annotations indicative of temporal characteristics of the audio signal, or (v) one or more annotations indicative of spectral characteristics of the audio signal.

3. The overlay system of claim 1, wherein the first audio configuration corresponds to at least one of: (i) one or more audio parameters, (ii) an encoding format, (iii) one or more feature representations, (iv) one or more processing settings, (v) metadata, or (vi) one or more annotations, associated with the first audio file.

4. The overlay system of claim 1,
wherein the first audio node includes a first audio reference of the first audio file,
wherein the first audio action overlay node includes a first module reference of a first audio action module, and
wherein for the execution of the first audio action, the processing circuitry is further configured to:
retrieve, based on the first audio action overlay node, the first audio reference from the first audio node;
communicate, based on the first module reference of the first audio action overlay node, the first audio reference to the first audio action module, wherein an audio operation, of the first audio action, is executed on the first audio file by the first audio action module, using the first audio reference, to generate the second audio file; and
receive, using the first audio action overlay node, the second audio configuration from the first audio action module.

5. The overlay system of claim 4,
wherein the execution of the first audio action generates at least one intermediate audio file associated with the first audio file, and
wherein prior to the reception of the second audio configuration, the processing circuitry is further configured to receive, based on the first audio action overlay node, a third audio configuration of the at least one intermediate audio file from the first audio action module.

6. The overlay system of claim 1,
wherein the processing circuitry is further configured to determine a third audio action overlay node, of the plurality of audio action overlay nodes, associated with the first audio action overlay node, and
wherein the first audio action is executed further based on the third audio action overlay node.

7. The overlay system of claim 1, wherein based on the execution of the first audio action, the processing circuitry is further configured to store the first audio configuration in association with the first audio action overlay node.

8. The overlay system of claim 7,
wherein the first audio action overlay node is one of a stateful node or a stateless node
wherein based on the first audio action overlay node being the stateful node, the first audio configuration is stored in the storage element upon unloading of the first audio action overlay node, and
wherein based on the first audio action overlay node being the stateless node, the first audio configuration ceases to exist in the storage element upon unloading of the first audio action overlay node.

9. The overlay system of claim 1,
wherein the execution of the first audio action generates at least one intermediate audio file associated with the first audio file,
wherein the at least one intermediate audio file is generated prior to the generation of the second audio file, and
wherein the processing circuitry is further configured to receive, using the first audio action overlay node, a third audio configuration of the at least one intermediate audio file.

10. The overlay system of claim 9, wherein the first audio action overlay node represents the third audio configuration of the at least one intermediate audio file.

11. The overlay system of claim 9, wherein the processing circuitry is further configured to instantiate, based on the first audio action overlay node, at least one intermediate audio node representing the third audio configuration of the at least one intermediate audio file.

12. The overlay system of claim 11, wherein the processing circuitry is further configured to correlate, based on the first audio action overlay node, the first audio node with at least one of the at least one intermediate audio node or the second audio node.

13. The overlay system of claim 11, wherein the processing circuitry is further configured to generate a first group node that includes at least one of: the first audio node, the at least one intermediate audio node, or the second audio node.

14. The overlay system of claim 13,
wherein the first group node is associated with a second group node, and
wherein the second group node includes a third audio node correlated with at least one of: the first audio node, the at least one intermediate audio node, or the second audio node.

15. The overlay system of claim 13,
wherein the processing circuitry is further configured to associate a fourth audio action overlay node, of the plurality of audio action overlay nodes, with the first group node, and
wherein the first audio action is executed further based on the fourth audio action overlay node.

16. The overlay system of claim 13,
wherein the processing circuitry is further configured to generate, based on the first group node, an audio trail associated with the first audio file, and
wherein the audio trail includes a time-synchronized order of audio mutations of the first audio file.

17. The overlay system of claim 13,
wherein the first group node is one of a persistable node or a non-persistable node,
wherein based on the first group node being the persistable node, an audio trail of the first audio node is stored in the storage element,
wherein based on the first group node being the non-persistable node, an audio trail of the first audio node ceases to exist from the storage element upon expiration of a threshold time-interval, and
wherein the audio trail of the first audio node includes a time-synchronized order of at least one of: the first audio node, the at least one intermediate audio node, or the second audio node.

18. The overlay system of claim 1,
wherein the first audio node is a run-time node that includes (i) a node template that defines a node structure and (ii) a node instance that is an implementation of the node template, and
wherein based on the first audio node being the run-time node, the first audio action overlay node is a run-time overlay node that includes (i) an overlay node template that defines an overlay node structure and (ii) an overlay node instance that is an implementation of the overlay node template.

19. The overlay system of claim 18,
wherein each audio action overlay node of the plurality of audio action overlay nodes is a run-time overlay node,
wherein the processing circuitry is further configured to determine one or more audio action overlay nodes, of the plurality of audio action overlay nodes, associated with the first audio action overlay node,
wherein the first audio action is executed further based on the one or more audio action overlay nodes, and
wherein the overlay node template of the first audio action overlay node defines a sequence of operations associated with the one or more audio action overlay nodes.

20. A method, comprising:
receiving, by processing circuitry of an overlay system, a stimulus associated with a first audio action,
wherein the first audio action is to be executed based on a first audio file of a plurality of audio files,
wherein an executable graph-based model is stored in a storage element of the overlay system and includes a plurality of audio nodes and a plurality of audio action overlay nodes,
wherein the plurality of audio nodes represent a plurality of audio configurations of the plurality of audio files, and
wherein each audio node of the plurality of audio nodes is associated with one or more audio action overlay nodes of the plurality of audio action overlay nodes;
identifying, by the processing circuitry, based on the stimulus, a first audio node of the plurality of audio nodes that represents a first audio configuration of the first audio file;
determining, by the processing circuitry, a first audio action overlay node, of the plurality of audio action overlay nodes, associated with the first audio node;
executing, by the processing circuitry, the first audio action based on the first audio node and the first audio action overlay node to generate a second audio file; and
generating, by the processing circuitry, in response to the stimulus, a second audio node, representing a second audio configuration of the second audio file.
